(19) United States
(12) Patent Application Publication
(10) Pub. No.: US 2024/0288555 A1
(43) Pub. Date: Aug. 29, 2024

(54) LIDAR DATA PROCESSING METHOD

(71) Applicant: SOS LAB CO., LTD., Gwangju (KR)

(72) Inventors: Yong Yi LEE, Seongnam-si Gyeonggi-do (KR); Jun Ho CHOI, Gwangju (KR); Dong Won SHIN, Gwangju (KR); Deok Yun JANG, Gwangju (KR); Ji Seong JEONG, Gwangju (KR)

(73) Assignee: SOS LAB CO., LTD., Gwangju (KR)

(21) Appl. No.: 18/659,598

(22) Filed: May 9, 2024

Related U.S. Application Data
(63) Continuation of application No. PCT/KR2021/016508, filed on Nov. 12, 2021.

(51) Int. Cl. G01S 7/4863; G01S 7/4865; G01S 17/89

(52) U.S. Cl. CPC G01S 7/4863; G01S 7/4865; G01S 17/89

(57) ABSTRACT

Proposed is a method for processing, by one or more processors, data obtained on the basis of detection signals generated by a detector array including a plurality of detector units. The method includes generating, on the basis of the detection signals generated by the detector array, a spatio-temporal data set including a plurality of counting values, wherein each of the plurality of counting values corresponds to one of the plurality of detector units and is addressed to at least one time bin, and generating distance information including a plurality of distance values corresponding to each of the plurality of detector units by processing the spatio-temporal data set.

### CROSS-REFERENCE TO RELATED APPLICATION

This application is a continuation of International Application No. PCT/KR2021/016508 filed on Nov. 12, 2021, the entire contents of which are herein incorporated by reference.

### TECHNICAL FIELD

The invention proposed in the present specification relates to a method of generating LiDAR data by a LiDAR device including a detector array, considering detection signals generated by a plurality of detectors receive light.

More particularly, the present disclosure relates to a method of obtaining depth information of an object more accurately by generating spatio-temporally defined data on the basis of detection signals generated by a detector array.

### BACKGROUND ART

A LIDAR device is a sensor for measuring a distance from the LiDAR device to an object by using the time of flight (TOF) of a laser. For example, a mechanical scanning LiDAR transmits and receives a laser using a rotating reflector, such as a MEMS mirror or a polygonal mirror, to obtain distance information of an object.

Recently, there has been a lot of research into LiDAR devices for use in autonomous driving vehicles. In particular, research on a solid-state LiDAR for transmitting and receiving lasers with a reduced size of a LiDAR device and no mechanical driving has been widely conducted. A solid-state LiDAR transmits and receives lasers using a fixed emitter array and a detector array to obtain distance information of an object.

In order for a solid-state LiDAR to obtain accurate distance information, detectors, such as SPADs or APDs, have been used. In particular, recently, in obtaining distance information on the basis of light received from detectors, there has been a wide development of LiDAR software solutions for generating data on the basis of received light and processing the data efficiently.

However, the currently developed LiDAR data generation and processing software solutions have limitations because the solutions are vulnerable to external noise and unable to use signals generated from several detectors together.

### SUMMARY

### Technical Problem

The present disclosure is directed to obtaining depth information of an object by using counting values for detectors adjacent to each other.

In addition, the present disclosure is directed to obtaining an enhanced spatio-temporal data set by processing a spatio-temporal data set.

In addition, the present disclosure is directed to extracting distance information by generating a spatio-temporal data set.

Technical problems to be solved by the present disclosure are not limited to the aforementioned technical problems and other technical problems which are not mentioned will be clearly understood by those skilled in the art from the present specification and the accompanying drawings.

### Technical Solution

According to an embodiment of the present disclosure, there is provided a method of processing, by one or more processors, data obtained on the basis of detection signals generated by a detector array including a first detector unit and a second detector unit, the method including: obtaining a first data set including a plurality of counting values corresponding to the detector array and allocated to a first time bin; obtaining a second data set including a plurality of counting values corresponding to the detector array and allocated to a second time bin different from the first time bin; and generating first distance information for the first detector unit on the basis of a first counting value corresponding to the first detector unit in the first data set, a second counting value corresponding to the first detector unit in the second data set, and a third counting value corresponding to the second detector unit in the first data set, wherein the first detector unit and the second detector unit are placed adjacent to each other.

According to another embodiment of the present disclosure, there is provided a LiDAR device for generating distance information by detecting light, the LiDAR device including: an emitter array designed to emit lasers; a detector array including a first detector unit and a second detector unit, and configured to generate detection signals by detecting light; a controller configured to control the emitter array and the detector array; and a data processing unit for processing the detection signals, wherein the data processing unit is configured to generate a first data set including a plurality of counting values corresponding to the detector array and allocated to a first time bin; generate a second data set including a plurality of counting values corresponding to the detector array and allocated to a second time bin; and generate first distance information of the first detector unit on the basis of at least one selected from a group of a first counting value corresponding to the first detector unit in the first data set, a second counting value corresponding to the first detector unit in the second data set, and a third counting value corresponding to the second detector unit in the first data set.

According to another embodiment of the present disclosure, there is provided a method of processing, by one or more processors, data obtained on the basis of detection signals generated by a detector array including a first detector unit, a second detector unit, a third detector unit, a fourth detector unit, and a fifth detector unit, the method including: obtaining a first data set including a plurality of counting values corresponding to the detector array and allocated to a first time bin; obtaining a second data set including a plurality of counting values corresponding to the detector array and allocated to a second time bin different from the first time bin; and adjusting a first counting value corresponding to the first detector unit in the first data set, the first counting value being adjusted on the basis of a second counting value corresponding to the second detector unit in the first data set, a third counting value corresponding to the third detector unit in the first data set, a fourth counting value corresponding to the fourth detector unit in the first data set, a fifth counting value corresponding to the fifth detector unit in the first data set, and a six counting value corresponding to the first detector unit in the second data set, wherein the second to the fifth detector unit are placed adjacent to the first detector unit, and the second time bin is adjacent to the first time bin.

According to another embodiment of the present disclosure, there is provided a method for processing data obtained based on detection signals generated from a detector array including a plurality of detector unit performed by one or more processors, comprising: generating a spatio-temporal data set including a plurality of counting values based on detection signals generated from the detector array, wherein each of the plurality of counting values corresponds to one of the plurality of detector units and is addressed to at least one time bin; and generating distance information including a plurality of distance values corresponding to each of the plurality of detector units by processing the spatio-temporal data set; wherein the generating distance information comprises: generating a first distance value included in the distance information based on a first counting value group included in the spatio-temporal data set, wherein the first counting value group is included in the spatio-temporal data set and includes at least a first counting value addressed to a first detector unit and a first time bin, a second counting value addressed to a second detector unit adjacent to the first detector unit and a second time bin adjacent to the first time bin and a third counting value addressed to the first detector unit and the second time bin.

According to another embodiment of the present disclosure, there is provided a method for processing data obtained based on detection signals generated from a detector array including a plurality of detector unit performed by one or more processors, comprising: generating a spatio-temporal data set including a plurality of counting values based on detection signals generated from the detector array, wherein each of the plurality of counting values corresponds to one of the plurality of detector units and is addressed to at least one time bin; and generating an enhanced spatio-temporal data set by processing the spatio-temporal data set; and generating a point cloud based on the enhanced spatio-temporal data set; wherein the generating the enhanced spatio-temporal data set comprises: generating a first value included in the enhanced spatio-temporal data set based on a first counting value group included in the spatio-temporal data set, wherein the first counting value group is included in the spatio-temporal data set and includes at least a first counting value addressed to a first detector unit and a first time bin, a second counting value addressed to a second detector unit adjacent to the first detector unit and a second time bin adjacent to the first time bin and a third counting value addressed to the first detector unit and the second time bin.

However, the solutions of the problems of the present disclosure are not limited to the aforementioned solutions and other solutions which are not mentioned will be clearly understood by those skilled in the art from the present specification and the accompanying drawings.

### Advantageous Effects

According to an embodiment of the present disclosure, a LiDAR device for obtaining depth information of an object by using adjacent counting values can be provided.

According to another embodiment of the present disclosure, a LiDAR device for obtaining an enhanced spatio-temporal data set by using a spatio-temporal data set can be provided.

According to still another embodiment of the present disclosure, a LiDAR device for generating a spatio-temporal data set to extract distance information can be provided.

The effects of the present disclosure are not limited to the aforementioned effects and other effects which are not mentioned will be clearly understood by those skilled in the art from the present specification and the accompanying drawings.

### DESCRIPTION OF DRAWINGS

FIG. 1 is a diagram illustrating a LiDAR device according to an embodiment.

FIG. 2 is a diagram illustrating a detector array according to an embodiment.

FIG. 3 is a diagram illustrating a LiDAR device according to an embodiment.

FIG. 4 is a diagram illustrating a LiDAR device according to another embodiment.

FIGS. 5A, 5B, 5C, and 5D are diagrams illustrating various examples of LiDAR devices.

FIG. 6 is a diagram illustrating data displayed on a 3D map, the data being obtained by a LiDAR device.

FIG. 7 is a diagram illustrating a point cloud simply displayed on a 2D plane.

FIG. 8 is a diagram illustrating point data obtained from a LiDAR device according to an embodiment.

FIG. 9 is a diagram illustrating a point data set obtained from a LiDAR device.

FIG. 10 is a diagram illustrating a plurality of pieces of information included in property data according to an embodiment.

FIG. 11 is a diagram illustrating the operation of a LiDAR device according to an embodiment.

FIG. 12 is a diagram illustrating a method of generating histogram data by a LiDAR device according to an embodiment.

FIG. 13 is a diagram illustrating a specific method of obtaining depth information on the basis of histogram data by a LiDAR device according to an embodiment.

FIG. 14 is a diagram illustrating the operation of a LiDAR device according to an embodiment.

FIG. 15 is a diagram illustrating the operation of a LiDAR device according to an embodiment.

FIG. 16 is a diagram illustrating a signal processing method of a LiDAR device including a detector array according to an embodiment.

FIG. 17 is a diagram illustrating the configuration of a LiDAR device according to an embodiment.

FIG. 18 is a diagram illustrating a LiDAR data processing device according to an embodiment.

FIG. 19 is a diagram illustrating a structure of a spatio-temporal data set according to an embodiment.

FIG. 20 is a diagram illustrating a structure of a spatio-temporal data set in connection with a detector array according to an embodiment.

FIG. 21 is a flowchart illustrating a method of generating a counting value included in a spatio-temporal data set according to an embodiment.

FIG. 22 is a diagram illustrating a detection signal sampling method of a data processing unit according to an embodiment.

FIG. 23 is a diagram illustrating a counting value identified by a location value and a time value according to an embodiment.

FIG. 24 is a diagram illustrating a method of generating a spatio-temporal data set of one frame according to the operation of a detector array according to an embodiment.

FIG. 25 is a flowchart illustrating the process of performing the method of FIG. 24.

FIG. 26 is a diagram illustrating, in time series, a method of generating a spatio-temporal data set according to an embodiment.

FIG. 27 is a diagram illustrating a spatio-temporal data set defined on the basis of accumulated data sets according to an embodiment.

FIG. 28 is a diagram illustrating a spatio-temporal data set defined on the basis of a unit space according to an embodiment.

FIG. 29 is a diagram illustrating a spatio-temporal data set defined on the basis of plane data sets according to an embodiment.

FIG. 30 is a diagram illustrating a spatio-temporal data set visualized on the basis of image planes according to an embodiment.

FIG. 31 is a diagram illustrating a spatio-temporal data set visualized through image planes according to another embodiment.

FIG. 32 is a diagram illustrating an enhanced spatio-temporal data set obtained by processing a spatio-temporal data set on the basis of a predetermined data processing method according to an embodiment.

FIGS. 33A, 33B, and 33C are diagrams illustrating a method of processing a spatio-temporal data set using a screening algorithm according to an embodiment.

FIG. 34 is a diagram illustrating a method of classifying plane data sets on the basis of the spatial distribution of counting values by a data processing unit according to an embodiment.

FIG. 35 is a diagram illustrating a method of classifying accumulated data sets on the basis of the temporal distribution of counting values by a data processing unit according to an embodiment.

FIG. 36 is a diagram illustrating a method of classifying a spatio-temporal data set on the basis of the spatio-temporal distribution of counting values by a data processing unit according to an embodiment.

FIG. 37 is a diagram illustrating a method of classifying and postprocessing data by a data processing unit according to an embodiment.

FIG. 38 is a diagram illustrating a method of denoising a spatio-temporal data set using a kernel filter by a data processing unit according to an embodiment.

FIG. 39 is a diagram illustrating a method of processing a spatio-temporal data set using a machine learning model according to an embodiment.

FIG. 40 is a flowchart illustrating a method of extracting a target data set within a spatio-temporal data set by a data processing unit according to an embodiment.

FIG. 41 is a diagram illustrating a method of obtaining depth information on the basis of a spatio-temporal data set according to an embodiment.

FIG. 42 is a diagram illustrating a method of obtaining depth information on the basis of adjacent counting values according to an embodiment.

FIG. 43 is a diagram illustrating a method of obtaining intensity information of a detection point using a spatio-temporal data set according to an embodiment.

FIGS. 44A and 44B are diagrams illustrating a spatio-temporal data set generated in a daytime environment with strong ambient light and a spatio-temporal data set generated in a nighttime environment with weak ambient light.

FIG. 45 is a diagram illustrating a method of denoising noise from ambient light using a spatio-temporal data set by a data processing unit according to an embodiment.

FIG. 46 is a diagram illustrating a spatio-temporal data set with a flaring artifact according to an embodiment.

FIG. 47 is a diagram illustrating a method of determining a flaring artifact according to an embodiment.

FIG. 48 is a diagram illustrating a method of generating point cloud data on the basis of a spatio-temporal data set according to an embodiment.

FIG. 49 is a diagram illustrating a method of generating and using a sub spatio-temporal data set according to an embodiment.

FIG. 50 is a diagram illustrating a method of generating and using a sub spatio-temporal data set according to another embodiment.

FIG. 51 is a diagram illustrating a summation image according to an embodiment.

FIG. 52 is a diagram illustrating a method of using a summation image according to an embodiment.

### DETAILED DESCRIPTION

Embodiments described in the present specification are for clearly describing the idea of the present disclosure to those skilled in the art to which the present disclosure belongs, so the present disclosure is not limited to the embodiments described in the present specification and the scope of the present disclosure should be construed as including modifications or variations that are within the idea of the present disclosure.

As the terms used in the present specification, general terms currently widely used are used considering functions in the present disclosure. However, the terms may vary according to the intentions of those skilled in the art, precedents, or the emergence of new technology. However, unlike this, when a particular term is used defined as having an optional meaning, the meaning of the term will be described. Thus, the terms used in the present specification should be construed based on the actual meanings of the terms and details throughout the present specification rather than simply the names of the terms.

The drawings accompanying the present specification are for easily describing the present disclosure, and the shapes shown in the drawings may be exaggerated to help the understanding of the present disclosure, so the present disclosure is not limited by the drawings.

In the present specification, if it is decided that a detailed description of known configuration or function related to the present disclosure makes the subject matter of the present disclosure unclear, the detailed description is omitted.

According to an embodiment of the present disclosure, there is provided a method of processing, by one or more processors, data obtained on the basis of detection signals generated by a detector array including a first detector unit and a second detector unit, the method including: obtaining a first data set including a plurality of counting values corresponding to the detector array and allocated to a first time bin; obtaining a second data set including a plurality of counting values corresponding to the detector array and allocated to a second time bin different from the first time bin; and generating first distance information of the first detector unit on the basis of a first counting value corresponding to the first detector unit in the first data set, a second counting value corresponding to the first detector unit in the second data set, and a third counting value corresponding to the second detector unit in the first data set, wherein the first detector unit and the second detector unit are placed adjacent to each other.

Herein, each of the number of the plurality of counting values included in the first data set and the number of the plurality of counting values included in the second data set may correspond to the number of detector units included in the detector array.

Herein, the first data set may include the counting values allocated to the first time bin among the counting values corresponding to all the detector units included in the detector array, and the second data set may include the counting values allocated to the second time bin among the counting values corresponding to all the detector units included in the detector array.

Herein, the obtaining of the first data set may include: generating a first counting value set corresponding to the first detector during a first time interval from a first time point; generating a second counting value set corresponding to the second detector during the first time interval from a second time point; and extracting the counting values allocated to the first time bin from the first counting value set and the second counting value set.

Herein, the obtaining of the second data set may include extracting the counting values allocated to the second time bin from the first counting value set and the second counting value set. Herein, the second time bin may be a time bin before or after the first time bin.

Herein, each of the first time bin and the second time bin may be a unit time interval defined by dividing a time interval during which the detector array detects light into predetermined intervals.

Herein, the first counting value and the second counting value may be generated on the basis of detection signals generated from the first detector unit, and the third counting value may be generated on the basis of a detection signal generated from the second detector unit.

Herein, the first distance information may be generated further considering a fourth counting value that corresponds to the second detector unit in the second data set.

Herein, the generating of the first distance information may include: determining a peak value and a time value corresponding to the peak value on the basis of the first counting value, the second counting value, and the third counting value; and calculating the first distance information on the basis of the time value.

Herein, when the first detector unit detects light reflecting off an object, the first distance information of the first detector unit may indicate a distance to the object.

Herein, the detector array may be an SPAD array, and each of the first detector unit and the second detector unit may include at least one SPAD.

Herein, a computer-readable recording medium including a program for performing the above-described data processing method may be provided.

According to another embodiment of the present disclosure, there is provided a LiDAR device for generating distance information by detecting light, the LiDAR device including: an emitter array designed to output lasers; a detector array including a first detector unit and a second detector unit, and configured to generate detection signals by detecting light; a controller configured to control the emitter array and the detector array; and a data processing unit for processing the detection signals, wherein the data processing unit is configured to generate a first data set including a plurality of counting values corresponding to the detector array and allocated to a first time bin; generate a second data set including a plurality of counting values corresponding to the detector array and allocated to a second time bin; and generate first distance information of the first detector unit on the basis of at least one selected from a group of a first counting value corresponding to the first detector unit in the first data set, a second counting value corresponding to the first detector unit in the second data set, and a third counting value corresponding to the second detector unit in the first data set.

According to another embodiment of the present disclosure, there is provided a method of processing, by one or more processors, data obtained on the basis of detection signals generated by a detector array including a first detector unit, a second detector unit, a third detector unit, a fourth detector unit, and a fifth detector unit, the method including: obtaining a first data set including a plurality of counting values corresponding to the detector array and allocated to a first time bin; obtaining a second data set including a plurality of counting values corresponding to the detector array and allocated to a second time bin different from the first time bin; and adjusting a first counting value corresponding to the first detector unit in the first data set, the first counting value being adjusted on the basis of a second counting value corresponding to the second detector unit in the first data set, a third counting value corresponding to the third detector unit in the first data set, a fourth counting value corresponding to the fourth detector unit in the first data set, a fifth counting value corresponding to the fifth detector unit in the first data set, and a six counting value corresponding to the first detector unit in the second data set, wherein the second to the fifth detector unit are placed adjacent to the first detector unit, and the second time bin is adjacent to the first time bin.

Herein, each of the number of the plurality of counting values included in the first data set and the number of the plurality of counting values included in the second data set may correspond to the number of detector units included in the detector array.

Herein, the first data set may include the counting values allocated to the first time bin among the counting values corresponding to all the detector units included in the detector array, and the second data set may include the counting values allocated to the second time bin among the counting values corresponding to all the detector units included in the detector array.

Herein, the obtaining of the first data set may include: generating a first counting value set corresponding to the first detector during a first time interval from a first time point; generating a second counting value set corresponding to the second detector during the first time interval from a second time point; generating a third counting value set corresponding to the third detector during the first time interval from a third time point; generating a fourth counting value set corresponding to the fourth detector during the first time interval from a fourth time point; generating a fifth counting value set corresponding to the fifth detector during the first time interval from a fifth time point; and extracting the counting values allocated to the first time bin from the first counting value set to the fifth counting value set.

Herein, the obtaining of the second data set may include extracting the counting values allocated to the second time bin from the first counting value set and the second counting value set.

Herein, the second time bin may be a time bin before or after the first time bin.

Herein, the adjusting may include: applying, to the first counting value to the six counting value, a kernel filter corresponding to a spatio-temporal dimension of a first counting value group including the first counting value to the six counting value; and adjusting the first counting value on the basis of the first counting value to the six counting value to which the kernel filter is applied.

Herein, the first counting value and the six counting value may be generated on the basis of detection signals generated by the first detector unit, and the second counting value may be generated on the basis of a detection signal generated by the second detector unit, and the third counting value may be generated on the basis of a detection signal generated by the third detector unit, and the fourth counting value may be generated on the basis of a detection signal generated by the fourth detector unit, and the fifth counting value may be generated on the basis of a detection signal generated by the fifth detector unit.

Herein, the adjusting of the first counting value may include interpolating the first counting value on the basis of magnitudes of the first counting value, the second counting value, the third counting value, the fourth counting value, the fifth counting value, and the six counting value.

Herein, the adjusting of the first counting value may include normalizing the first counting value on the basis of a maximum value among the first counting value, the second counting value, the third counting value, the fourth counting value, the fifth counting value, and the six counting value.

Herein, the detector array may be an SPAD array, and each of the first detector unit, the second detector unit, the third detector unit, the fourth detector unit, and the fifth detector unit may include at least one SPAD.

According to another embodiment of the present disclosure, there is provided a method for processing data obtained based on detection signals generated from a detector array including a plurality of detector unit performed by one or more processors, comprising: generating a spatio-temporal data set including a plurality of counting values based on detection signals generated from the detector array, wherein each of the plurality of counting values corresponds to one of the plurality of detector units and is addressed to at least one time bin; and generating distance information including a plurality of distance values corresponding to each of the plurality of detector units by processing the spatio-temporal data set; wherein the generating distance information comprises: generating a first distance value included in the distance information based on a first counting value group included in the spatio-temporal data set, wherein the first counting value group is included in the spatio-temporal data set and includes at least a first counting value addressed to a first detector unit and a first time bin, a second counting value addressed to a second detector unit adjacent to the first detector unit and a second time bin adjacent to the first time bin and a third counting value addressed to the first detector unit and the second time bin.

Herein, the at least one time bin is a unit time interval defined by dividing a time interval in which the detector array detects light into predetermined intervals.

Herein, the generating the first distance value comprises: extracting a peak value and a time value corresponding to the peak value based on the first counting value group, and calculating the first distance value based on the extracted time value.

Herein, the first counting value group is defined as counting values to which a kernel filter having a predetermined size is applied.

Herein, the spatio-temporal data set includes a second counting value group, wherein a size of a kernel filter defining the second counting value group is larger than the size of the kernel filter defining the first counting value group.

Herein, the first counting value and the third counting value are generated based on a detection signal generated by the first detector unit, wherein the second counting value is generated based on a detection signal generated by the second detector unit.

According to another embodiment of the present disclosure, there is provided a method for processing data obtained based on detection signals generated from a detector array including a plurality of detector unit performed by one or more processors, comprising: generating a spatio-temporal data set including a plurality of counting values based on detection signals generated from the detector array, wherein each of the plurality of counting values corresponds to one of the plurality of detector units and is addressed to at least one time bin; and generating an enhanced spatio-temporal data set by processing the spatio-temporal data set; and generating a point cloud based on the enhanced spatio-temporal data set; wherein the generating the enhanced spatio-temporal data set comprises: generating a first value included in the enhanced spatio-temporal data set based on a first counting value group included in the spatio-temporal data set, wherein the first counting value group is included in the spatio-temporal data set and includes at least a first counting value addressed to a first detector unit and a first time bin, a second counting value addressed to a second detector unit adjacent to the first detector unit and a second time bin adjacent to the first time bin and a third counting value addressed to the first detector unit and the second time bin.

Herein, the at least one time bin is a unit time interval defined by dividing a time interval in which the detector array detects light into predetermined intervals.

Herein, the first counting value group is defined as counting values to which a kernel filter having a predetermined size is applied.

Herein, the spatio-temporal data set includes a second counting value group, wherein a size of a kernel filter defining the second counting value group is larger than the size of the kernel filter defining the first counting value group.

Herein, the first counting value and the third counting value are generated based on a detection signal generated by the first detector unit, wherein the second counting value is generated based on a detection signal generated by the second detector unit.

Herein, a number of values included in the enhanced spatio-temporal data set corresponds to a number of counting values included in the spatio-temporal data set.

Herein, a number of values included in the enhanced spatio-temporal data set is different from a number of counting values included in the spatio-temporal data set.

Herein, the enhanced spatio-temporal data set is stored in a different memory from the spatio-temporal data set.

Herein, the first value is generated by interpolating the first counting value based on magnitudes of the first counting value, the second counting value and the third counting value.

Herein, the first value is generated by normalizing the first counting value based on a maximum value among the first counting value, the second counting value and the third counting value.

Herein, a computer-readable recording medium comprising a program performing the above-described data processing method may be provided.

Hereinafter, a LIDAR device according to the present disclosure will be described.

A LIDAR device is a device for detecting a distance to an object and a location of the object by using a laser. For example, the LiDAR device may output a laser, and when the output laser reflects off the object, the LiDAR device receives the reflected laser to measure the distance between the object and the LiDAR device and the location of the object. Herein, the distance to and the location of the object may be represented through a coordinate system. For example, the distance to and the location of the object may be represented in a spherical coordinate system (r,θ, φ). However, without being limited thereto, these may be represented in a rectangular coordinate system (X, Y, Z) or a cylindrical coordinate system (r, θ, z).

In addition, in order to measure the distance to the object, the LiDAR device may use a laser that is output from the LiDAR device and reflects off the object.

A LIDAR device according to an embodiment may use the time of flight (TOF) that it takes for a laser to be detected after output, so as to measure a distance to an object. For example, the LiDAR device may measure the distance to the object by using the difference between a time value based on the time of output when a laser is output and a time value based on the time of detection when the laser reflecting off the object is detected.

In addition, the LiDAR device may measure the distance to an object by using the difference between a time value when an output laser is directly detected without touching the object and a time value based on the time of detection when a laser reflecting off the object is detected.

There may be a difference between the time point when the LiDAR device transmits a trigger signal for emitting a laser beam by a controller and the time point of actual emission, which is the time when the laser beam is actually output from a laser emitting element. The laser beam is not actually output between the time point of the trigger signal and the time point of actual emission, so precision may be reduced if the time period therebetween is included in the time of flight of the laser.

In order to improve the precision of measuring the time of flight of a laser beam, the time point of actual emission of the laser beam may be used. However, it may be difficult to determine the time point of actual emission of the laser beam. Therefore, a laser beam output from the laser emitting element needs to be immediately transmitted to a sensor as soon as it is output, or without touching an object after it is output.

For example, an optic is placed on the laser emitting element, so that the optic enables a laser beam output from the laser emitting element to be directly detected by a light receiving part without touching an object. The optic may be a mirror, a lens, a prism, or a metasurface, but is not limited thereto. There may be one or a plurality of optics.

In addition, for example, a sensor may be placed on the laser emitting element, so that a laser beam output from the laser emitting element may be directly detected by the sensor without touching an object. The sensor may be spaced apart from the laser emitting element at a distance of 1 mm, 1 um, or 1 nm, but is not limited thereto. Alternatively, the sensor may be placed adjacent to the laser emitting element rather than spaced apart therefrom. The optic may be present between the sensor and the laser emitting element, but no limitation thereto is imposed.

In addition to the time of flight, a LiDAR device according to an embodiment may use a triangulation method, an interferometry method, or phase shift measurement in order to measure a distance to an object, but is not limited thereto.

A LIDAR device according to one embodiment may be installed at a vehicle. For example, the LiDAR device may be installed at a roof, a hood, a headlamp, or a bumper of a vehicle.

In addition, a plurality of LiDAR devices according to an embodiment may be installed at a vehicle. For example, when two LiDAR devices are installed on the roof of a vehicle, one of the LiDAR devices may be for observing ahead and the other may be for observing behind, but are not limited thereto. In addition, for example, when two LiDAR devices are installed on the roof of a vehicle, one of the LiDAR devices may be for observing left and the other may be for observing right, but are not limited thereto.

In addition, a LiDAR device according to an embodiment may be installed at a vehicle. For example, when the LiDAR device is installed inside a vehicle, the LiDAR device may be for recognizing a driver's gestures during driving, but is not limited thereto. In addition, for example, when the LiDAR device is installed inside or outside a vehicle, the LiDAR device may be for recognizing the driver's face, but is not limited thereto.

A LIDAR device according to an embodiment may be installed at an unmanned aerial vehicle. For example, the LiDAR device may be installed at an unmanned aerial vehicle system (UAV System), a drone, a remotely piloted vehicle (RPV), an unmanned aerial vehicle system (UAVs), an unmanned aircraft system (UAS), a remotely piloted air/aerial vehicle (RPAV), or a remotely piloted aircraft system (RPAS).

In addition, a plurality of LiDAR devices according to an embodiment may be installed at an unmanned aerial vehicle. For example, when two LiDAR devices are installed at an unmanned aerial vehicle, one of the LiDAR devices may be for observing ahead and the other may be for observing behind, but are not limited thereto. In addition, for example, when two LiDAR devices are installed at an unmanned aerial vehicle, one of the LiDAR devices may be for observing left and the other may be for observing right, but are not limited thereto.

A LIDAR device according to an embodiment may be installed at a robot. For example, the LiDAR device may be installed in a personal robot, a professional robot, a public service robot, other industrial robots, or a manufacturing robot.

In addition, a plurality of LiDAR devices according to an embodiment may be installed at a robot. For example, when two LiDAR devices are installed at a robot, one of the LiDAR devices may be for observing ahead and the other may be for observing behind, but are not limited thereto. In addition, for example, when two LiDAR devices are installed at a robot, one of the LiDAR devices may be for observing left and the other may be for observing right, but are not limited thereto.

In addition, a LiDAR device according to an embodiment may be installed at a robot. For example, when the LiDAR device is installed at a robot, the LiDAR device may be for recognizing a human's face, but is not limited thereto.

In addition, a LiDAR device according to an embodiment may be installed for industrial security. For example, the LiDAR device may be installed at a smart factory for industrial security.

In addition, a plurality of LiDAR devices according to an embodiment may be installed at a smart factory for industrial security. For example, when two LiDAR devices are installed at a smart factory, one of the LiDAR devices may be for observing ahead and the other may be for observing behind, but are not limited thereto. In addition, for example, when two LiDAR devices are installed at a smart factory, one of the LiDAR devices may be for observing left and the other may be for observing right, but are not limited thereto.

In addition, a LiDAR device according to an embodiment may be installed for industrial security. For example, when the LiDAR device is installed for industrial security, the LiDAR device may be for recognizing a human's face, but is not limited thereto.

### 1. Basic Configuration of LiDAR Device

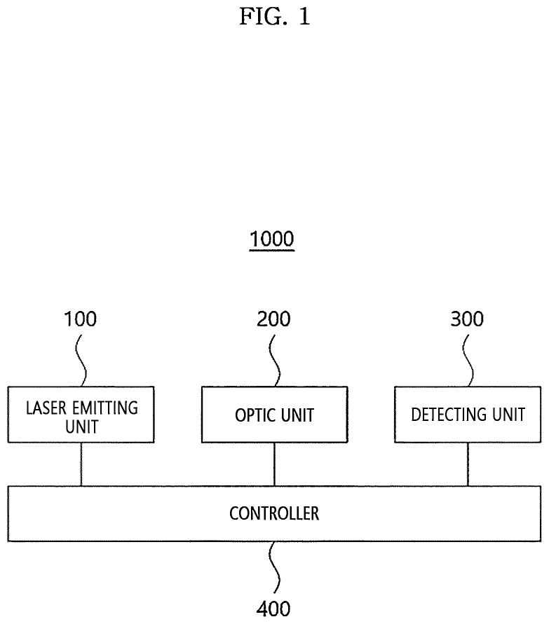

FIG. 1 is a diagram illustrating a LiDAR device according to an embodiment.

Referring to FIG. 1, a LIDAR device 1000 may include a laser emitting unit 100, an optic unit 200, a detecting unit 300, and a controller 400.

### 1.1. Laser Emitting Unit

Referring to FIG. 1, a LiDAR device 1000 according to an embodiment may include a laser emitting unit 100. Herein, a laser emitting unit 100 according to an embodiment may output a laser. The laser emitting unit 100 may output a laser when a voltage is applied from outside. However, without being limited thereto, the laser emitting unit 100 may output a laser on the basis of various types of laser emission algorithms known to those skilled in the art.

In addition, the laser emitting unit 100 may include at least one laser emitting element. For example, the laser emitting unit 100 may include a laser diode (LD), a solid-state laser, a high power laser, a light-entitling diode (LED), a vertical-cavity surface-emitting laser (VCSEL), or an external cavity diode laser (ECDL), but is not limited thereto.

The laser emitting unit 100 may include a plurality of light-emitting elements. For example, the laser emitting unit 100 may include a light-emitting element array. Herein, the light-emitting element array may include 2D N*M (herein, N and M are natural numbers of 1 or more) light-emitting elements. As a specific example, the laser emitting unit 100 may include a VCSEL array, but is not limited thereto.

In addition, the laser emitting unit 100 may output a laser with a predetermined wavelength. For example, the laser emitting unit 100 may output a laser with a wavelength of 905 nm or a laser with a wavelength of 1550 nm. Furthermore, for example, the laser emitting unit 100 may output a laser with a wavelength of 940 nm. In addition, for example, the laser emitting unit 100 may output a laser with a plurality of wavelengths ranging from 800 nm to 1000 nm. Furthermore, when the laser emitting unit 100 includes a plurality of laser emitting elements, some of the plurality of laser emitting elements may output a laser with a wavelength of 905 nm, and others may output a laser with a wavelength of 1500 nm.

### 1.2. Optic Unit

Referring back to FIG. 1, a LiDAR device 1000 according to an embodiment may include an optic unit 200.

The optic unit may be variously referred to as a steering unit or a scanning unit in the description of the present disclosure, but is not limited thereto.

Herein, an optic unit 200 according to an embodiment may change a flight path of a laser. For example, the optic unit 200 may change a flight path of a laser such that the laser emitted from the laser emitting unit 100 is toward a scan region. In addition, for example, the optic unit 200 may change a flight path of a laser such that the laser reflecting off an object located in a scan region is toward the detecting unit.

In addition, an optic unit 200 according to an embodiment may change a flight path of a laser by reflecting the laser. For example, the optic unit 200 may reflect a laser emitted from the laser emitting unit 100 to change the flight path of the laser such that the laser is toward a scan region. In addition, for example, the optic unit 200 may change a flight path of a laser such that the laser reflecting off an object located in a scan region is toward the detecting unit.

In addition, an optic unit 200 according to an embodiment may include various optical means to reflect a laser. For example, the optic unit 200 may include a mirror, a resonance scanner, a MEMS mirror, a voice coil motor (VCM), a polygonal mirror, a rotating mirror, or a Galvano mirror, but is not limited thereto.

In addition, an optic unit 200 according to an embodiment may refract a laser to change the flight path of the laser. For example, the optic unit 200 may refract a laser emitted from the laser emitting unit 100 to change the flight path of the laser such that the laser is toward a scan region. In addition, for example, the optic unit 200 may change a flight path of a laser such that the laser reflecting off an object located in a scan region is toward the detecting unit.

In addition, an optic unit 200 according to an embodiment may include various optical means to refract a laser. For example, the optic unit 200 may include a lens, a prism, a microlens, or a microfluidic lens, but is not limited thereto.

In addition, an optic unit 200 according to an embodiment may change the phase of a laser to change the flight path of the laser. For example, the optic unit 200 may change the phase of a laser emitted from the laser emitting unit 100 to change the flight path of the laser such that the laser is toward a scan region. In addition, for example, the optic unit 200 may change a flight path of a laser such that the laser reflecting off an object located in a scan region is toward the detecting unit.

In addition, an optic unit 200 according to an embodiment may include various optical means to change the phase of a laser. For example, the optic unit 200 may include an optical phased array (OPA), a meta lens, or a meta surface, but is not limited thereto.

In addition, an optic unit 200 according to an embodiment may include one or more optical means. In addition, for example, the optic unit 200 may include a plurality of optical means.

### 1.3. Detecting Unit

Referring back to FIG. 1, a LIDAR device 1000 according to an embodiment may include a detecting unit 300.

The detecting unit may be variously referred to as a detector, a detector light receiving part, or a receiver in the description of the present disclosure, but is not limited thereto.

Herein, a detecting unit 300 according to an embodiment may detect a laser. For example, the detecting unit may detect a laser reflecting off an object located in a scan region.

In addition, a detecting unit 300 according to an embodiment may receive a laser, and may generate an electrical signal on the basis of the received laser. For example, the detecting unit 300 may receive a laser reflecting off an object located in a scan region, and may generate an electrical signal on the basis of the laser. In addition, for example, the detecting unit 300 may receive a laser reflecting off an object located in a scan region through one or more optical means, and may generate an electrical signal on the basis of the laser. In addition, for example, the detecting unit 300 may receive a laser reflecting off an object located in a scan region through an optical filter, and may generate an electrical signal on the basis of the laser.

In addition, a detecting unit 300 according to an embodiment may detect a laser on the basis of a generated electrical signal. For example, the detecting unit 300 may detect a laser by comparing a predetermined threshold with the magnitude of a generated electrical signal, but is not limited thereto. In addition, for example, the detecting unit 300 may detect a laser by comparing a predetermined threshold with a rising edge, a falling edge, or a median value of the rising edge and the falling edge of a generated electrical signal, but is not limited thereto. In addition, for example, the detecting unit 300 may detect a laser by comparing a predetermined threshold with a peak value of a generated electrical signal, but is not limited thereto.

In addition, a detecting unit 300 according to an embodiment may include various detector elements. For example, the detecting unit 300 may include a PN photodiode, a phototransistor, a PIN photodiode, an avalanche photodiode (APD), a single-photon avalanche diode (SPAD), a silicon photomultiplier (SiPM), a time-to-digital converter (TDC), a comparator, a complementary metal-oxide-semiconductor (CMOS), or a charge coupled device (CCD), but is not limited thereto.

In addition, a detecting unit 300 according to an embodiment may include one or more detector elements. For example, the detecting unit 300 may include a single detector element or a plurality of detector elements.

In addition, a detecting unit 300 according to an embodiment may include one or more optical elements. For example, the detecting unit 300 may include an aperture, a micro lens, a converging lens, or a diffuser, but is not limited thereto.

In addition, a detecting unit 300 according to an embodiment may include one or more optical filters. The detecting unit 300 may receive a laser reflecting off an object, through an optical filter. For example, the detecting unit 300 may include a band-pass filter, a dichroic filter, a guided-mode resonance filter, a polarizer, or a wedge filter, but is not limited thereto.

In addition, a detecting unit 300 according to an embodiment may include a signal processor (not shown). The signal processor may be connected to at least one detector included in the detecting unit 300. For example, the signal processor may include a time-to-digital conversion circuit (time-to-digital converter (TDC)) or an analog-to-digital conversion circuit (analog-to-digital converter (ADC)), but is not limited thereto.

For example, the detecting unit 300 may be a 2D SPAD array, but is not limited thereto. In addition, for example, the SPAD array may include a plurality of SPAD units, and an SPAD unit may include a plurality of SPADs (pixels).

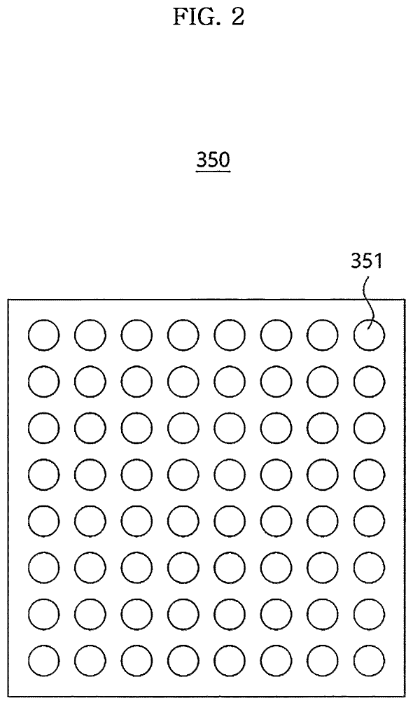

FIG. 2 is a diagram illustrating a detector array according to an embodiment.

Referring to FIG. 2, a detecting unit 300 according to an embodiment may include a detector array 350. FIG. 2 shows an 8×8 detector array, but no limitation thereto is imposed. A 10×10, 12×12, 24×24, or 64×64 detector array may be used. For example, the detector array 350 may be an SPAD array of a plurality of SPADs. Herein, when a laser beam is incident on the detector array 350 including the SPADs, photons may be detected due to the avalanche phenomenon.

A detector array 350 according to an embodiment may include a plurality of detector units 351. For example, the plurality of detector units 351 may be arranged in a matrix structure. However, without being limited thereto, the plurality of detector units 351 may be arranged in a circular, elliptical, or honeycomb structure.

### 1.4. Controller

Referring back to FIG. 1, a LiDAR device 1000 according to an embodiment may include a controller 400.

The controller may be variously referred to as a controller or a processor in the description of the present disclosure, but is not limited thereto.

Herein, a controller 400 according to an embodiment may control the operation of the laser emitting unit 100, the optic unit 200, or the detecting unit 300.

In addition, a controller 400 according to an embodiment may control the operation of the laser emitting unit 100. Specifically, the controller 400 may transmit a predetermined trigger signal to the laser emitting unit 100 to operate the laser emitting unit 100. Herein, the trigger signal may be an electrical signal.

In addition, the controller 400 may control the period of a laser emitted from the laser emitting unit 100. Specifically, the controller 400 may operate the laser emitting unit 100 on the basis of a predetermined output repetition. For example, the controller 400 may operate the laser emitting unit 100 with an output repetition of 25 Hz, but is not limited thereto. In addition, herein, the controller 400 may adjust the output repetition of the laser emitting unit 100.

In addition, when the laser emitting unit 100 includes a plurality of laser emitting elements, the controller 400 may control the laser emitting unit 100 such that some of the plurality of laser emitting elements operate. For example, when the laser emitting unit 100 is an emitter array of a plurality of laser emitting elements, the controller 400 may operate the entire emitter array simultaneously. However, without being limited thereto, the controller 400 may operate the emitter array on a per-column basis or a per-row basis.

In addition, the controller 400 may control an output time point of a laser emitted from the laser emitting unit 100.

In addition, the controller 400 may control the power of a laser emitted from the laser emitting unit 100.

In addition, the controller 400 may control the pulse width of a laser emitted from the laser emitting unit 100.

In addition, a controller 400 according to an embodiment may control the operation of the optic unit 200.

For example, the controller 400 may control the operating speed of the optic unit 200. Specifically, when the optic unit 200 includes a rotating mirror, the controller 400 may control the rotation speed of the rotating mirror. When the optic unit 200 includes a MEMS mirror, the controller 400 may control the repetition period of the MEMS mirror. However, no limitation thereto is imposed.

In addition, for example, the controller 400 may control the degree of operation of the optic unit 200. Specifically, when the optic unit 200 includes a MEMS mirror, the controller 400 may control the angle of operation of the MEMS mirror, but is not limited thereto.

In addition, a controller 400 according to an embodiment may control the operation of the detecting unit 300.

For example, the controller 400 may control the sensitivity of the detecting unit 300. Specifically, the controller 400 may control the sensitivity of the detecting unit 300 by adjusting a predetermined threshold, but is not limited thereto.

In addition, for example, the controller 400 may control the operation of the detecting unit 300. Specifically, the controller 400 may control the on/off operation of the detecting unit 300. When the controller 400 includes a plurality of detector elements, the operation of the detecting unit 300 may be controlled such that some of the plurality of detector elements operate.

As a specific example, when the detecting unit 300 includes a detector array 350 as shown in FIG. 2, the controller 400 may operate the detector array 350 on the basis of a predetermined operating mechanism. For example, the controller 400 may operate all detector elements included in the detector array 350 simultaneously. However, without being limited thereto, the controller 400 may operate the detector array 350 n columns by n columns, or n rows by n rows. The operating mechanism by which the controller 400 operates the detector array 350 may be determined by the design of a driving circuit connected to the detector array 350.

In addition, a controller 400 according to an embodiment may determine a distance from the LiDAR device 1000 to an object located in a scan region, on the basis of a laser detected by the detecting unit 300.

For example, the controller 400 may determine a distance to an object located in a scan region, on the basis of a time point of output of a laser from the laser emitting unit 100 and a time point of detection of the laser by the detecting unit 300. In addition, for example, the controller 400 may determine a distance to an object located in a scan region, on the basis of a time point when a laser emitted from the laser emitting unit 100 is directly detected by the detecting unit 300 without touching the object and a time point when a laser reflecting off the object is detected by the detecting unit 300.

Specifically, the laser emitting unit 100 may output a laser, and the controller 400 may obtain a time point of output of the laser from the laser emitting unit 100. When the laser emitted from the laser emitting unit 100 reflects off an object located in a scan region, the detecting unit 300 may detect the laser reflecting off the object, the controller 400 may obtain the time point of detection of the laser by the detecting unit 300, and the controller 400 may determine the distance to the object located in the scan region, on the basis of the output time point and the detection time point of the laser.

In addition, specifically, the laser emitting unit 100 may output a laser, the laser emitted from the laser emitting unit 100 may be directly detected by the detecting unit 300 without touching an object located in a scan region, and the controller 400 may obtain the time point of detection of the laser not touching the object. When the laser emitted from the laser emitting unit 100 reflects off the object located in the scan region, the detecting unit 300 may detect the laser reflecting off the object, the controller 400 may obtain the time point of detection of the laser by the detecting unit 300, and the controller 400 may determine the distance to the object located in the scan region on the basis of the detection time point of the laser not touching the object and the detection time point of the laser reflecting off the object.

### 2. Basic Structure of LiDAR Device

### 2.1. Light-Emitting and Light-Receiving Paths

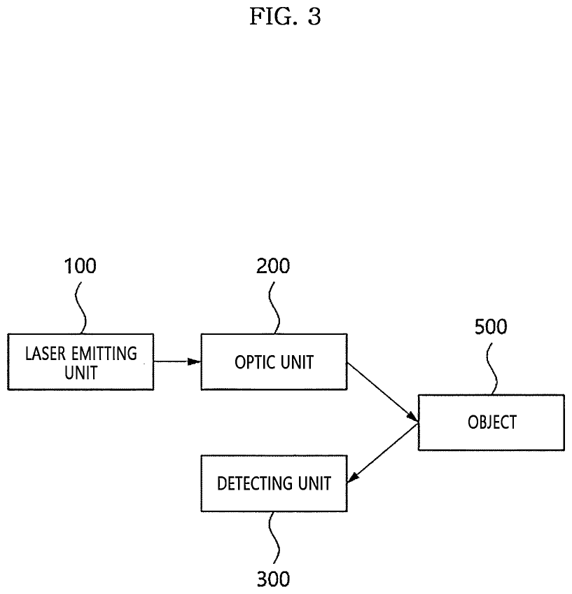

FIG. 3 is a diagram illustrating a LiDAR device according to an embodiment.

Referring to FIG. 3, a LiDAR device 1050 according to an embodiment may include a laser emitting unit 100, an optic unit 200, and a detecting unit 300.

Since the laser emitting unit 100, the optic unit 200, and the detecting unit 300 have been described with reference to FIG. 1, a detailed description thereof will be omitted below.

A laser beam output from the laser emitting unit 100 may pass through the optic unit 200. In addition, the laser beam passing through the optic unit 200 may be emitted toward an object 500. In addition, the laser beam reflecting off the object 500 may be received by the detecting unit 300.

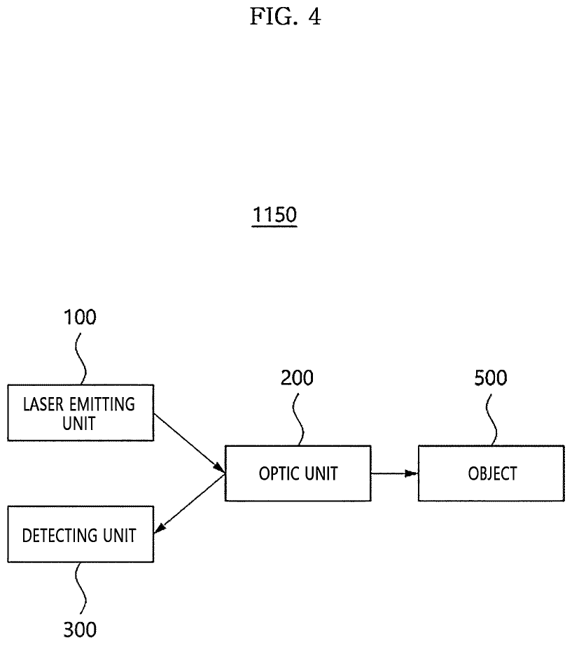

FIG. 4 is a diagram illustrating a LiDAR device according to another embodiment.

Referring to FIG. 4, a LiDAR device 1150 according to another embodiment may include a laser emitting unit 100, an optic unit 200, and a detecting unit 300.

Since the laser emitting unit 100, the optic unit 200, and the detecting unit 300 have been described with reference to FIG. 1, a detailed description thereof will be omitted below.

A laser beam emitted from the laser emitting unit 100 may pass through the optic unit 200. In addition, the laser beam passing through the optic unit 200 may be emitted toward an object 500. In addition, the laser beam reflecting off the object 500 may pass through the optic unit 200 again.

Herein, the optic unit through which the laser beam passes before irradiating the object and the optic unit through which the laser beam reflecting off the object passes may be physically the same optic unit, or may be physically different optic units.

The laser beam passing through the optic unit 200 may be received by the detecting unit 300.

### 2.2. Various Structures of LiDAR Devices

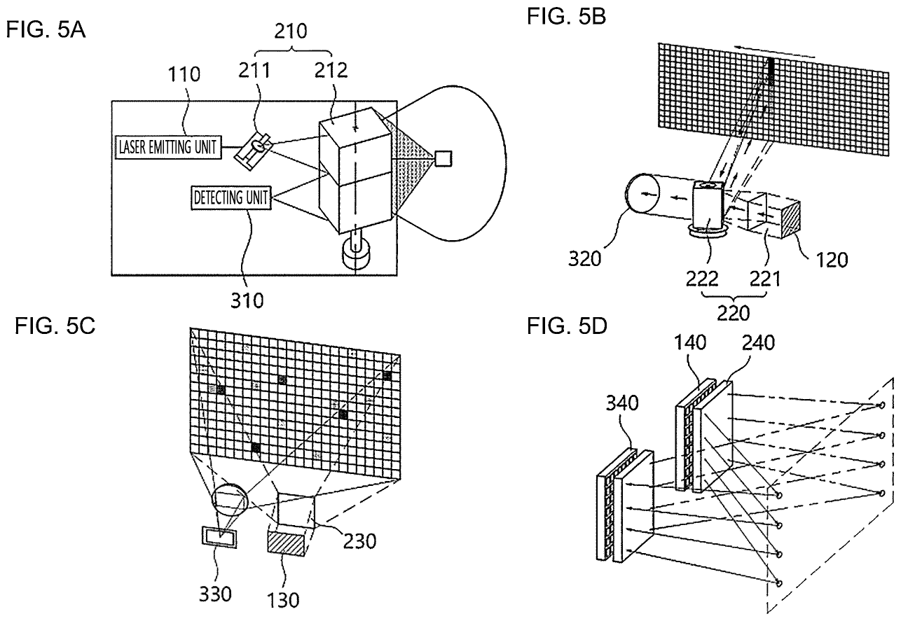

FIG. 5 is a diagram illustrating various examples of LiDAR devices.

Referring to FIG. 5A, a LiDAR device according to an embodiment may include a laser emitting unit 110, an optic unit 210, and a detecting unit 310, and the optic unit 210 may include a nodding mirror 211 and a polygonal mirror 212 described above. However, no limitation thereto is imposed.

Herein, the above-described details may be applied to the laser emitting unit 110, the optic unit 210, and the detecting unit 310, so a redundant description will be omitted. FIG. 5A is a simplified diagram illustrating one of the various examples of LiDAR devices, and the various examples of LiDAR devices are not limited to FIG. 5A.

In addition, referring to FIG. 5B, a LiDAR device according to an embodiment may include a laser emitting unit 120, an optic unit 220, and a detecting unit 320, and the optic unit 220 may include at least one lens for collimating and steering a laser emitted from the laser emitting unit 120. However, no limitation thereto is imposed.

Herein, the above-described details may be applied to the laser emitting unit 120, the optic unit 220, and the detecting unit 320, so a redundant description will be omitted. FIG. 5B is a simplified diagram illustrating one of the various examples of LiDAR devices, and the various examples of LiDAR devices are not limited to FIG. 5B.

In addition, referring to FIG. 5C, a LiDAR device according to an embodiment may include a laser emitting unit 130, an optic unit 230, and a detecting unit 330, and the optic unit 230 may include at least one lens for collimating and steering a laser emitted from the laser emitting unit 130. However, no limitation thereto is imposed.

Herein, the above-described details may be applied to the laser emitting unit 130, the optic unit 230, and the detecting unit 330, so a redundant description will be omitted. FIG. 5C is a simplified diagram illustrating one of the various examples of LiDAR devices, and the various examples of LiDAR devices are not limited to FIG. 5C.

In addition, referring to FIG. 5D, a LiDAR device according to an embodiment may include a laser emitting unit 140, an optic unit 240, and a detecting unit 340, and the optic unit 240 may include at least one lens for collimating and steering a laser emitted from the laser emitting unit 130. However, no limitation thereto is imposed.

Herein, the above-described details may be applied to the laser emitting unit 140, the optic unit 240, and the detecting unit 340, so a redundant description will be omitted. FIG. 5D is a simplified diagram illustrating one of the various examples of LiDAR devices, and the various examples of LiDAR devices are not limited to FIG. 5D.

### 3. LiDAR Data

### 3.1. Definition of LiDAR Data

A LIDAR device according to an embodiment may generate LiDAR data on the basis of light received through a detecting unit. Herein, the LiDAR data may refer to any type of data that the LiDAR device generates in association with the received light.

In addition, the LiDAR data may refer to data including information on at least one object that is present within the field of view of the LiDAR device. Specifically, the LiDAR device may generate, on the basis of light received through the detecting unit, LiDAR data including at least one piece of information on a detection point of an object that reflects the light. For example, the LiDAR data may include point cloud data and property data. However, without being limited thereto, the LiDAR data may include pixel data on a depth map or pixel data on an intensity map for generating the point cloud data.

### 3.2. Point Cloud Data

A LIDAR device according to an embodiment may generate point cloud data on the basis of light received from outside. Herein, the point cloud data may refer to data including at least one piece of information on an external object on the basis of an electrical signal generated by receiving at least some of light scattered from the external object. For example, the point cloud data may be a data group including location information and intensity information of a plurality of detection points from which light is scattered, but is not limited thereto.

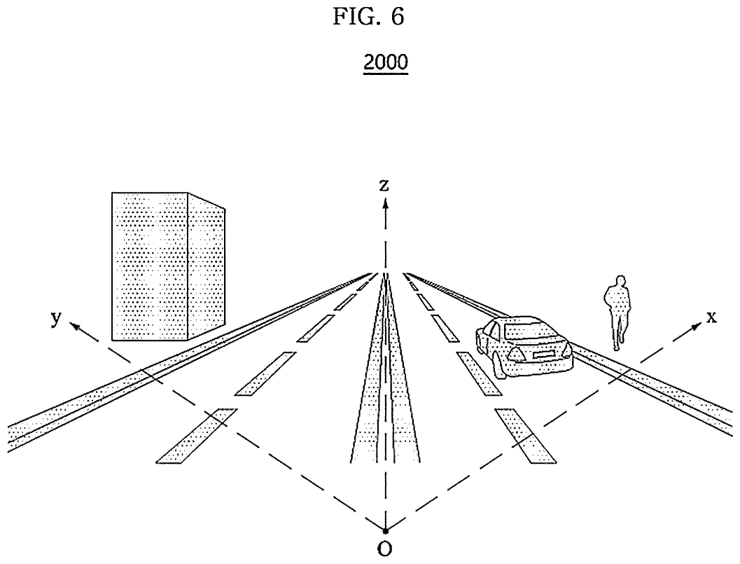

FIG. 6 is a diagram illustrating data displayed on a 3D map, the data being obtained by a LIDAR device.

Referring to FIG. 6, a controller of a LiDAR device may form a 3D point cloud image for a point data set on the basis of obtained detection signals. In addition, the location of the origin (O) of the 3D point cloud image may correspond to the optical origin of the LiDAR device. However, without being limited thereto, the location of the origin (O) of the 3D point cloud image may correspond to the location of the center of gravity of the LiDAR device or the location of the center of gravity of a vehicle at which the LiDAR device is placed.

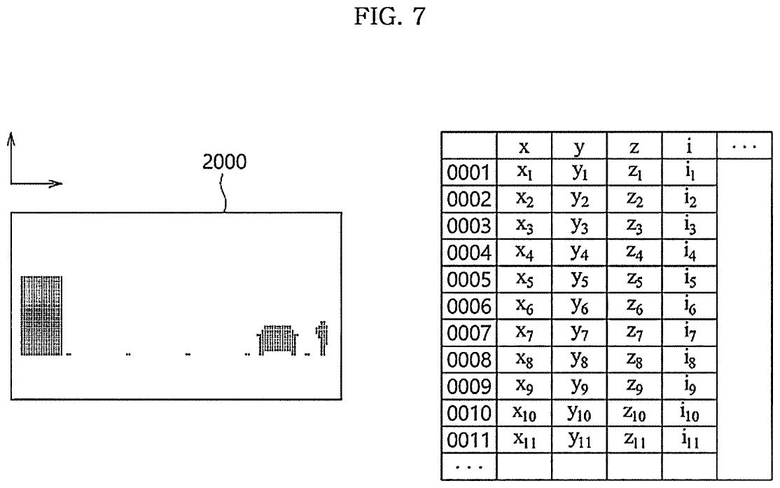

FIG. 7 is a diagram illustrating a point cloud simply displayed on a 2D plane.

Referring to FIG. 7, point cloud data 2000 may be represented on a 2D plane.

In addition, the point cloud data is represented on the 2D plane in the present specification, but may actually be for simply representing data on a 3D map.

In addition, the point cloud data 2000 may be represented in the form of a data sheet. A plurality of pieces of information included in the point cloud data 2000 may be represented as values on the data sheet.

Hereinafter, the meaning of various forms of data included in the point cloud data and sensor data will be described in detail.

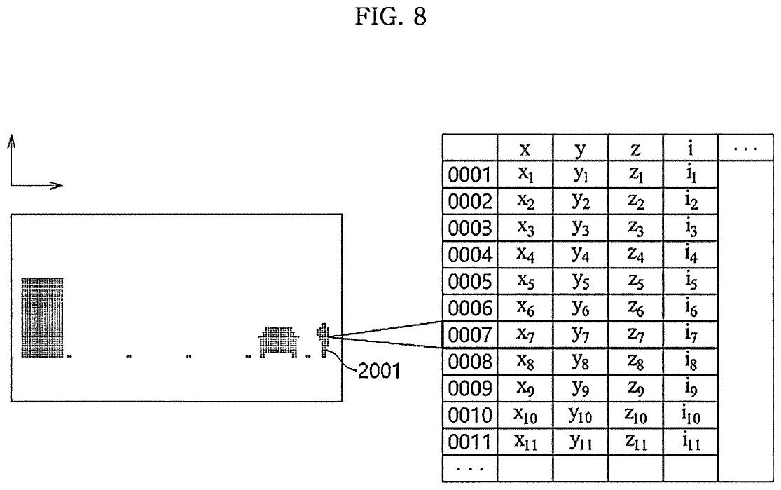

FIG. 8 is a diagram illustrating point data obtained from a LiDAR device according to an embodiment.

Referring to FIG. 8, the point cloud data 2000 may include point data 2001. Herein, the point data may refer to data that may be obtained first as the LiDAR device detects an object. In addition, the point data may refer to raw data that is unprocessed initial information obtained from the LiDAR device.

In addition, as the LiDAR device scans at least a portion of the object, the point data 2001 may be obtained, and the point data 2001 may include location coordinates (x,y,z). In addition, according to an embodiment, the point data 2001 may further include an intensity value (I).

In addition, the number of pieces of the point data 2001 may corresponds to the number of lasers that are received by the LiDAR device after emitted from the LiDAR device and scattered from the object.

More specifically, when lasers emitted from the LiDAR device are scattered from at least a portion of the object and received by the LiDAR device, the LiDAR device may generate the point data 2001 by processing, each time the lasers are received, signals corresponding to the received lasers.

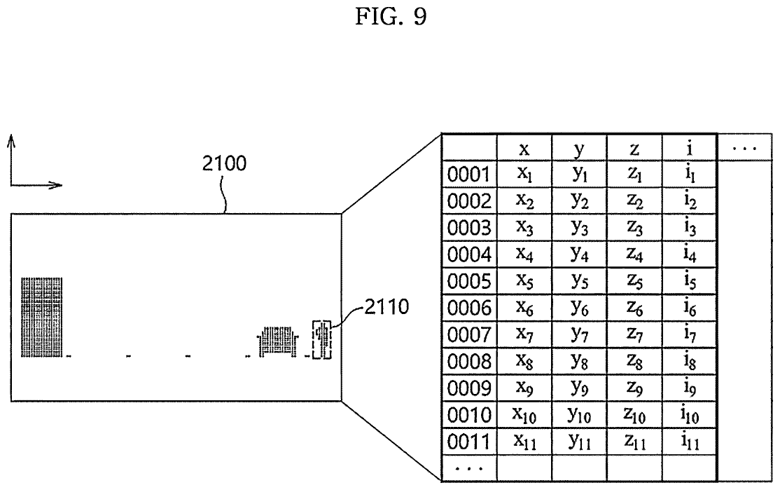

FIG. 9 is a diagram illustrating a point data set obtained from a LiDAR device.

Referring to FIG. 9, point cloud data 2000 may include a point data set 2100. Herein, the point data set 2100 may refer to one data set included in the point cloud data 2000. However, without being limited thereto, the point data set 2100 may collectively refer to a plurality of data sets. In addition, according to an embodiment, the point data set 2100 and the point cloud data 2000 may be interchangeable.

In addition, the point data set 2100 may refer to a plurality of pieces of point data generated as the LiDAR device scans a scan region once. For example, when the LiDAR device has a 180-degree horizontal field of view, the point data set 2100 may refer to all pieces of point data obtained as the LiDAR device performs 180-degree scanning once.

In addition, the point data set 2100 may include location coordinates (x,y,z) and an intensity value (I) of an object included in the field of view of the LiDAR device. In addition, location coordinates (x,y,z) and an intensity value (I) of the point data 2001 included in the point data set 2100 may be represented on a data sheet.

In addition, the point data set 2100 may include noise data. The noise data may be generated by an external environment regardless of the object located in the field of view of the LiDAR device. For example, the noise data may include noise caused by interference between LiDARs, noise caused by ambient light, such as sunlight, or noise caused by an object at a distance greater than a measurable distance, but is not limited thereto.

In addition, the point data set 2100 may include background information. The background information may refer to at least one piece of point data not related to the object among a plurality of pieces of point data included in the point data set 2100. In addition, the background information may be pre-stored in an autonomous driving system including the LiDAR device. For example, the background information may include information on a static object (or a fixed object with a fixed location), such as a building, and the background information may be pre-stored in the form of a map in the LiDAR device.

Referring back to FIG. 8, the point cloud data 2000 may include a sub point data set 2110. Herein, the sub point data set 2110 may refer to a plurality of pieces of point data 2001 representing the same object. For example, when the point data set 2100 includes a plurality of pieces of point data representing a human, the plurality of pieces of point data may constitute one sub point data set 2110.

In addition, the sub point data set 2110 may be included in the point data set 2100. In addition, the sub point data set 2110 may represent at least one object or at least a portion of one object included in the point data set 2100. More specifically, the sub point data set 2110 may refer to a plurality of pieces of point data representing a first object among a plurality of pieces of point data included in the point data set 2100.

In addition, the sub point data set 2110 may be obtained through clustering of at least one piece of point data related to a dynamic object among a plurality of pieces of point data included in the point data set 2100. More specifically, after detecting a static object and a dynamic object (or a moving object) included in the point data set 2100 by using the background information, pieces of data related to one object are grouped into a particular cluster to obtain the sub point data set 2110.

In addition, the sub point data set 2110 may be generated using machine learning. For example, on the basis of machine learning trained for various objects, the controller of the LiDAR device may determine that at least some of a plurality of pieces of data included in the point cloud data 2000 represent the same object.

In addition, the sub point data set 2110 may be generated by segmenting the point data set 2100. Herein, the controller of the LiDAR device may segment the point data set 2100 into predetermined segment units. In addition, at least one segment unit of the segmented point data set may represent at least a portion of a first object included in the point data set 2100. In addition, a plurality of segment units representing the first object may correspond to the sub point data set 2110.

### 3.3. Property Data

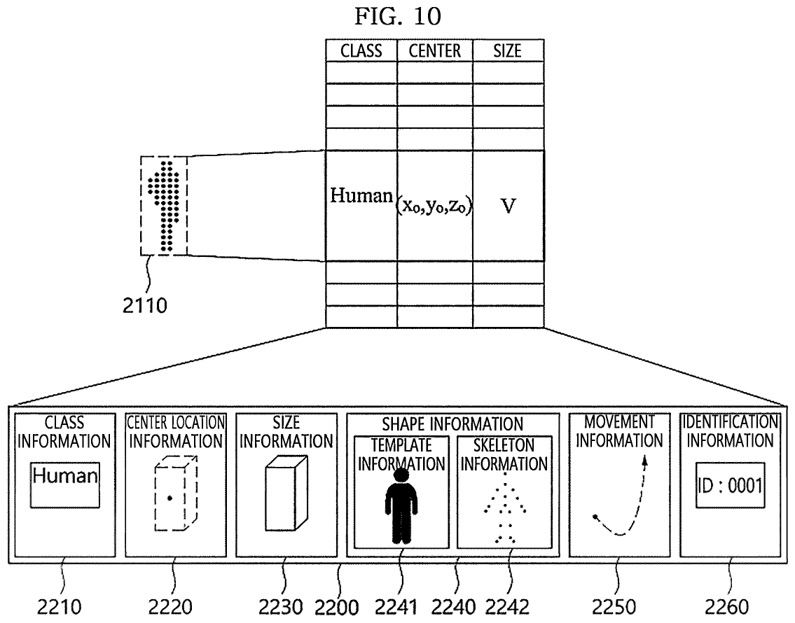

FIG. 10 is a diagram illustrating multiple pieces of information included in property data according to an embodiment.

Referring to FIG. 10, the LiDAR device may obtain property data 2200. For example, the property data 2200 may include class information 2210, center location information 2220, size information 2230, shape information 2240, movement information 2250, and identification information 2260 of an object represented by the sub point data set 2110, but is not limited thereto.

Herein, the property data 2200 may be determined on the basis of at least one sub point data set 2110. More specifically, the property data 2200 may include information on various properties of the object, such as the type, size, speed, and direction of the object, represented by the at least one sub point data set 2110. In addition, the property data 2200 may be data obtained by processing at least some of the at least one sub point data set 2110.

In addition, a process of generating the property data 2200 from the sub point data set 2110 included in the point data set 2100 may use a PCL library algorithm.

For example, a first process related to generation of the property data 2200 using the point cloud library (PCL) algorithm may include preprocessing a point data set, removing background information, detecting feature points (keypoints), defining descriptors, matching the feature points, and estimating properties of the object, but is not limited thereto.

Herein, the preprocessing of the point data set may mean processing the point data set into a form suitable for the PCL algorithm. In the first process, point data included in the point data set 2100 and irrelevant to extraction of property data of the object may be removed. For example, the preprocessing of the data may include removing noise data included in the point data set 2100, and resampling a plurality of pieces of point data included in the point data set 2100, but is not limited thereto.

In addition, through the removing of the background information, the background information included in the point data set 2100 may be removed and a sub point data set 2110 related to the object may be extracted in the first process.

In addition, through the detecting of the feature points, the feature points well representing the shape characteristics of the object may be detected among a plurality of pieces of point data included in the sub point data set 2110 related to the object remaining after the background information is removed in the first process.

In addition, through the defining of the descriptors, the descriptors for describing unique characteristics of the detected feature points may be defined in the first process.

In addition, through the matching of the feature points, descriptors of feature points included in pre-stored template data related to the object may be compared to the descriptors of the feature points of the sub point data set 2110 and corresponding feature points may be selected in the first process.

In addition, through the estimating of the properties of the object, a geometric relationship of the selected feature points may be used to detect the object represented by the sub point data set 2110 and the property data 2200 may be generated in the first process.

As another example, a second process related to generation of the property data 2200 may include preprocessing data, detecting data of an object, clustering the data of the object, classifying cluster data, and tracking the object, but is not limited thereto.

Herein, through the detecting of the data of the object, a plurality of pieces of point data representing the object may be extracted among a plurality of pieces of point data included in the point data set 2100, by using pre-stored background data in the second process.

In addition, through the clustering of the data of the object, a sub point data set 2110 may be extracted by clustering at least one piece of point data representing one object among the plurality of pieces of point data in the second process.

In addition, through the classifying of the cluster data, class information of the sub point data set 2110 may be classified or determined using a pre-trained machine learning model or deep learning model in the second process.

In addition, through the tracking of the object, the property data 2200 may be generated on the basis of the sub point data set 2110 in the second process. For example, the controller performing the second process may display the location of the object using center location coordinates and volumes of a plurality of sub point data sets 2110. Accordingly, a corresponding relationship is defined on the basis of similarity information in distance and shape between a plurality of sub point data sets obtained from successive frames and the object is tracked, thereby estimating the movement direction and speed of the object.

The LiDAR data may encompass not only the point cloud data and the property data described above, but also all types of data that the LiDAR device generates on the basis of lasers received through the detectors. However, in the present specification, LiDAR data is described assuming that the LiDAR data described below refers to point cloud data, but this is for convenience of description and is not actually limited thereto.

### 4. LiDAR Data Generation Method

### 4.1. LiDAR Data Generation Method According to Embodiment

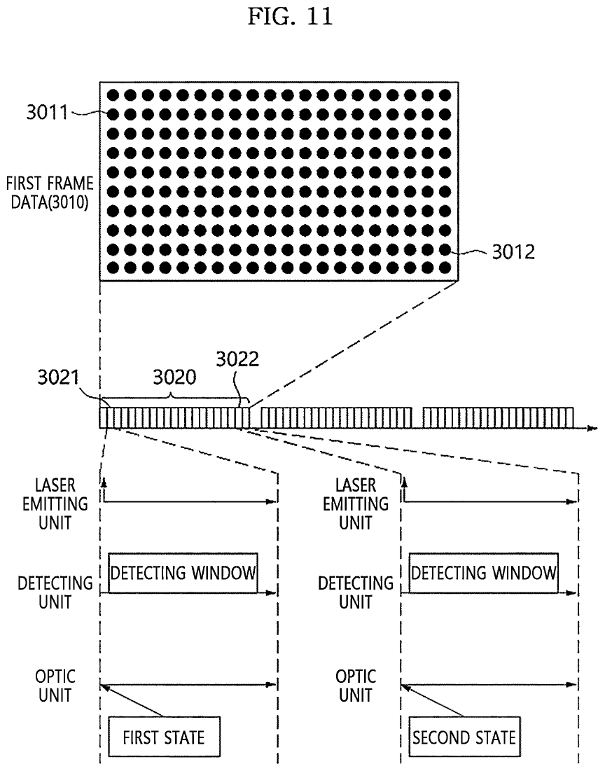

FIG. 11 is a diagram illustrating the operation of a LiDAR device according to an embodiment.

The details described with reference to FIG. 11 may be applied to a LiDAR device, especially a LiDAR device of which an optic unit includes a scanning mirror, such as a nodding mirror or a rotating mirror. However, without being limited thereto, the details described below may be applied to LiDAR devices having various applicable structures.

Referring to FIG. 11, a LiDAR device according to an embodiment may obtain point data corresponding to at least one piece of frame data.

Herein, the frame data may refer to a data set constituting one screen, a point data set obtained during a predetermined period of time, a point data set defined in a predetermined form, a point cloud obtained during a predetermined period of time, a point cloud defined in a predetermined form, a point data set used for at least one data processing algorithm, or a point cloud used for at least one data processing algorithm, but is not limited thereto. The frame data may correspond to various concepts that can be understood as frame data by those skilled in the art.

The at least one piece of frame data may include first frame data 3010.

Herein, the first frame data 3010 shown in FIG. 11 is simply represented as a 2D image for convenience of description, but is not limited thereto.

In addition, the first frame data 3010 may correspond to a point data set obtained during a first time interval 3020, and the point data set may include a plurality of pieces of point data. Herein, the above-described details may be applied to the point data set and the plurality of pieces of point data, so a redundant description will be omitted.

For example, as shown in FIG. 11, the first frame data 3010 may include first point data 3011 and second point data 3012, but is not limited thereto.

In addition, each piece of point data included in the first frame data 3010 may be obtained on the basis of a signal output from a detecting unit as a laser emitted from a laser emitting unit included in the LiDAR device reflects off an object and the reflected laser is received by the detecting unit.

Accordingly, the first time interval 3020 for obtaining the first frame data 3010 may include a plurality of sub time intervals during which at least one piece of point data is obtained.

For example, the first time interval 3020 for obtaining the first frame data 3010 may include a first sub time interval 3021 for obtaining the first point data 3011 and a second sub time interval 3022 for obtaining the second point data 3012, but is not limited thereto.

In addition, the laser emitting unit, the detecting unit, and the optic unit included in the LiDAR device may operate in each of the plurality of sub time intervals.

for example, the laser emitting unit, the detecting unit, and the optic unit included in the LiDAR device may operate in the first sub time interval 3021 included in the plurality of sub time intervals, and the laser emitting unit, the detecting unit, and the optic unit included in the LiDAR device may operate in the second sub time interval 3022. However, no limitation thereto is imposed.

More specifically, the laser emitting unit may operate to output a laser when the optic unit is in at least one state, and the detecting unit may operate to detect the laser emitted from the laser emitting unit.

For example, in the first sub time interval 3021, the laser emitting unit may operate to output a laser when the optic unit is in a first state and the detecting unit may operate to detect the laser emitted from the laser emitting unit when the optic unit is in the first state. However, no limitation thereto is imposed.

In addition, for example, in the second sub time interval 3022, the laser emitting unit may operate to output a laser when the optic unit is in a second state and the detecting unit may operate to detect the laser emitted from the laser emitting unit when the optic unit is in the second state. However, no limitation thereto is imposed.

In addition, when a time interval in which the detecting unit operates to detect a laser emitted from the laser emitting unit is called a detecting window, the detecting window may have a particular time length from the time point the laser is output from the laser emitting unit. However, no limitation thereto is imposed.

In addition, the laser emitting unit operating in the first sub time interval 3021 and the laser emitting unit operating in the second sub time interval 3022 may be the same or different.

For example, the laser emitting unit may include a first laser emitting unit and a second laser emitting unit. The laser emitting unit operating in the first sub time interval 3021 and the laser emitting unit operating in the second sub time interval 3022 may be the same, or the laser emitting unit operating in the first sub time interval 3021 may be the first laser emitting unit and the laser emitting unit operating in the second sub time interval 3022 may be the second laser emitting unit. However, no limitation thereto is imposed.

In addition, the detecting unit operating in the first sub time interval 3021 and the detecting unit operating in the second sub time interval 3022 may be the same or different.

For example, the detecting unit may include a first detecting unit and a second detecting unit. The detecting unit operating in the first sub time interval 3021 and the detecting unit operating in the second sub time interval 3022 may be the same, or the detecting unit operating in the first sub time interval 3021 may be the first detecting unit and the detecting unit operating in the second sub time interval 3022 may be the second detecting unit. However, no limitation thereto is imposed.

In addition, the first state of the optic unit in the first sub time interval 3021 and the second state of the optic unit in the second sub time interval 3022 may be different.

For example, when the optic unit includes a rotating mirror, the first state of the optic unit in the first sub time interval 3021 may refer to a state in which the rotating mirror has rotated by a first angle, and the second state of the optic unit in the second sub time interval 3022 may refer to a state in which the rotating mirror has rotated by a second angle different from the first angle. However, no limitation thereto is imposed.

In addition, each of the plurality of pieces of point data included in the first frame data 3010 may be obtained on the basis of the time when a laser is emitted from the laser emitting unit, the time when the laser is detected by the detecting unit, and state information of the optic unit.

For example, the first point data 3011 included in the first frame data 3010 may be obtained on the basis of information on the time the laser is output from the laser emitting unit when the optic unit is in the first state in the first sub time interval 3021, information on the time the laser emitted from the laser emitting unit is detected by the detecting unit, and information on the first state of the optic unit, but is not limited thereto.

In addition, for example, the second point data 3012 included in the first frame data 3010 may be obtained on the basis of information on the time the laser is output from the laser emitting unit when the optic unit is in the second state in the second sub time interval 3022, information on the time the laser emitted from the laser emitting unit is detected by the detecting unit, and information on the second state of the optic unit, but is not limited thereto.

### 4.2. LiDAR Data Generation Using Histogram Data (Photon Counting Histogram (PCH))

### 4.2.1. Histogram Data (PCH) Generation Method

A LIDAR device according to an embodiment may generate histogram data on the basis of light received through a detecting unit. Herein, the detecting unit may include a detector array. For example, the detecting unit may include a SPAD array as shown in FIG. 2, but is not limited thereto.

For example, histogram data may be accumulated using a 2D SPAD array. Herein, using the histogram data, the LiDAR device may detect a light-receiving time point of a laser beam reflects off an object and is received.

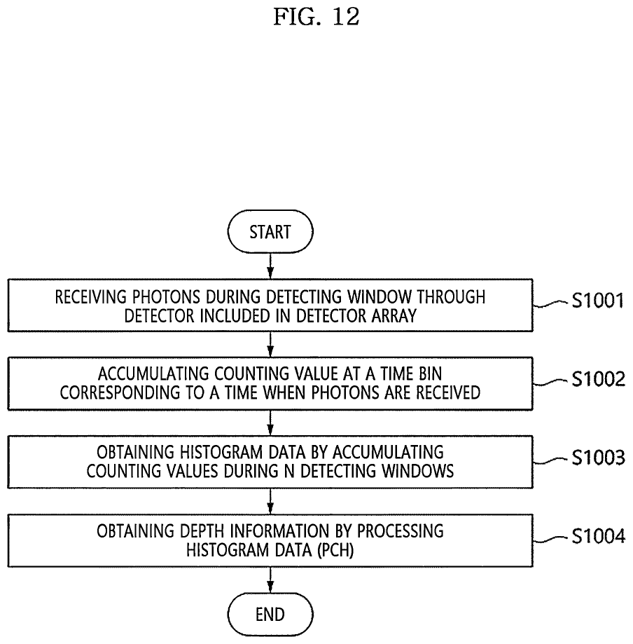

In the description of FIG. 12 below, a basic algorithm for generating histogram data and various terms related to the histogram data will be defined.

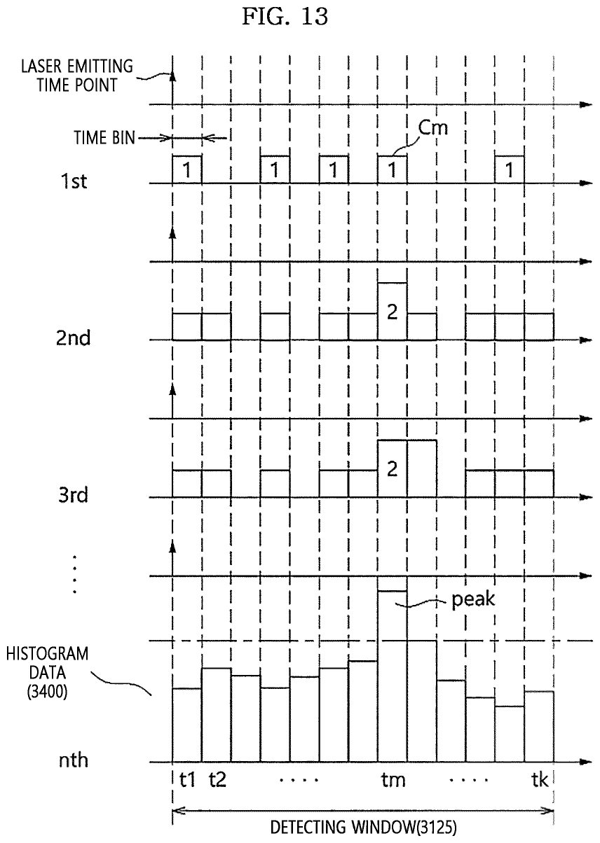

In addition, in the description of FIG. 13 below, a specific process of generating histogram data and obtaining depth information on the basis of the histogram data will be defined in detail.

FIG. 12 is a diagram illustrating a method of generating histogram data by a LiDAR device according to an embodiment.

Referring to FIG. 12, a LiDAR device according to an embodiment may receive photons during a detecting window through detectors included in a detector array in step S1001.

Herein, the detecting window is a time interval defined for each of the detectors included in the detector array. The detecting window may mean a time interval during which the detector operates to detect a laser emitted from a laser emitting unit.

For example, the detecting window may be divided into a plurality of time bins each having a unit time length, but is not limited thereto.

As a more specific example, when the detecting window is implemented as 1.28 μs, the detecting window may be configured to be divided into 1024 time bins each having a time length of 1.25 ns, but is not limited thereto.

In addition, the plurality of time bins constituting the detecting window may have the same unit time length. However, without being limited thereto, the plurality of time bins may have different time lengths.

In addition, the detecting window may be a time interval for matching a signal obtained from the detector to the plurality of preset time bins. More specifically, a detecting window may be a time interval for matching a signal obtained from the detector to a time bin corresponding to the time point when the signal is obtained.

In addition, the LiDAR device may accumulate a counting value during a time bin corresponding to the time when photons are received in step S1002.

Herein, the LiDAR device may generate and store the counting value to numerically express a signal generated by the detector. Specifically, the counting value may be generated in response to the detector receiving photons. For example, when the detector receives photons and obtains a detection signal, the controller of the LiDAR device may accumulate a counting value of 1 in the time bin corresponding to the time when light is received. However, no limitation thereto is imposed. In other words, the counting value may be a value expressed as a natural number or 1 or greater for representing how many times that the detector has received photons, but is not limited thereto.

In addition, the LiDAR device may obtain histogram data by accumulating the counting values during N detecting windows in step S1003. Specifically, the controller of the LiDAR device may open a detecting window each time a laser is output, and may accumulate a counting value in at least one time bin in response to the received photons, and may repeatedly accumulate the counting values during N times of detecting, thereby obtaining the histogram data.

In addition, the LiDAR device may process the histogram data to obtain depth information in step S1004. Specifically, the controller of the LiDAR device may process the histogram data accumulated during the N detecting windows, on the basis of a predetermined algorithm thereby obtaining the depth information.

The controller of the LiDAR device may extract at least one feature from the histogram data accumulated during the N detecting windows, and may obtain the depth information by using an algorithm for obtaining the depth information on the basis of the extracted feature.

For example, the controller of the LiDAR device may extract a peak value from the histogram data accumulated during the N detecting window and may use an algorithm for obtaining the depth information on the basis of the extracted peak value. Herein, the peak value may refer to at least one counting value that is great among a plurality of counting values of the histogram data, or to at least one time bin corresponding to the at least one counting value.

In addition, without limitation thereto, the controller may use various features, such as a rising edge, a falling edge, and a center peak, and may use various algorithms for obtaining depth information.

As a more specific example, the controller of the LiDAR device may extract at least one time bin in which a counting value is equal to or greater than a predetermined threshold from the histogram data, and may determine a time bin that may represent the at least one time bin as a peak. However, without being limited thereto, the controller may determine the counting value corresponding to the time bin as a peak. As a specific example, the controller may determine the time bin corresponding to the highest counting value in the histogram data as a peak, but is not limited thereto. In this case, using the histogram data, the LiDAR device may detect the peak time point in the histogram data as the light-receiving time point of the laser beam that reflects off an object and is received.

In addition, the depth information may be a distance value to a detection point at which a laser reflects off when the laser emitted from the laser emitting unit reflects and is received through a detector. That is, the depth information may refer to a distance from the LiDAR device to the detection point, and the LiDAR device may calculate a distance value on the basis of the time of flight (TOF) of the laser, thereby obtaining the depth information. The details of a method of calculating a distance value on the basis of the time of flight of a laser have been described above, so the details will be omitted hereinafter.

FIG. 13 is a diagram illustrating a specific method of obtaining depth information on the basis of histogram data by a LiDAR device according to an embodiment.

A detector of a LiDAR device according to an embodiment may detect photons. For example, the detector may be a SPAD, but is not limited thereto.

In addition, after the detector detects photons, a recovery time that it takes to return to a state in which the detector is capable of detecting photons again may be required. For example, when the recovery time has not elapsed after the SPAD detects photons, the SPAD is unable to detect photons even if the photons are incident to the SPAD. For example, the recovery time may be a time interval equal to one or more time bins.

In addition, when the detector detects photon, the detector may generate and transmit a detection signal to the controller. In addition, the controller of the LiDAR device may convert the detection signal into a digital signal and generate and store a counting value. In addition, the controller may store the counting value in the form of a histogram corresponding to the magnitude of the counting value.

According to an embodiment, after a laser is output from the laser emitting unit, the detector may detect photons during a detecting window 3125. Specifically, the detector may detect photons reflecting off a detection point to which the output laser is emitted, and other photons during the detecting window 3125. Herein, the other photons may refer to ambient light (for example, sunlight and reflected light inside the LiDAR) and interfering light caused by other lasers, but are not limited thereto.

In addition, the start time point of the detecting window 3125 and the laser emission time point of the laser emitting unit may be the same or, without being limited thereto, may be different.

In addition, the detecting window 3125 may be configured divided into a plurality of time bins. For example, the detecting window 3125 may be divided into a first time bin (t1), a second time bin (t2), . . . , and a k-th time bin (tk), but is not limited thereto.

In addition, when the detector detects photons, the controller may generate a counting value (Cm) corresponding to the detected photons. Specifically, the controller may accumulate a counting value in a time bin corresponding to the time point at which the photons are detected. In addition, the controller may store accumulated counting values in the form of a histogram corresponding to the magnitudes of counting values.

In addition, the detector may detect photons during n detecting windows, and the controller may generate histogram data by accumulating counting values during the n detecting cycles. Herein, a detecting cycle may be a time interval from the laser emission time point of the laser emitting unit to the end time point of the detecting window. For example, n may be 128 or, without being limited thereto, a value determined on the basis of the sampling rate preset in the LiDAR device.

Hereinafter, a method of generating histogram data will be described on the basis of an example of counting values accumulated in an m-th time bin (tm) among a plurality of counting values included in histogram data.

Referring to FIG. 13, the detector may detect photons during a first cycle after the laser emitting unit outputs the first laser beam. Herein, the first cycle may correspond to a detecting window. More specifically, when the LiDAR device accumulates counting values during N detecting windows to obtain histogram data, the first cycle may be the time interval corresponding to the first detecting window.

Herein, the controller may allocate and store a counting value in a time bin corresponding to the time point when the detector detects photons. For example, the controller may allocate a counting value (Cm) to the m-th time bin (tm) in association with photons received by the detector, but is not limited thereto. In this case, the counting value (Cm) may be 1, but is not limited thereto.

In addition, the detector may detect photons during a second cycle after the laser emitting unit outputs the second laser beam. Herein, when photons are received at the time point corresponding to the m-th time bin (tm), the controller may allocate a counting value to the m-th time bin (tm). In this case, the controller may accumulate the counting value to update the counting value (Cm) to 2. However, without being limited thereto, the counting value may be finally updated by adding all counting values after N cycles are performed.

In addition, the detector may detect photons during a third cycle after the laser emitting unit outputs the third laser beam. Herein, when photons are not received at the time point corresponding to the m-th time bin (tm), the controller may not allocate a counting value to the m-th time bin (tm). In this case, the controller does not accumulate the counting value, so the counting value (Cm) may be still 2.

In addition, the detector may detect photons during the n-th cycle after the laser emitting unit outputs the n-th laser beam. Herein, the counting value allocated to the m-th time bin (tm) may be the final value of the counting values accumulated during n detecting cycles.

As described above, the controller of the LiDAR device may generate histogram data (3400) by accumulating counting values during n detecting cycles.

Hereinafter, a method of extracting an actual detecting time point from histogram data to obtain depth information of a detection point of an object on the basis of the histogram data will be described.

### 4.2.2. Depth Information Obtainment Method Based on Histogram Data

A LIDAR device according to an embodiment may generate histogram data on the basis of photons received from a detector. Specifically, the detector of the LiDAR device may generate a detection signal by receiving photons, and the controller of the LiDAR device may generate histogram data by accumulating a counting value on the basis of the detection signal. Herein, the detection signal may include an actual signal generated by receiving photons reflecting off an actual detection point, and a noise signal generated by receiving photons arriving from sunlight or interfering light. For example, the histogram data may include a plurality of counting values generated in association with an actual signal generated by receiving photons reflecting off an actual detection point, and a plurality of counting values generated in association with a noise signal generated by receiving photons arriving from sunlight or interfering light.

In addition, a controller of a LiDAR device according to an embodiment may calculate the time of flight (TOF) of a laser to obtain depth information of a detection point. Herein, the time of flight of a laser may be a time interval between the time point when the laser is output from a laser emitting unit and the time point when the output laser reaches a detector. In this case, the time point when the output laser reflects off the detection point and reaches the detector and is received may be defined as a detection time point of the laser.

Therefore, in order to obtain accurate depth information of the detection point, the LiDAR device needs to determine an accurate detection time point of the laser reflecting off the detection point. Accordingly, the LiDAR device including a detector array may generate histogram data and may determine a detection time point of a laser on the basis of the histogram data.

A LIDAR device according to an embodiment may use histogram data to determine an accurate detection time point. Specifically, the controller may extract a time bin corresponding to a detection time point from the histogram data. For example, the LiDAR device may extract an actual signal from the histogram data and may extract a time bin corresponding to the actual signal, but is not limited thereto.

The controller of the LiDAR device may extract a counting value and a time bin corresponding to an actual signal from the histogram data by using various methods. For example, the LiDAR device may extract at least one feature value from the histogram data and may extract a time bin corresponding to the extracted feature value.

For example, referring back to FIG. 13, the LiDAR device may extract a peak value with the highest counting value among a plurality of counting values from the histogram data, and may extract a time bin (tm) corresponding to the extracted peak value.

In addition, as another example, the controller of the LiDAR device may extract at least one counting value that is equal to or greater than a threshold 768 from among a plurality of counting values of the histogram data (3400), and may extract at least one time bin corresponding to the at least one counting value.

In addition, a controller of a LiDAR device according to an embodiment may determine a detection time point on the basis of a time bin extracted using various methods. This is because information on a particular time point is required to determine a laser arrival time point for calculating the time of flight of a laser and it is necessary to determine a time point for representing a time bin as a time bin is defined as a time interval.

For example, when the controller of the LiDAR device extracts one time bin corresponding to a peak value of histogram data, a median value of the extracted time bin may be determined as a detection time point. In addition, in this case, the controller may calculate the time of flight of a laser on the basis of a time interval from a laser emission time point to the determined median value. Without being limited thereto, the controller may determine the start value or the end value of the extracted time bin as a detection time point.

In addition, for example, when the controller of the LiDAR device extracts a plurality of time bins corresponding to a peak value of histogram data, the median value of the extracted plurality of time bins may be determined as the detection time point. In addition, without being limited thereto, the controller may calculate an interpolation value by interpolating the plurality of time bins on the basis of counting values in the plurality of time bins, and may determine the calculated interpolation value as a detection time point. Herein, a method of interpolating data by the controller of the LiDAR device may be performed on the basis of a standard deviation of counting values, but without being limited thereto, various methods of performing mathematical interpolation of data by those skilled in the art may be applied.

The LiDAR device may determine a detection time point using histogram data on the basis of the above-described method, and may obtain depth information of a detection point by using a time difference between the laser emission time point and the detection time point.

### 4.2.3. Intensity Information Obtainment Method Based on Histogram Data

LiDAR data that a LiDAR device according to an embodiment obtains may include intensity information. Herein, the intensity information may semantically refer to the intensity of a laser reflecting off an object. However, without being limited thereto, the intensity information may refer to a parameter derived in relation to the intensity of a laser or the number of photons reflecting off an object. In other words, the intensity information may be information that represents the intensity of reflection at which a laser reflects. In addition, the intensity information may be represented as a term such as reflection intensity information, reflectivity information, or reflection information.

In addition, the intensity information may include an intensity value. Herein, the intensity value may be a value resulting from quantifying the degree to which a laser reflects off a detection point. More specifically, the LiDAR device may calculate an intensity value for each of a plurality of detection points, and may generate intensity information including the intensity values.

A LIDAR device according to an embodiment may obtain intensity information on the basis of various algorithms.

For example, in an embodiment, a LiDAR device including a detector array may obtain intensity information of a detection point on the basis of histogram data.

More specifically, the controller of the LiDAR device may determine a time bin corresponding to a detection point in the histogram data, and may determine a counting value matching the time bin as an intensity value of the detection point.

For example, referring to FIG. 13, the controller of the LiDAR device may determine the counting value matching the m-th time bin determined as the detection time point of the object, as the intensity value of the detection point.

In addition, without being limited thereto, the controller of the LiDAR device may determine the histogram area of at least one time bin in which a counting value in the histogram data is equal to or greater than a predetermined value, as the intensity value of the detection point. Herein, the histogram area is a value for representing the size of the histogram in the histogram data, and may refer to a value obtained by multiplying the size of a time bin by a counting value, but is not limited thereto.

For example, referring to FIG. 13, the controller of the LiDAR device may determine the histogram area of the m-th time bin having a counting value equal to or greater than a predetermined value (th) in the histogram data, as the intensity value of the detection point.

A method of obtaining intensity information of a detection point on the basis of histogram data is not limited to the above-described method, and various methods of calculating an intensity value on the basis of histogram data may be applied.

The LiDAR device may obtain depth information and intensity information of a detection point by using histogram data on the basis of the above-described method.

In addition, the LiDAR device may obtain LiDAR data by using the depth information or

the intensity information or both of the detection point obtained using the above-described method. Hereinafter, a method of generating LiDAR data by using histogram data by a LiDAR device will be described in time series.

### 4.2.4. LiDAR Data Generation Method Using Histogram Data

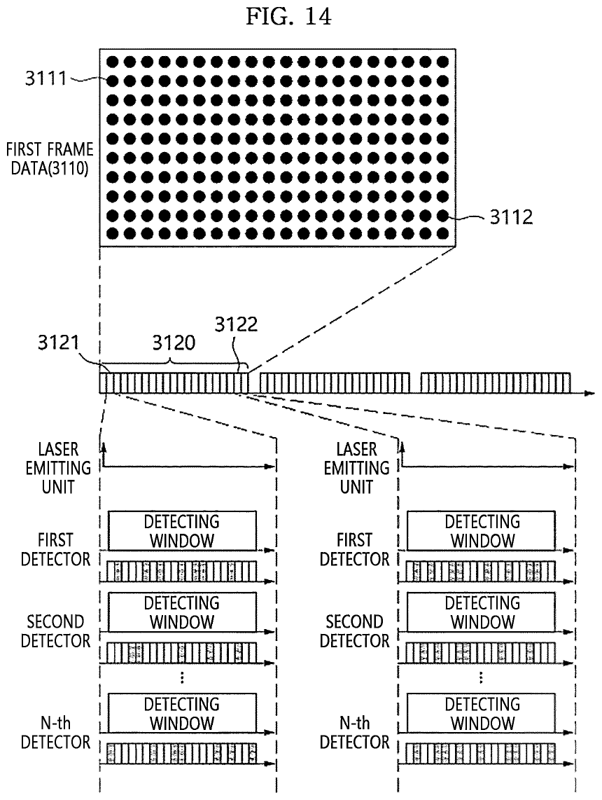

FIG. 14 is a diagram illustrating the operation of a LiDAR device according to an embodiment.

The details described with reference to FIG. 14 may be applied to a LiDAR device, especially a flash-type a LiDAR device of which a detecting unit includes a detector array. However, without being limited thereto, the details described below may be applied to LiDAR devices having various applicable structures.

Herein, the flash-type LiDAR device is a type of LiDAR device in which when a laser emitting unit outputs a laser, all detectors included in the detector array receive the laser. For example, the flash-type LiDAR device may be designed such that all emitters included in the laser emitting unit output lasers and all the detectors included in the detector array receive at least some of the output lasers and depth information of an object is obtained.

Referring to FIG. 14, a LiDAR device according to an embodiment may obtain point data corresponding to at least one piece of frame data.

Herein, the frame data may refer to a data set constituting one screen, a point data set obtained during a predetermined period of time, a point data set defined in a predetermined form, a point cloud obtained during a predetermined period of time, a point cloud defined in a predetermined form, a point data set used for at least one data processing algorithm, or a point cloud used for at least one data processing algorithm, but is not limited thereto. The frame data may correspond to various concepts that can be understood as frame data by those skilled in the art.

The at least one piece of frame data may include first frame data 3110.

Herein, the first frame data 3110 shown in FIG. 14 is simply represented as a 2D image for convenience of description, but is not limited thereto.

In addition, the first frame data 3110 may correspond to a point data set obtained during a first time interval 3120, and the point data set may include a plurality of pieces of point data. Herein, the above-described details may be applied to the point data set and the plurality of pieces of point data, so a redundant description will be omitted.

For example, as shown in FIG. 14, the first frame data 3110 may include first point data 3111 and second point data 3112, but is not limited thereto.

In addition, each piece of point data included in the first frame data 3110 may be obtained on the basis of a signal output from a detecting unit as a laser emitted from the laser emitting unit included in the LiDAR device reflects off an object and the reflected laser is received by the detecting unit.

Accordingly, the first time interval 3120 for obtaining the first frame data 3110 may include a plurality of sub time intervals during which a data set for at least one detector is obtained. Herein, the data set for at least one detector may refer to a counting value set obtained by matching a signal output from the at least one detector to a corresponding time bin, and the data set for the at least one detector may be used in generating histogram data for the at least one detector. In addition, herein, the histogram data may be data obtained by accumulating a plurality of data sets obtained in each of the plurality of sub time intervals. However, without being limited thereto, the histogram data may include any meaning of histogram data understood by those skilled in the art to be histogram data.

For example, the first time interval 3120 for obtaining the first frame data 3110 may include a first sub time interval 3121 for obtaining a first data set for each of the plurality of detectors, and a second sub time interval 3122 for obtaining a second data set for each of the plurality of detectors, but is not limited thereto.

In addition, the laser emitting unit and the detecting unit included in the LiDAR device may operate in each of the plurality of sub time intervals.

For example, the laser emitting unit and the detecting unit included in the LiDAR device may operate in the first sub time interval 3121 included in the plurality of sub time intervals, and the laser emitting unit and the detecting unit included in the LiDAR device may operate in the second sub time interval 3122. However, no limitation thereto is imposed.

More specifically, the laser emitting unit may operate to output a laser at a particular time point, and the detecting unit may operate to detect the laser emitted from the laser emitting unit. The detecting unit may generate a signal based on light detected within a detecting window, and a counting value may be stored in a corresponding time bin on the basis of the generated signal.

For example, in the first sub time interval 3121, the laser emitting unit may operate to output a laser, and first to N-th detectors included in the detecting unit may operate to detect the laser emitted from the laser emitting unit. Each of the first to N-th detectors may generate a signal based on light detected within the detecting window, and a counting value may be stored in a corresponding time bin on the basis of the generated signal. In FIG. 14, under the detecting window of each detector, the way the detecting window is segmented may be to refer to each time bin, and a counting value stored in each time bin may be represented by shading.

In addition, for example, in the second sub time interval 3122, the laser emitting unit may operate to output a laser, and the first to N-th detectors included in the detecting unit may operate to detect the laser emitted from the laser emitting unit. Each of the first to N-th detectors may generate a signal based on light detected within the detecting window, and a counting value may be stored in a corresponding time bin on the basis of the generated signal. In FIG. 14, under the detecting window of each detector, the way the detecting window is segmented may be to refer to each time bin, and a counting value stored in each time bin may be represented by shading.

In addition, in each sub time interval, data sets for the respective detectors may be obtained on the basis of signals generated on the basis of light detected within detecting windows for the respective detectors.

For example, in the first sub time interval 3121, the respective first data sets for the first to N-th detectors may be obtained on the basis of signals generated on the basis of light detected by the first to N-th detectors respectively, but no limitation thereto is imposed.

In addition, for example, in the second sub time interval 3122, the respective second data sets for the first to N-th detectors may be obtained on the basis of signals generated on the basis of light detected by the first to N-th detectors respectively, but no limitation thereto is imposed.

In addition, the laser emitting unit operating in the first sub time interval 3121 and the laser emitting unit operating in the second sub time interval 3122 may be the same or different.

For example, the laser emitting unit may include a first laser emitting unit and a second laser emitting unit. The laser emitting unit operating in the first sub time interval 3121 and the laser emitting unit operating in the second sub time interval 3122 may be the same, or the laser emitting unit operating in the first sub time interval 3121 may be the first laser emitting unit and the laser emitting unit operating in the second sub time interval 3122 may be the second laser emitting unit. However, no limitation thereto is imposed.

In addition, each of the plurality of pieces of point data included in the first frame data 3110 may be obtained on the basis of histogram data for each detector obtained by accumulating a plurality of data sets for each detector with respect to each detector.

For example, the first point data 3111 included in the first frame data 3110 may be obtained on the basis of first histogram data based on the first data set for the second detector obtained in the first sub time interval 3121 and the second data set for the second detector obtained in the second sub time interval 3122, but is not limited thereto.

In addition, for example, the second point data 3112 included in the first frame data 3110 may be obtained on the basis of second histogram data based on the first data set for the N−1-th detector obtained in the first sub time interval 3121 and the second data set for the N−1-th detector obtained in the second sub time interval 3122, but is not limited thereto.

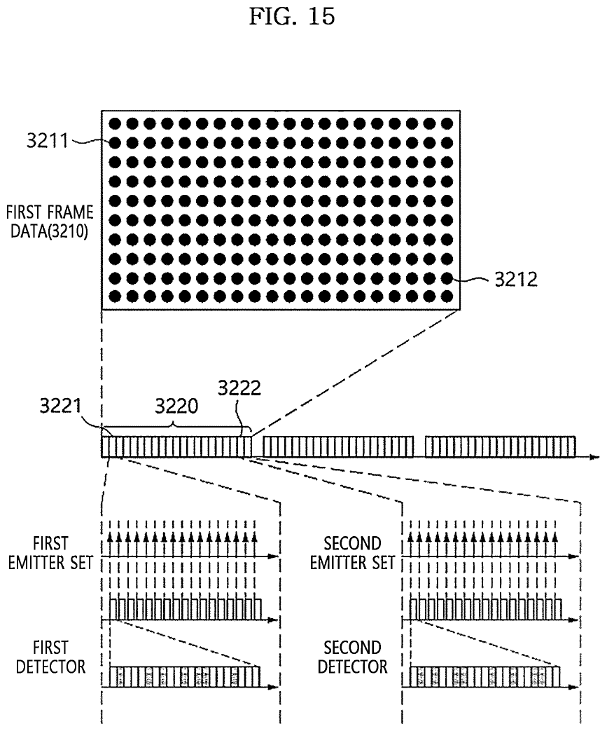

FIG. 15 is a diagram illustrating the operation of a LiDAR device according to an embodiment.

The details described with reference to FIG. 15 may be applied to a LiDAR device, especially a LiDAR device of which a detecting unit includes a detector array and a laser emitting unit includes an emitter array. In particular, the details may be applied to a LiDAR device that includes a laser emitting unit for outputting lasers in an addressable manner. However, no limitation thereto is imposed, and the details described below may be applied to LiDAR devices having various applicable structures.

A laser emitting unit for outputting lasers in an addressable manner may output a laser beam for each emitter unit.

For example, the laser emitting unit may output a laser beam of the emitter unit at row 1, column 1 once and may output a laser beam of the emitter unit at row 1, column 3 once, and then may output a laser beam of the emitter unit at row 2, column 4 once. As described above, the laser emitting unit may output a laser beam of the emitter unit at row A, column B N time and then output a laser beam of the emitter unit at row C, column D M times.

Herein, a SPAD array may receive, among the laser beams output from the corresponding emitter units, the laser beams reflecting back off an object.

For example, in a laser beam output sequence of the laser emitting unit, when the emitter unit at row 1, column 1 outputs a laser beam N times, the SPAD unit at row 1, column 1 corresponding to row 1, column 1 may receive the laser beams reflecting off an object, up to N times.

In addition, for example, when the reflected laser beams need to be accumulated N times in histogram data for the detectors and the laser emitting unit includes M emitter units, the M emitter units may be operated simultaneously N times. Alternatively, the M emitter units may be operated M*N times one by one, or the M emitter units may be operated M*N/5 times five by five.

In addition, in FIG. 15, for convenience of description, a description is made using an emitter set (including at least one emitter for outputting a laser) included in the laser emitting unit and only one of one or more detectors corresponding to the emitter set, but it is to be understood that a plurality of detectors may operate in association with the emitter set.

Referring to FIG. 15, a LiDAR device according to an embodiment may obtain point data corresponding to at least one piece of frame data.

Herein, the frame data may refer to a data set constituting one screen, a point data set obtained during a predetermined period of time, a point data set defined in a predetermined form, a point cloud obtained during a predetermined period of time, a point cloud defined in a predetermined form, a point data set used for at least one data processing algorithm, or a point cloud used for at least one data processing algorithm, but is not limited thereto. The frame data may correspond to various concepts that can be understood as frame data by those skilled in the art.

The at least one piece of frame data may include first frame data 3210.

Herein, the first frame data 3210 shown in FIG. 15 is simply represented as a 2D image for convenience of description, but is not limited thereto.

In addition, the first frame data 3210 may correspond to a point data set obtained during a first time interval 3220, and the point data set may include a plurality of pieces of point data. Herein, the above-described details may be applied to the point data set and the plurality of pieces of point data, so a redundant description will be omitted.

For example, as shown in FIG. 15, the first frame data 3210 may include first point data 3211 and second point data 3212, but is not limited thereto.

In addition, each piece of point data included in the first frame data 3210 may be obtained on the basis of a signal output from a detecting unit as a laser emitted from the laser emitting unit included in the LiDAR device reflects off an object and the reflected laser is received by the detecting unit.

Accordingly, the first time interval 3220 for obtaining the first frame data 3210 may include a plurality of sub time intervals for obtaining at least one piece of histogram data for obtaining at least one piece of point data.

For example, the first time interval 3220 for obtaining the first frame data 3210 may include a first sub time interval 3221 for obtaining first histogram data for obtaining the first point data 3211 and a second sub time interval 3222 for obtaining second histogram data for obtaining the second point data 3212, but is not limited thereto.

In addition, the laser emitting unit and the detecting unit included in the LiDAR device may operate in each of the plurality of sub time intervals.

For example, the laser emitting unit and the detecting unit included in the LiDAR device may operate in the first sub time interval 3221 included in the plurality of sub time intervals, and the laser emitting unit and the detecting unit included in the LiDAR device may operate in the second sub time interval 3222. However, no limitation thereto is imposed.

More specifically, the laser emitting unit may operate to output lasers N times, and the detecting unit may operate in synchronization with the laser emitting unit to detect the lasers output N times from the laser emitting unit. The detecting unit may generate a signal based on light detected within a detecting window, and a counting value may be stored in a corresponding time bin on the basis of the generated signal.

For example, in the first sub time interval 3221, a first emitter set included in the laser emitting unit may operate to output lasers, and a first detector included in the detecting unit may operate to detect the lasers output from the first emitter set. The first detector may generate a signal based on light detected within the detecting window, and a counting value may be stored in a corresponding time bin on the basis of the generated signal.

In addition, for example, in the first sub time interval 3221, the first emitter set may operate to output lasers N times, and the first detector may operate in a detecting window corresponding to each laser emission, may generate a signal based on light detected within each detecting window, and may generate a data set by storing a counting value in a corresponding time bin on the basis of the generated signal. Accordingly, histogram data may be obtained on the basis of N data sets corresponding to the lasers output N times.

In addition, for example, in the second sub time interval 3222, a second emitter set included in the laser emitting unit may operate to output lasers, and a second detector included in the detecting unit may operate to detect the lasers output from the second emitter set. The second detector may generate a signal based on light detected within the detecting window, and a counting value may be stored in a corresponding time bin on the basis of the generated signals.

In addition, for example, in the second sub time interval 3222, the second emitter set may operate to output lasers N times, and the second detector may operate in a detecting window corresponding to each laser emission, may generate a signal based on light detected within each detecting window, and may generate a data set by storing a counting value in a corresponding time bin on the basis of the generated signal. Accordingly, histogram data may be obtained on the basis of N data sets corresponding to the lasers output N times.

In addition, each of the plurality of pieces of point data included in the first frame data 3210 may be obtained on the basis of histogram data for each detector obtained by accumulating a plurality of data sets for each detector with respect to each detector.

For example, the first point data 3211 included in the first frame data 3210 may be obtained on the basis of the first histogram data obtained in the first sub time interval 3221, and the second point data 3212 may be obtained on the basis of the second histogram data obtained in the second sub time interval 3222. However, no limitation thereto is imposed.

### 4.3. Problems of LiDAR Data Generation Method Using Histogram Data

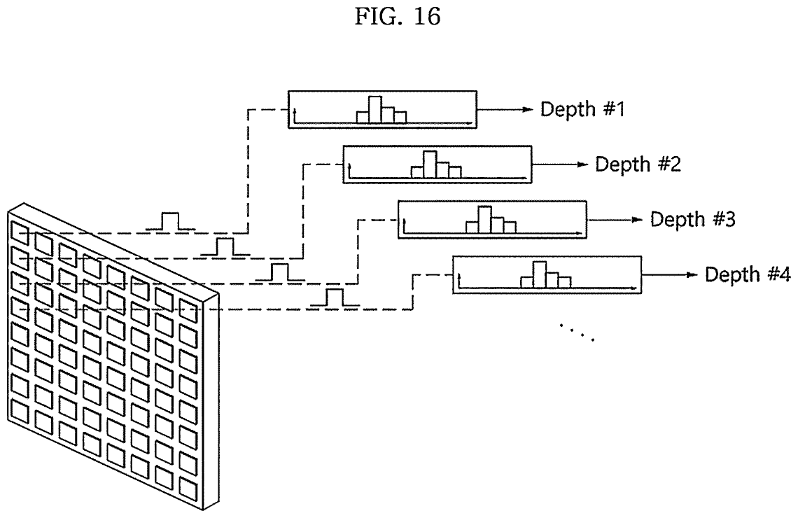

FIG. 16 is a diagram illustrating a signal processing method of a LiDAR device including a detector array according to an embodiment.

Referring to FIG. 16, the LiDAR device including the detector array may generate histogram data individually for each of the detectors included in the detector array. In addition, the LiDAR device may obtain respective pieces of depth information on the basis of the respective pieces of histogram data generated individually.

A data processing method in which LiDAR data is generated using histogram data may cause various problems because spatially related data is not used and each of the detectors processes data individually.

For example, the accuracy of depth information that the LiDAR device obtains may be reduced. Specifically, since all the detectors process signals individually, each of the detectors may calculate different pieces of depth information for points located at the same distance.

In addition, as another example, a method of processing LiDAR data individually by using histogram data may be susceptible to noise. Specifically, the method relies on data obtained from one detector, so it may be difficult to distinguish an actual detection signal from a noise signal, such as sunlight and interfering light.

### 5. Proposal of Present Disclosure

To solve the above problems, the present specification proposes a new form of data structure that may consider signals together which are obtained from spatially adjacent detectors.

Specifically, the present specification proposes a new form of data processing algorithm that introduces a data structure having a spatial domain corresponding to a detector array and considers detection signals of adjacent detectors together in a LiDAR device including a detector array.

### 6. Configuration of LiDAR Device Proposed in Present Disclosure

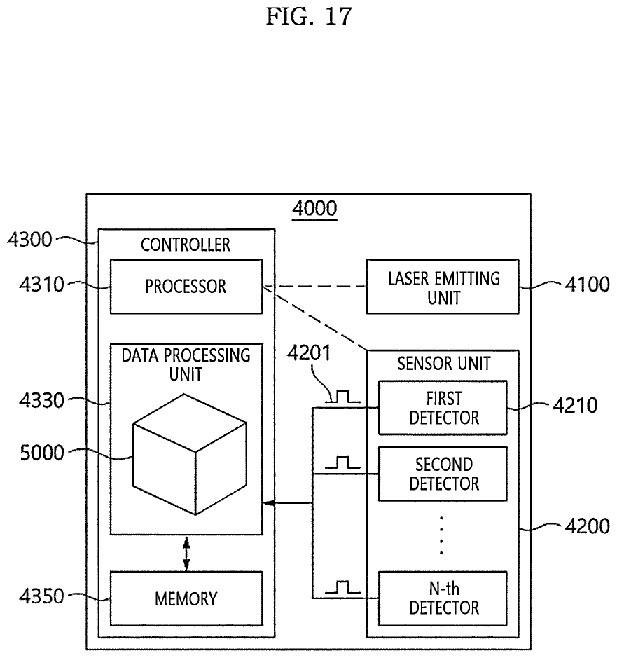

FIG. 17 is a diagram illustrating the configuration of a LiDAR device according to an embodiment.

Referring to FIG. 17, a LiDAR device 4000 according to an embodiment may include a laser emitting unit 4100, a sensor unit 4200, and a controller 4300.

Herein, the details described above may be applied to the laser emitting unit, so a redundant description will be omitted.

In addition, the sensor unit 4200 may include a detector array. More specifically, the sensor unit 4200 may include a plurality of detectors 4210 arranged in the form of an array. For example, the sensor unit 4200 may include a first detector, a second detector, . . . , and an n-th detector, but is not limited thereto.

In addition, the details described above may be applied to the detecting unit, so a redundant description will be omitted.

In addition, the controller 4300 may include a processor 4310. Herein, the processor may control the laser emitting unit 4100 and the sensor unit 4200. The details (section 1.4.) of the controller described above may be applied to the processor 4310, so a redundant description will be omitted.

In addition, the controller 4300 may include a data processing unit 4330. Herein, the data processing unit 4330 may generate data on the basis of a detection signal obtained from the sensor unit 4200, or may process the generated data. More specifically, the data processing unit 4330 may be connected to each of the detectors included in the detector array, and may receive a detection signal 4201 from each of the detectors.

In addition, the data processing unit 4330 may process the detection signals 4201 received from the detectors, on the basis of a preset algorithm.

In addition, the data processing unit 4330 may process the detection signals 4201 to generate a data set having a predefined form. Specifically, the data processing unit 4330 may generate a spatio-temporal data set 5000 that reflects a detection time point of a laser reflecting off an object and the location of the detector that has detected the laser. In other words, the data processing unit 4330 may receive the detection signals 4201 and output or store the spatio-temporal data set 5000.

The detailed definition of the spatio-temporal data set 5000 will be described in detail below.

In addition, the controller 4300 may store the detection signals 4201 in at least one memory 4350.

Specifically, the data processing unit 4330 may store the detection signals 4201 and data generated from the detection signals 4201 in the at least one memory 4350.

For example, the at least one memory 4350 may include a plurality of memory regions for respectively storing the detection signals 4201 generated by the respective detectors included in the detector array.

In addition, for example, the at least one memory 4350 may include a plurality of memory regions for storing counting values generated by the data processing unit 4330.

Herein, the memory in which the detection signals 4201 are stored and the memory in which the counting values are stored may be separate memories, but are not limited thereto. Specifically, the data processing unit 4330 may store the detection signals 4201 in a first memory, may read the detection signals 4201 from the first memory to generate the counting values, and then may store the counting values in a second memory.

In addition, the data processing unit 4330 may fetch the detection signals 4201 from the at least one memory 4350.

In addition, the data processing unit 4330 may process the fetched detection signals 4201 on the basis of a data processing algorithm.

For example, the data processing unit 4330 may generate an accumulated data set on the basis of the detection signals 4201 fetched from the at least one memory 4350.

In addition, the data processing unit 4330 may store the generated accumulated data set in the at least one memory 4350. Herein, the region in the at least one memory 4350 in which the accumulated data set is stored may be different from the regions in the at least one memory 4350 in which the detection signals 4201 are stored.

In addition, for example, the data processing unit 4330 may generate the spatio-temporal data set 5000 on the basis of the detection signals 4201 fetched from the at least one memory 4350.

In addition, in this case, the data processing unit 4330 may store the generated spatio-temporal data set 5000 in the at least one memory 4350. Herein, the region in the at least one memory 4350 in which the spatio-temporal data set 5000 is stored may be different from the regions in the at least one memory 4350 in which the detection signals 4201 are stored.

In addition, the data processing unit 4330 may fetch the accumulated data set from the at least one memory 4350.

In addition, the data processing unit 4330 may process the fetched accumulated data set on the basis of a data processing algorithm. For example, the data processing unit 4330 may generate the spatio-temporal data set 5000 on the basis of the accumulated data set fetched from the at least one memory 4350.

In addition, in this case, the data processing unit 4330 may store the generated spatio-temporal data set 5000 in the at least one memory 4350. Herein, the region in the at least one memory 4350 in which the spatio-temporal data set 5000 is stored may be different from the regions in the at least one memory 4350 in which the detection signals 4201 and the accumulated data set are stored.

In addition, the data processing unit 4330 may fetch the spatio-temporal data set 5000 from the at least one memory 4350.

In addition, the data processing unit 4330 may process the fetched spatio-temporal data set 5000 on the basis of a data processing algorithm. For example, the data processing unit 4330 may generate an enhanced spatio-temporal data set on the basis of the spatio-temporal data set 5000 fetched from the at least one memory 4350.

In addition, in this case, the data processing unit 4330 may store the generated enhanced spatio-temporal data set in the at least one memory 4350. Herein, the region in the at least one memory 4350 in which the enhanced spatio-temporal data set is stored may be different from the regions in the at least one memory 4350 in which the detection signals 4201 and the spatio-temporal data set 5000 are stored.

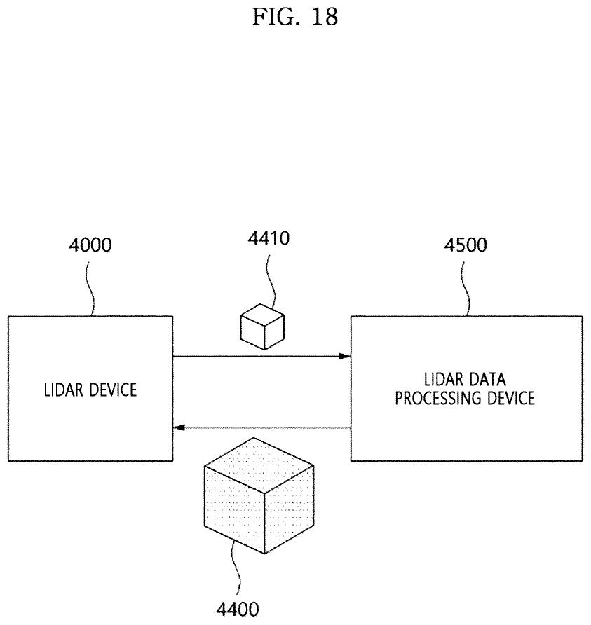

FIG. 18 is a diagram illustrating a LiDAR data processing device according to an embodiment.

Referring to FIG. 18, a LiDAR device 4000 may generate LiDAR data on the basis of detection signals generated by a detector array. Specifically, the controller of the LiDAR device 4000 may process the detection signals to generate LiDAR data. For example, the processor of the LIDAR device 4000 may generate an accumulated data set, a spatio-temporal data set, or an enhanced spatio-temporal data set on the basis of the detection signals, but is not limited thereto.

Herein, the LiDAR data may be generated from the processor placed inside the LiDAR device 4000. However, without being limited thereto, the LiDAR data may be generated by a LiDAR data processing device 4500 connected to the LiDAR device 4000.

In this case, the LiDAR data processing device 4500 may refer to, as a processor included in the controller of the LiDAR device 4000, an external processor placed outside the LiDAR device 4000, but is not limited thereto. Specifically, the LiDAR data processing device 4500 may be a device for generating LiDAR data by receiving data from the processor included inside the LiDAR device 4000. For example, the LiDAR data processing device 4500 may be a relay for connecting the controller of the LiDAR device and a main controller of a vehicle at which the LiDAR device is placed, but is not limited thereto.

Herein, the LiDAR data processing device 4500 may transmit and receive data to and from the LiDAR device 4000 through wired or wireless communication.

A LIDAR data processing device 4500 according to an embodiment may be a device for obtaining detection signals from the detectors included in the LiDAR device 4000, and processing the detection signals.

For example, a LiDAR data processing device 4500 according to an embodiment may obtain detection signals from the detectors included in the LiDAR device 4000 and may generate histogram data on the basis of the obtained detection signals, but is not limited thereto. In addition, the LiDAR data processing device may store the generated histogram data and may transmit the histogram data to the LiDAR device. As a specific example, referring to FIG. 18, the LiDAR device may transmit a first data set 4410 including detection signals to the LiDAR data processing device, and the LiDAR data processing device may transmit a second data set 4400 to the LiDAR device, wherein the second data set includes histogram data generated on the basis of the detection signals. However, no limitation thereto is imposed.

In addition, as another example, a LiDAR data processing device 4500 according to an embodiment may obtain detection signals from the detectors included in the LiDAR device 4000 and may generate a spatio-temporal data set on the basis of the obtained detection signals, but is not limited thereto. In addition, the LiDAR data processing device 4500 may store the generated spatio-temporal data set, and may transmit the spatio-temporal data set to the LiDAR device 4000. As a specific example, referring to FIG. 18, the LiDAR device 4000 may transmit a first data set 4410 including detection signals to the LiDAR data processing device 4500, and the LiDAR data processing device 4500 may transmit a second data set 4400 to the LiDAR device 4000, wherein the second data set includes a spatio-temporal data set generated on the basis of the detection signals. However, no limitation thereto is imposed.

In addition, as another example, a LiDAR data processing device 4500 according to an embodiment may obtains detection signals from the detectors included in the LiDAR device 4000 and may generate depth information on the basis of the obtained detection signals, but is not limited thereto. Specifically, the LiDAR data processing device 4500 may generate histogram data on the basis of the detection signals and generate depth information on the basis of the histogram data; or may generate a spatio-temporal data set on the basis of the detection signals and generate depth information on the basis of the spatio-temporal data set; or may generate histogram data on the basis of the detection signals, generate a spatio-temporal data set on the basis of the histogram data, and generate depth information on the basis of the spatio-temporal data set, but is not limited thereto. In addition, the LiDAR data processing device 4500 may store the generated depth information, and may transmit the depth information to the LiDAR device 4000. As a specific example, referring to FIG. 18, the LiDAR device 4000 may transmit a first data set 4410 including detection signals to the LiDAR data processing device 4500, and the LiDAR data processing device 4500 may transmit a second data set 4400 to the LiDAR device 4000, wherein the second data set includes depth information generated on the basis of the detection signals. However, no limitation thereto is imposed.

In addition, a LiDAR data processing device 4500 according to an embodiment may be a device for obtaining histogram data from the LiDAR device 4000, and processing the histogram data.

For example, a LiDAR data processing device 4500 according to an embodiment may obtain histogram data from the processor included in the LiDAR device 4000, and may generate a spatio-temporal data set on the basis of the obtained histogram data, but is not limited thereto. In addition, the LiDAR data processing device 4500 may store the generated spatio-temporal data set, and may transmit the spatio-temporal data set to the LiDAR device 4000. As a specific example, referring to FIG. 18, the LiDAR device 4000 may transmit a first data set 4410 including histogram data to the LiDAR data processing device 4500, and the LiDAR data processing device 4500 may transmit a second data set 4400 to the LiDAR device 4000, wherein the second data set includes a spatio-temporal data set generated on the basis of the histogram data. However, no limitation thereto is imposed.

In addition, as another example, a LiDAR data processing device 4500 according to an embodiment may obtain histogram data from the processor included in the LiDAR device, and may generate depth information on the basis of the obtained histogram data, but is not limited thereto. Specifically, the LiDAR data processing device 4500 may generate depth information on the basis of the histogram data; or may generate a spatio-temporal data set on the basis of the histogram data and generate depth information on the basis of the spatio-temporal data set, but is not limited thereto. In addition, the LiDAR data processing device 4500 may store the generated depth information, and may transmit the depth information to the LiDAR device 4000. As a specific example, referring to FIG. 18, the LiDAR device may transmit a first data set 4410 including histogram data to the LiDAR data processing device, and the LiDAR data processing device may transmit a second data set 4400 to the LiDAR device, wherein the second data set includes depth information generated on the basis of the histogram data. However, no limitation thereto is imposed.

In addition, a LiDAR data processing device 4500 according to an embodiment may be a device for obtaining a spatio-temporal data set from the LiDAR device, and processing the spatio-temporal data set.

For example, a LiDAR data processing device 4500 according to an embodiment may obtain a spatio-temporal data set from the processor included in the LiDAR device, and may generate an enhanced spatio-temporal data set on the basis of the obtained spatio-temporal data set, but is not limited thereto. Specifically, the LiDAR data processing device 4500 may process a spatio-temporal data set received from the LiDAR device, on the basis of a pre-stored data processing algorithm and may generate an enhanced spatio-temporal data set. Herein, the definition of the enhanced spatio-temporal data set will be described in detail below.

In addition, the LiDAR data processing device 4500 may store the enhanced spatio-temporal data set, and may transmit the enhanced spatio-temporal data set to the LiDAR device 4000. As a specific example, referring to FIG. 18, the LiDAR device 4000 may transmit a first data set 4410 including a spatio-temporal data set to the LiDAR data processing device 4500, and the LiDAR data processing device 4500 may transmit a second data set 4400 to the LiDAR device, wherein the second data set includes an enhanced spatio-temporal data set generated on the basis of the spatio-temporal data set. However, no limitation thereto is imposed.

In addition, as another example, a LiDAR data processing device 4500 according to an embodiment may obtain a spatio-temporal data set from the processor included in the LiDAR device, and may generate depth information on the basis of the obtained spatio-temporal data set, but is not limited thereto. Specifically, the LiDAR data processing device 4500 may generate depth information on the basis of the spatio-temporal data set; or may generate an enhanced spatio-temporal data set on the basis of the spatio-temporal data set and generate depth information on the basis of the enhanced spatio-temporal data set, but is not limited thereto. In addition, the LiDAR data processing device 4500 may store the generated depth information, and may transmit the depth information to the LiDAR device 4000. As a specific example, referring to FIG. 18, the LiDAR device may transmit a first data set 4410 including a spatio-temporal data set to the LiDAR data processing device, and the LiDAR data processing device may transmit a second data set 4400 to the LiDAR device, wherein the second data set includes depth information generated on the basis of the spatio-temporal data set. However, no limitation thereto is imposed.

In addition, the data processing operation described above may be performed by a main controller located in a vehicle. Specifically, the main controller of the vehicle may generate an accumulated data set on the basis of detection signals received from the LiDAR device, may generate the spatio-temporal data set, or may generate the enhanced spatio-temporal data set, but is not limited thereto.

### 7. Spatio-Temporal Data Set

### 7.1. Definition of Spatio-Temporal Data Set

A processor of a LiDAR device or a LiDAR data processing device according to an embodiment may generate a spatio-temporal data set having a 3D data form. Herein, the 3D data form may refer to a data form having a temporally extended dimension with respect to a 2D spatial dimension. Specifically, the LiDAR device or the LiDAR data processing device may generate a 3D spatio-temporal data set that represents a temporal dimension as well as a spatial dimension of data. In addition, without being limited thereto, the spatio-temporal data set may be referred to as a spatio-temporal volume data set, a photon counting matrix (PCM).

Specifically, in a LiDAR device including a detector array, a spatio-temporal data set may refer to data in which a plurality of counting values are arranged, which are generated on the basis of detection signals detected by at least some of the detector array during a predetermined period of time.

For example, in the LiDAR device including the detector array, the LiDAR device may generate temporally and spatially identified counting values on the basis of detection signals detected by the respective detectors included in the detector array during the time required to obtain 1 frame data, and the spatio-temporal data set may refer to a data set in which the counting values generated in the above-described manner are sorted.

In addition, in a LiDAR device including a detector array, a spatio-temporal data set may refer to a unit of data for processing, as one group, detection signals detected by at least some of the detector array during a predetermined period of time.

For example, in the LiDAR device including the detector array, the spatio-temporal data set may refer to unit of data for processing, as one group, detection signals detected by the respective detectors included in the detector array during the time required to obtain 1 frame data, but is not limited thereto.

In addition, in a LiDAR device including a detector array, a spatio-temporal data set may refer to a data set in which the signals detected in physically different times are aligned and matched to relative time intervals in order to process signals detected by at least some of the detector array during a predetermined period of time as one group.

For example, in the LiDAR device including the detector array, the spatio-temporal data set may refer to a data set in which the signals detected by the respective detectors are aligned and matched to relative time intervals (e.g., time bins) for detecting windows for the respective detectors, but is not limited thereto.

In addition, a spatio-temporal data set may refer to a data set that is arranged by reflecting location relationships between respective detectors included in a detector array, but is not limited thereto.

For example, in a LiDAR device including a detector array, the spatio-temporal data set may refer to a data set that is arranged to reflect the locations of the detectors of the detector array that have detected lasers and to correspond to the locations of the detectors that have detected the lasers, but is not limited thereto.

In addition, a spatio-temporal data set may refer to a data set that addresses each counting value with a location value corresponding to a detector and a time value corresponding to a relative time interval for a detecting window, but is not limited thereto.

For example, in a LiDAR device including a detector array, the spatio-temporal data set may refer to a data set generated by addressing a counting value based on a detection signal obtained from each detector included in the detector array, to a location value corresponding to a location of a detector that has detected a laser and a time value (e.g., a time bin) corresponding to a time point of detection of the laser, but is not limited thereto.

In addition, in a LiDAR device including a detector array, a spatio-temporal data set may refer to a data set generated by accumulating counting values based on detection signals obtained from a plurality of detectors, in the spaces corresponding to the locations of the respective detectors and in the times corresponding to the detected time points.

In addition, a spatio-temporal data set may be generated by arranging histogram data for each detector in a LiDAR device including a detector array. In this case, the LiDAR device may generate the spatio-temporal data set by arranging histogram data obtained from all the detectors included in the detector array, conceptually into one data space.

However, this is only for convenience of description in terms of results, and in practice, a method of generating histogram data or a method of processing histogram data is very different from a method of generating and processing a spatio-temporal data set.

The method of generating a spatio-temporal data set will be described in more detail later.

### 7.1.1. Structure of Spatio-Temporal Data Set

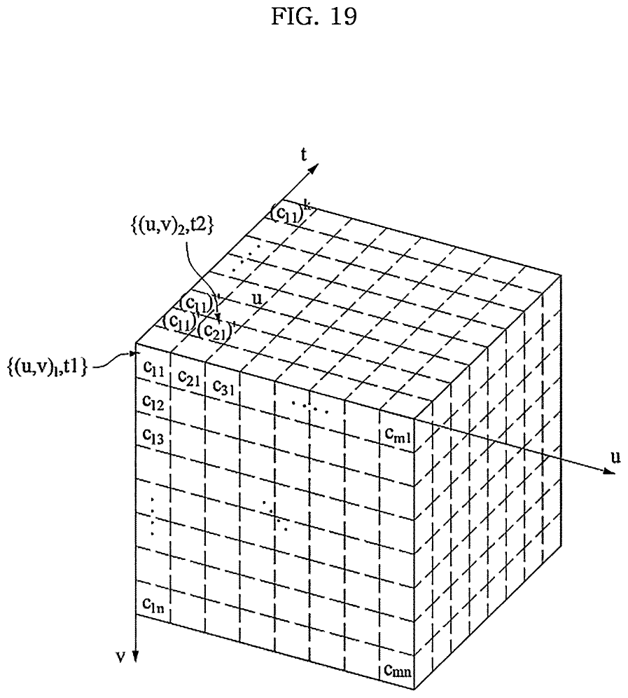

FIG. 19 is a diagram illustrating a structure of a spatio-temporal data set according to an embodiment.

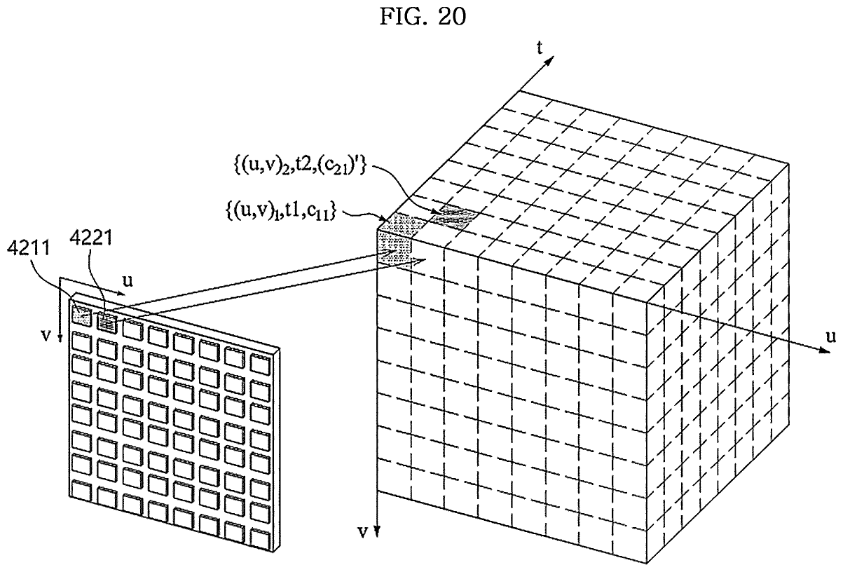

FIG. 20 is a diagram illustrating a structure of a spatio-temporal data set in connection with a detector array according to an embodiment.

A spatio-temporal data set according to an embodiment may be an assembly of a plurality of counting values identified by different location values and time values. Specifically, each of the counting values included in the spatio-temporal data set may have a spatio-temporal location on the spatio-temporal data set determined on the basis of a corresponding location value and time value, and may be allocated to the spatio-temporal data set on the basis of the spatio-temporal location.

Referring to FIGS. 19 and 20, the spatio-temporal data set may be a data set in which a plurality of counting values (c) are allocated to volume data. FIG. 19 shows that a counting value is allocated in a unit space in the form of a cube in a 3D volume space consists of the u axis and the v axis, which are spatial axes, and the t axis, which is a temporal axis. However, this is for case of description and understanding, and the data structure of the spatio-temporal data set is not limited to that shown in FIG. 19.

The plurality of counting values included in the spatio-temporal data set may respectively refer to values spatio-temporally different depending on corresponding location values and time values.

For example, a first counting value (c1) identified by a first location value (u,v) and a first time value (t1) may refer to an accumulated value for signals detected at a relative time corresponding to the first time bin (t1) in each of the plurality of detecting windows of the first detector 4211, among signals detected by a first detector 4211 corresponding to the first location value (u,v).

In addition, a second counting value (c2) identified by a second location value (u,v) and a second time value (t2) may refer to an accumulated value for signals detected at a relative time corresponding to the second time bin (t2) in each of the plurality of detecting windows of the second detector 4221. However, no limitation thereto is imposed, among signals detected by a second detector 4221 corresponding to the second location value (u,v).

### 7.1.2. Generation of Spatio-Temporal Data Set

A LIDAR device or a LiDAR data processing device may generate a spatio-temporal data set by receiving a detection signal from at least one detector included in a detector array. For example, the data processing unit included in the LiDAR device or the LiDAR data processing device may generate a spatio-temporal data set, which is an assembly of a plurality of counting values arranged on the basis of the above-described data structure, on the basis of a preset data processing algorithm.

In addition, the data processing unit may generate counting values by processing the detection signals. Specifically, each time a detection signal is received, the data processing unit may generate a counting value on the basis of the detection signal. Herein, the counting value may be a digitalized number for representing the presence or absence of a signal by reflecting a sampling result. In addition, the data processing unit may generate a plurality of counting values identified by location values and time values.

Hereinafter, a method of generating, by the data processing unit through sampling of a detection signal, a counting value identified by a location value and a time value will be described. Based on this, various embodiments of generating a spatio-temporal data set including counting values will be described.

### 7.1.2.1. Method of Sampling Detection Signal

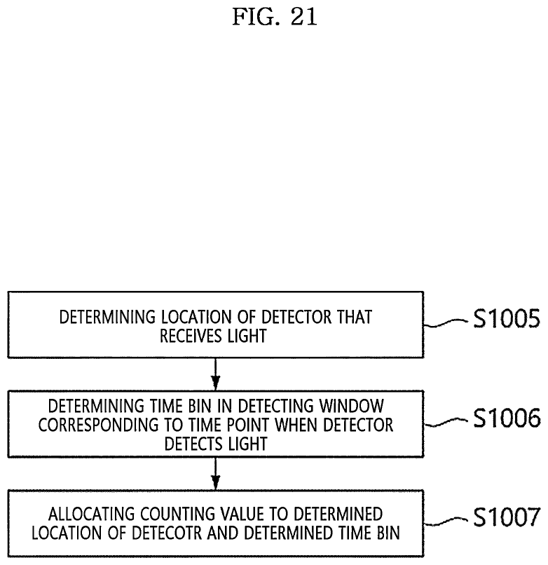

FIG. 21 is a flowchart illustrating a method of generating a counting value included in a spatio-temporal data set according to an embodiment.

Referring to FIG. 21, a LiDAR device according to an embodiment may determine the location of a detector that has received light in step S1005. This is to determine a location value at which the counting value is to be generated in the spatio-temporal data set. The location value may be determined depending on the location of the detector that has generated a detection signal in response to received light.

In addition, the LiDAR device may determine a time bin in the detecting window corresponding to the time point when the detector detects light in step S1006. This is to determine a time value at which the counting value is to be generated in the spatio-temporal data set. The time value may be determined by selecting the time bin corresponding to the time point when a light is detected in the detecting window opened from the laser emission time point.

In addition, the LiDAR device may generate the counting value corresponding to the determined location and time bin of the detector in step S1010. Specifically, the LiDAR device may generate the counting value in association with the determined location value of the detector and the time value in the detecting window of the detector.

Hereinafter, a method of determining location values and time values for identifying a plurality of counting values in a spatio-temporal data set will be described in detail.

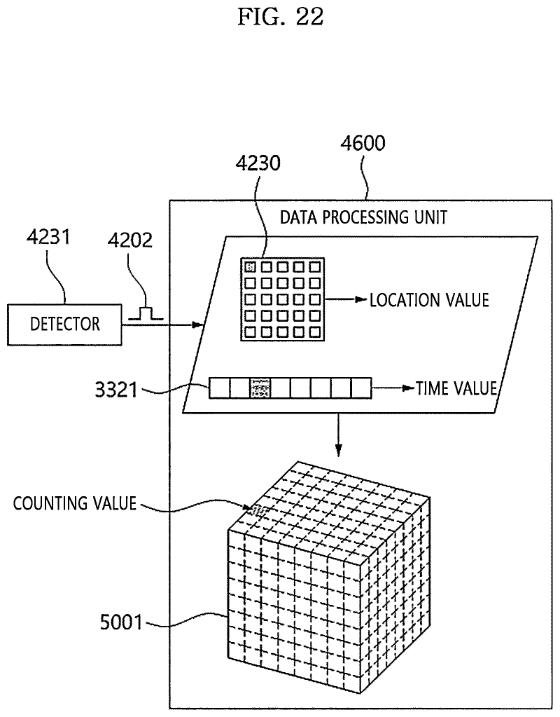

FIG. 22 is a diagram illustrating a detection signal sampling method of a data processing unit according to an embodiment.

Referring to FIG. 22, a data processing unit included in a controller of a LiDAR device or a processor (hereinafter, referred to as a “data processing unit” for convenience of description) included in a LiDAR data processing device may receive a detection signal 4202 from at least one detector 4231 and may generate a spatio-temporal data set 5001.

In addition, the data processing unit 4600 determines a location value and a time value corresponding to a counting value included in the spatio-temporal data set 5001 to address the counting value to a particular location value and a particular time value, and accumulate or update counting values addressed to the same location value and the same time value, thereby generating the spatio-temporal data set.

Herein, the location value may be a value that reflects the location of the detector that has transmitted the detection signal. Specifically, the data processing unit 4600 may determine the location value on the basis of the location of the detector generating the detection signal 4202. For example, the location value may include the location coordinates (u,v) of the detector 4231 generating the detection signal 4202, but is not limited thereto.

In addition, different location values may be allocated to detectors included in a detector array. Specifically, when the detector 4231 generates and transmits the detection signal 4202, the data processing unit 4600 may determine the location value allocated to the detector 4231 as the location value of the counting value. In other words, a corresponding location value may be preset for each detector included in the detector array.

In addition, the data processing unit 4600 may determine the location value on the basis of the location of the detector generating the detection signal 4202 in the detector array. Specifically, the data processing unit 4600 may receive the detection signal 4202 from at least one detector, and may determine relative location coordinates of the at least one detector in the detector array as the location value. For example, when at least one detector transmitting the detection signal 4202 is placed at the location (1,1) in the detector array, the data processing unit 4600 may determine (1,1) as the location value. However, no limitation thereto is imposed.

In addition, the time value may be a value reflecting the time point when photons are detected. Specifically, the time value may include the time bin to which the counting value is allocated in the detecting window of the detector as a result of sampling the detection signal.

In addition, the data processing unit 4600 may determine the time value on the basis of the time corresponding to the time point when a laser is detected in the detecting window of at least one detector that has generated the detection signal. Specifically, the data processing unit 4600 may receive the detection signal 4202 from at least one detector, and may determine, as the time value, the time bin value matching the detection time point of a laser in the detecting window of the at least one detector. For example, when at least one detector detects a laser at a first time point and generates the detection signal 4202, the data processing unit 4600 may determine, as the time value, the first time bin corresponding to the first time point in the detecting window of the at least one detector. However, no limitation thereto is imposed.

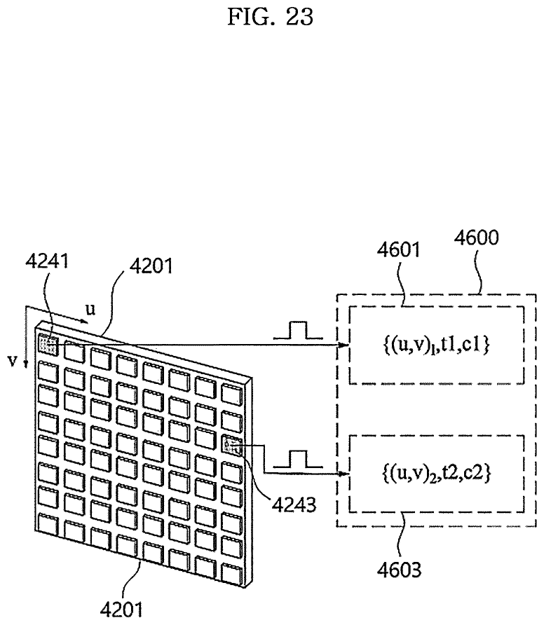

FIG. 23 is a diagram illustrating a counting value identified by a location value and a time value according to an embodiment.

Referring to FIG. 23, a data processing unit 4600 may receive detection signals from respective detectors included in a detector array 4201, and may generate a plurality of counting values identified by location values and time values, on the basis of the detection signals. In addition, in this case, the data processing unit 4600 may store the plurality of counting values as one spatio-temporal data set.

For example, the detector array 4201 may include a first detector 4241 and a second detector 4243. The first detector 4241 and the second detector 4243 may transmit detection signals to the data processing unit 4600, respectively. The data processing unit 4600 may generate counting values corresponding to the first detector 4241 and the second detector 4243, respectively. However, no limitation thereto is imposed.

In this case, the data processing unit 4600 may include a plurality of sub data processing units individually addressed to the respective detectors included in the detector array 4201. For example, the data processing unit 4600 may include a first sub data processing unit 4601 for receiving a detection signal from the first detector 4241, and a second sub data processing unit 4603 for receiving a detection signal from the second detector 4243. In addition, herein, the first sub data processing unit 4601 may generate a counting value corresponding to the first detector 4241, and the second sub data processing unit 4603 may generate a counting value corresponding to the second detector 4243. Without limitation thereto, all the detectors included in the detector array 4201 may be connected to one data processing unit, and the one data processing unit may collectively generate counting values corresponding to the detectors.

For example, the first sub data processing unit 4361 may receive a detection signal from the first detector 4241 to generate a first counting value (c1). Herein, the first counting value (c1) may be addressed by a first location value ((u,v)1) and a first time value (t1). As a specific example, in the detector array 4201, when the first detector 4241 placed at the location (1,1) detects a light at a time point corresponding to a first time bin of a detecting window, the first location value ((u,v)1) may be (1,1) and the first time value (t1) may be a first time bin. However, no limitation thereto is imposed.

In addition, for example, the second sub data processing unit 4363 may receive a detection signal from the second detector 4243 to generate a second counting value (c2). Herein, the second counting value (c2) may be addressed by a second location value ((u,v)2) and a second time value (t2). As a specific example, in the detector array 4201, when the second detector 4243 placed at the location (8,3) detects a light at a time point corresponding to a second time bin in a detecting window, the second location value ((u,v)2) may be (8,3) and the second time value (t2) may be a second time bin. However, no limitation thereto is imposed.

In addition, the above description is based on a method of generating one counting value for one detector, but the data processing unit may generate the counting values for each group according to an embodiment. Specifically, the data processing unit may generate a counting value set on the basis of detection signals received from a detector group including a plurality of detectors, but is not limited thereto. Herein, the detector group may include a plurality of detectors that operate simultaneously, but is not limited thereto.

In addition, the data processing unit 4600 may update the counting values. Specifically, the data processing unit 4600 may generate a counting value by sampling a detection signal, and may update the counting value by sampling the detection signal. For example, the data processing unit 4600 may generate a counting value to which a particular location value and time value are allocated. As a result of sampling a detection signal, when a counting value is allocated to the particular location value and time value, the already generated counting value may be updated. However, no limitation thereto is imposed.

In addition, the data processing unit 4600 may sample a detection signal during a plurality of detecting windows at a predetermined sampling rate. Herein, the sampling rate may be related to the frequency of opened detecting windows to sample the detection signal. Specifically, the data processing unit 4600 may have a preset frequency of opened detecting windows to sample the detection signal, and may update the counting values obtained during the sampling process, thereby generating the spatio-temporal data set.

In addition, the data processing unit 4600 may arrange and store the generated counting values. Specifically, the data processing unit 4600 may generate the spatio-temporal data set by arranging the generated counting values in a predetermined manner.

For example, the data processing unit 4600 may arrange and store one or more counting values generated during different time intervals. Specifically, the data processing unit 4600 may store a first counting value set generated during a first time interval. Making arrangement with the first counting value set, the data processing unit may store a second counting value set generated during a second time interval different from the first time interval. However, there is no limitation imposed.

In addition, for example, the data processing unit 4600 may arrange and store one or more counting values generated during different detecting windows. Specifically, the data processing unit 4600 may store a first counting value set generated during a first detecting window. Making arrangement with the first counting value set, the data processing unit may store a second counting value set generated during a second time interval different from the first time interval. However, there is no limitation imposed.

In addition, for example, a counting value set corresponding to a detector group operating simultaneously may be arranged and stored. Specifically, the data processing unit 4600 may generate a first counting value set on the basis of detection signals received from a first detector group. In addition, the data processing unit may generate a second counting value set on the basis of detection signals received from a second detector group adjacent to the first detector group. Herein, making arrangement with the first counting value set, the data processing unit may store the second counting value set.

In addition, for example, the data processing unit 4600 may store the generated counting values in at least one memory. Specifically, the data processing unit 4600 may store a first counting value set generated during a first time interval in a first section of a memory, and may store a second counting value set generated during a second time interval different from the first time interval in a second section different from the first section of the memory, but is not limited thereto.

In addition, for example, the data processing unit 4600 may generate counting values in different ways depending on a time interval during which the detector array operates. Specifically, depending on a time interval during which the detector array operates, previously generated counting values may be updated or new counting values may be generated and arranged.

As a specific example, the data processing unit 4600 may generate a first counting value set on the basis of detection signals generated in the detector array during a first time interval. In addition, the data processing unit 4600 may update the first counting value set on the basis of detection signals generated by the detector array during a second time interval. Herein, the first time interval and the second time interval may be the time intervals during which the same detector group operates, but is not limited thereto. In addition, the data processing unit 4600 may generate a second counting value set on the basis of detection signals generated in the detector array during a third time interval. In addition, in this case, making arrangement with the first counting value set, the data processing unit may store the second counting value set. In addition, the data processing unit may obtain a depth value corresponding to one detector on the basis of the first counting value set and the second counting value set, but is not limited thereto.

### 7.1.2.2. Method of Generating Spatio-Temporal Data Set According to Operation of Detector Array

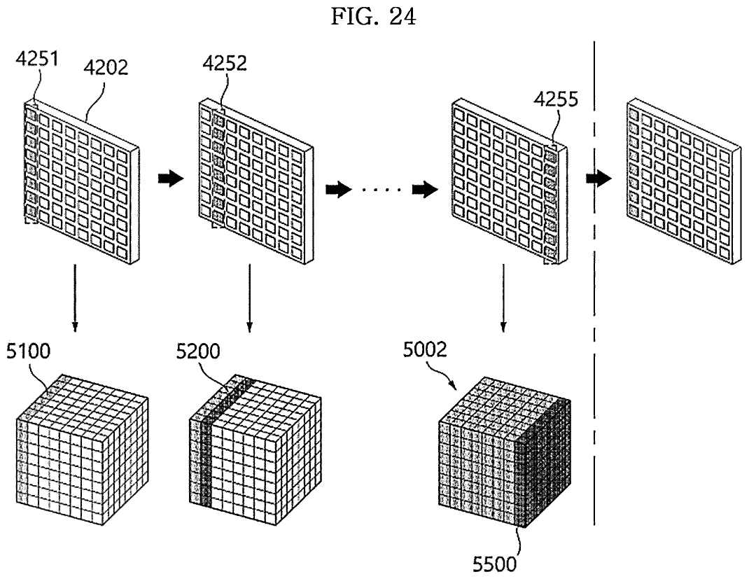

FIG. 24 is a diagram illustrating a method of generating a spatio-temporal data set of one frame according to the operation of a detector array according to an embodiment.

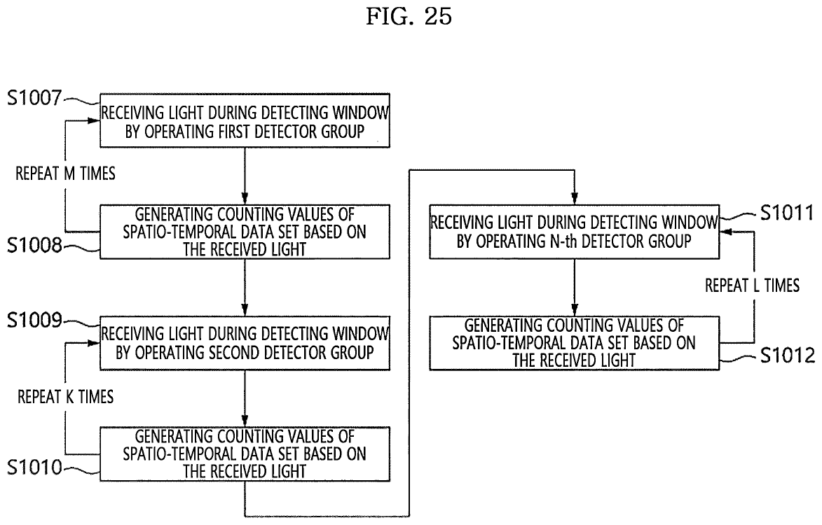

FIG. 25 is a flowchart illustrating the process of performing the method of FIG. 24.

Referring to FIG. 24, a LiDAR device including a detector array 4202 according to an embodiment may operate the detector array on the basis of a predetermined operating mechanism. Specifically, the controller of the LiDAR device may operate the detector array 4202 on a per-group basis. For example, the controller of the LiDAR device may operate the detector array one column by one column, or one row by one row. However, without being limited thereto, the controller may operate the detector array 4202 according to a predetermined order, for example, a plurality of columns by a plurality of columns, or a plurality of rows by a plurality of rows. As a specific example, as shown in FIG. 24, the LiDAR device may operate a first detector group 4251, a second detector group 4252, . . . , and an n-th detector group 4255 sequentially, but is not limited thereto.

In addition, the data processing unit of the LiDAR device or the LiDAR data processing device may generate a spatio-temporal data set 5002 by receiving detection signals from the detectors included in the detector array 4202. In this case, the data processing unit may operate to correspond to the operating mechanism of the detector array. Specifically, the data processing unit may receive a detection signal from an operated detector among the detectors included in the detector array 4202, may generate a counting value on the basis of the detection signal, and may generate a spatio-temporal data set on the basis of the counting value. For example, when an operated detector detects a laser and transmit a detection signal to the data processing unit, the data processing unit may generate, on the basis of the detection signal, a counting value to which a location value and a time value are allocated. However, no limitation thereto is imposed.

As a specific example, the data processing unit may accumulate a first counting value set 5100 when the first detector group 4251 operates, and may accumulate a second counting value set 5200 while the second detector group 4252 operates, and may accumulate an n-th counting value set 5500 while the n-th detector group 4255 operates. However, no limitation thereto is imposed.

In addition, the data processing unit may generate the spatio-temporal data set 5002 of one frame on the basis of the first counting value set 5100 to the n-th counting value set 5500. Specifically, the spatio-temporal data set 5002 of the one frame may be an assembly of counting value sets generated while a predetermined operating mechanism of the detector array is completed.

More specifically, as the operating mechanism of the detector array 4202 completes onc cycle, the spatio-temporal data set 5002 of the one frame may be generated. Specifically, as the generation of counting values is completed for all the detectors at a predetermined sampling rate, the spatio-temporal data set 5002 of the one frame may be generated. Herein, counting values may be generated at the same sampling rate for all the detectors. However, without limitation thereto, the respective detectors may generate counting values at different sampling rates. For example, the data processing unit may identify a counting value with a location value and a time value on the basis of the time and frequency determined on the basis of the sampling rate of the LiDAR device and may accumulate the counting value, thereby generating the spatio-temporal data set 5002 of the one frame. However, no limitation thereto is imposed.

The above-described method of generating the spatio-temporal data set according to the operation of the detector array is listed as follows through the flowchart of FIG. 25.

A LIDAR device according to an embodiment may receive light during detecting window by operating a first detector group 4251 in step S1007.

In addition, the data processing unit of the LiDAR device or the LiDAR data processing device may generate counting values of a spatio-temporal data set on the basis of the received light in step S1008. For example, the LiDAR device may operate the first detector group 4251 to generate a first sub counting value set generated during a detecting window of one cycle. In addition, the LiDAR device may repeat the steps S1007 and S1008 M times. In this case, referring to FIG. 24, the first counting value set 5100 in the spatio-temporal data set corresponding to the first detector group 4251 may be accumulated. In addition, herein, the reason for repeating the steps M times may be to accumulate counting values of significant magnitudes. In other words, the spatio-temporal data set having significant counting values may be generated by accumulating counting values during detecting windows of M cycles. For example, the data processing unit may sample the detection signals transmitted from the first detector group 4251 for M detecting windows and may update the first sub counting value set, thereby generating the first counting value set 5100. However, no limitation thereto is imposed.

In addition, the LiDAR device may receive light during detecting window by operating a second detector group 4252 in step S1009.

In addition, the data processing unit of the LiDAR device or the LiDAR data processing device may generate counting values of a spatio-temporal data set on the basis of the received light in step S1010. For example, the LiDAR device may operate the second detector group 4252 to generate a second sub counting value set generated during a detecting window of one cycle.

In addition, the LiDAR device may repeat the steps S1009 and S1010 K times. In this case, referring to FIG. 24, the second counting value set 5200 in the spatio-temporal data set corresponding to the second detector group 4252 may be accumulated. For example, the data processing unit may sample the detection signals transmitted from the second detector group 4252 for K detecting windows and may update the second sub counting value set, thereby generating the second counting value set 5200. However, no limitation thereto is imposed.

In addition, making arrangement with the first counting value set 5100, the data processing unit may store the second counting value set 5200. Specifically, by reflecting the location relationship between the first detector group 4251 and the second detector group 4252, the data processing unit may arrange and store the first counting value set 5100 and the second counting value set 5200 in association with the location relationship.

In addition, the LiDAR device may receive light during detecting window by operating an N-th detector group 4255 in step S1011.

In addition, the data processing unit of the LiDAR device or the LiDAR data processing device may generate counting values of a spatio-temporal data set on the basis of the received light in step S1012. For example, the LiDAR device may operate the n-th detector group 4255 to generate an n-th sub counting value set generated during a detecting window of one cycle.

In addition, the LiDAR device may repeat the steps S1011 and S1012 L times. In this case, referring to FIG. 24, the n-th counting value set 5500 in the spatio-temporal data set corresponding to the n-th detector group 4255 may be accumulated. For example, the data processing unit may sample the detection signals transmitted from the n-th detector group 4255 for L detecting windows and may update the n-th sub counting value set, thereby generating the n-th counting value set 5500. However, no limitation thereto is imposed.

In addition, the data processing unit may arrange and store the first counting value set 5100 to the n-th counting value set 5500, thereby generating a spatio-temporal data set 5002.

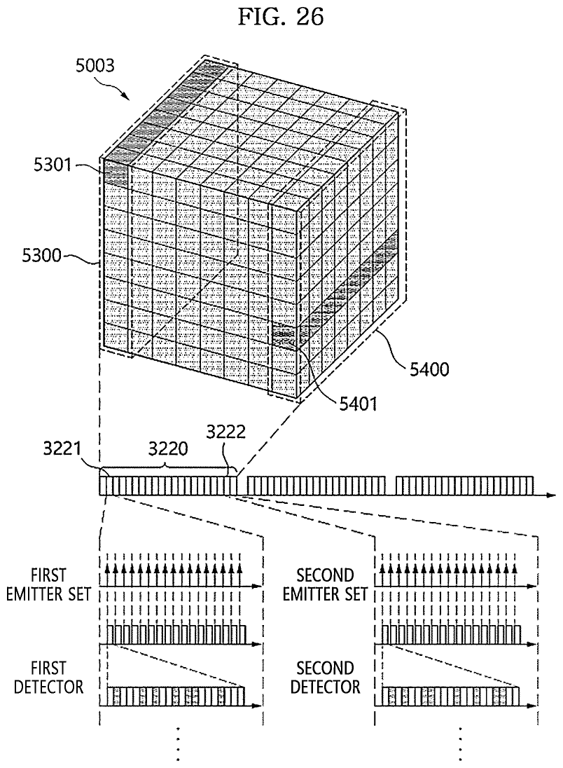

FIG. 26 is a diagram illustrating, in time series, a method of generating a spatio-temporal data set according to an embodiment.

Referring to FIG. 26, a data processing unit of a LiDAR device or a LiDAR data processing device according to an embodiment may obtain a spatio-temporal data set including counting values to which location values and time values are allocated. For example, the data processing unit may obtain a first spatio-temporal data set 5003 of one frame.

In addition, the first spatio-temporal data set 5003 may correspond to a set of counting values obtained during a first time interval 3220, and the location values and the time values may be allocated to the set of counting values to form the spatio-temporal data set. Herein, each of the location values and the time values may be determined on the basis of the location of a detector receiving a light and a time bin corresponding to a detection time point of the light. In addition, the details described above may be applied to the counting values and the time bins, so a redundant description will be omitted.

In addition, each of the counting values included in the first spatio-temporal data set 5003 may be obtained on the basis of a signal output from a detecting unit as a laser emitted from the laser emitting unit included in the LiDAR device reflects off an object and the reflected laser is received by the detecting unit.

Accordingly, the first time interval 3220 for obtaining the first spatio-temporal data set 5003 may include a plurality of sub time intervals for accumulating counting values in a sub spatio-temporal data set corresponding to at least one detector group operating simultaneously.

For example, the first time interval 3220 for obtaining the first spatio-temporal data set 5003 may include a plurality of first sub time intervals 3221 for accumulating counting values in a first sub spatio-temporal data set 5300 corresponding to a first detector group, and a plurality of second sub time intervals 3222 for accumulating counting values in a second sub spatio-temporal data set 5400 corresponding to a second detector group, but is not limited thereto.

In addition, the laser emitting unit and the detecting unit included in the LiDAR device may operate in each of the plurality of sub time intervals.

For example, the laser emitting unit and the detecting unit included in the LiDAR device may operate in the first sub time interval 3221 included in the plurality of sub time intervals, and the laser emitting unit and the detecting unit included in the LiDAR device may operate in the second sub time interval 3222. However, no limitation thereto is imposed.

More specifically, the laser emitting unit may operate to output lasers N times, and the detecting unit may operate in synchronization with the laser emitting unit to detect the lasers output N times from the laser emitting unit. In addition, the detecting unit may generate a detection signal in association with light detected within a detecting window, and may store a counting value in a corresponding time bin on the basis of the generated signal.

For example, in the first sub time interval 3221, a first emitter set included in the laser emitting unit may operate to output lasers, and a first detector group included in the detecting unit may operate to detect the lasers output from the first emitter set. In addition, in this case, the first detector group may generate detection signals in association with the detected light. In addition, accordingly, the controller of the LiDAR device may store counting values in the locations corresponding to locations of the detectors generating the detection signals and the time bins corresponding to the time points of light detection.

In addition, for example, in the first sub time interval 3221, the first emitter set may operate to output lasers N times, and the first detector group may operate in the detecting windows corresponding to respective laser emissions. In addition, the first detector group may generate detection signals in association with light detected within the respective detecting windows. In addition, in this case, the controller may store counting values in corresponding detectors and time bins on the basis of the generated detection signals. By accumulating and storing the counting values over N iterations as described above, the controller may obtain a counting value set for each detector included in the first detector group.

For example, in the second sub time interval 3222, a second emitter set included in the laser emitting unit may operate to output lasers, and a second detector group included in the detecting unit may operate to detect the lasers output from the second emitter set. In addition, in this case, the second detector group may generate detection signals in association with light detected within the detecting windows. In addition, accordingly, the controller of the LiDAR device may store counting values in the locations corresponding to locations of the detectors generating the detection signals and the time bins corresponding to the time points of light detection.

In addition, for example, in the second sub time interval 3222, the second emitter set may operate to output lasers N times, and the second detector group may operate in the detecting windows corresponding to respective laser emissions. In addition, the second detector group may generate detection signals in association with light detected within the respective detecting windows. In addition, in this case, the controller may store counting values in corresponding detectors and time bins on the basis of the generated detection signals. By accumulating and storing the counting values over N iterations as described above, the controller may obtain a counting value set for each detector included in the second detector group.

In addition, the first spatio-temporal data set 5003 may be obtained on the basis of a plurality of counting value sets corresponding to the sub spatio-temporal data sets of the respective detector groups.

For example, a first counting value set 5301 included in the first sub spatio-temporal data set 5300 may be obtained on the basis of counting values accumulated during the first sub time interval 3221 by a first detector included in the first detector group. Specifically, the first counting value set 5301 may refer to an assembly of all counting values allocated to at least one time bin by the first detector during the first sub time interval 3221.

In addition, a second counting value set 5401 included in the second sub spatio-temporal data set 5400 may be obtained on the basis of counting values accumulated during the second sub time interval 3222 by a second detector included in the second detector group. Specifically, the second counting value set 5401 may refer to an assembly of all counting values allocated to at least one time bin by the second detector during the second sub time interval 3222.

### 7.2. Various Examples of Spatio-Temporal Data Sets

The spatio-temporal data set may be defined as various examples in addition to the those described above.

### 7.2.1. Spatio-Temporal Data Set Including Accumulated Data Sets

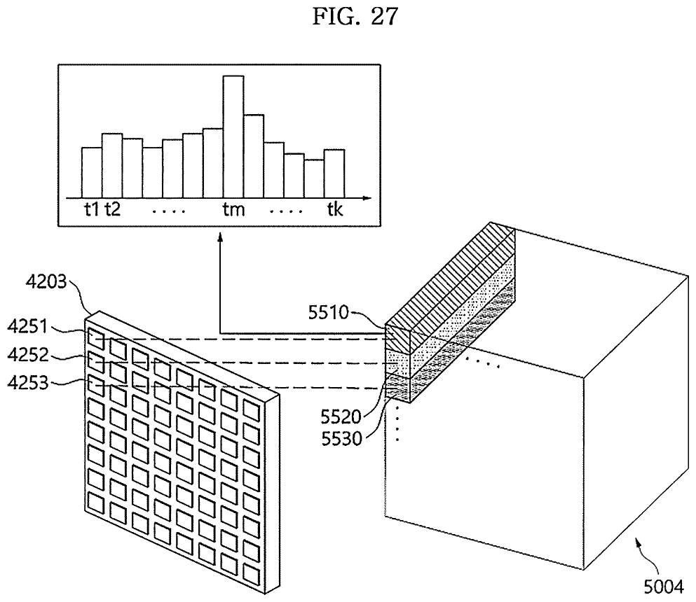

FIG. 27 is a diagram illustrating a spatio-temporal data set defined on the basis of accumulated data sets according to an embodiment.

Referring to FIG. 27, a spatio-temporal data set 5004 according to an embodiment may include a plurality of accumulated data sets. Herein, the accumulated data sets may correspond to detectors included in a detector array, respectively, and may be data sets generated by accumulating counting values during a predetermined time interval. Specifically, in a LiDAR device including a detector array 4203, the spatio-temporal data set 5004 may be a data set in which accumulated data sets corresponding to the respective detectors included in the detector array are arranged.

Specifically, the plurality of accumulated data sets included in the spatio-temporal data set 5004 may correspond to the detectors included in the detector array 4203, respectively. For example, the spatio-temporal data set 5004 may include a first accumulated data set 5510, a second accumulated data set 5520, and a third accumulated data set 5530. In this case, the first accumulated data set 5510 may correspond to a first detector 4251, the second accumulated data set 5520 may correspond to a second detector 4252, and the third accumulated data set 5530 may correspond to a third detector 4253. However, no limitation thereto is imposed. In other words, the spatio-temporal data set 5004 may include as many accumulated data sets as there are detectors included in the detector array. Without limitation thereto, one accumulated data set may correspond to two or more detectors.

In addition, the data processing unit of the LiDAR device or the LiDAR data processing device may generate accumulated data sets on the basis of a predetermined algorithm, and may arrange the accumulated data sets using a predetermined method, thereby generating the spatio-temporal data set 5004.

Herein, as the predetermined algorithm for generating the accumulated data sets, the histogram generation method described in section 4.2.1. may be used as it is. In other words, the accumulated data sets may be histogram data, and the spatio-temporal data set 5004 may be data in which all pieces of histogram data corresponding to the respective detectors are arranged.

In addition, a method of arranging the accumulated data sets may be determined on the basis of the locations of the detectors included in the detector array. More specifically, at least one accumulated data set may be arranged at a location of a detector in the detector array to which the at least one accumulated data set corresponds. For example, the first accumulated data set 5510 may be arranged at the location in the spatio-temporal data set 5004 corresponding to the location of the first detector 4251 in the detector array 4203 to which the first accumulated data set 5510 corresponds, but is not limited thereto.

For example, the difference between the location value allocated to the first accumulated data set 5510 and the location value allocated to the second accumulated data set 5520 may be smaller than the difference between the location value allocated to the third accumulated data set 5530 and the location value allocated to the first accumulated data set 5510.

In addition, the data processing unit may generate the plurality of accumulated data sets during different time intervals, respectively. Specifically, the plurality of accumulated data sets may be individually generated during different time intervals, respectively. In addition, the data processing unit may arrange the plurality of accumulated data sets individually generated during different time intervals, thereby generating one spatio-temporal data set. For example, the data processing unit may generate the first accumulated data set 5510 during a first time interval, and may generate the second accumulated data set 5520 during a second time interval different from the first time interval. Herein, the data processing unit may arrange and store the first accumulated data set 5510 and the second accumulated data set 5520. In other words, in order to simultaneously process the accumulated data sets generated during different time intervals, the data processing unit may collect and store the accumulated data sets.

### 7.2.2. Spatio-Temporal Data Set Including Unit Spaces

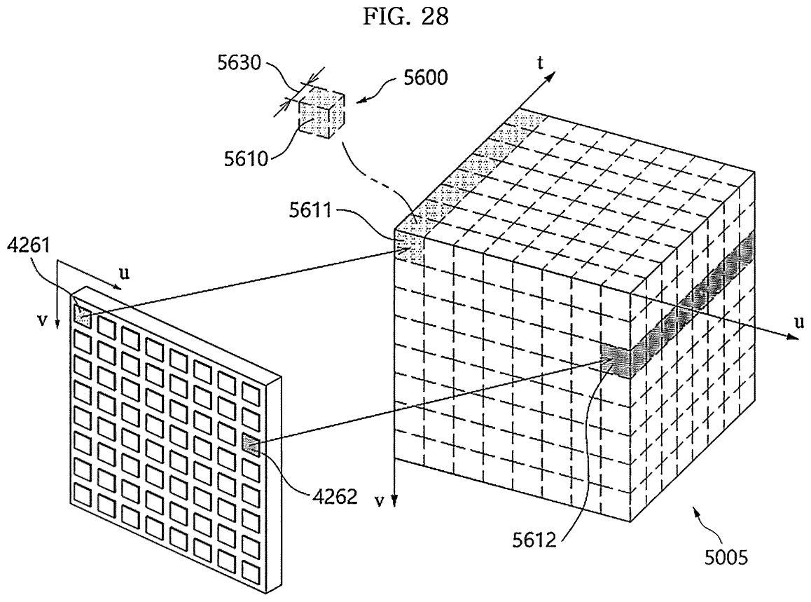

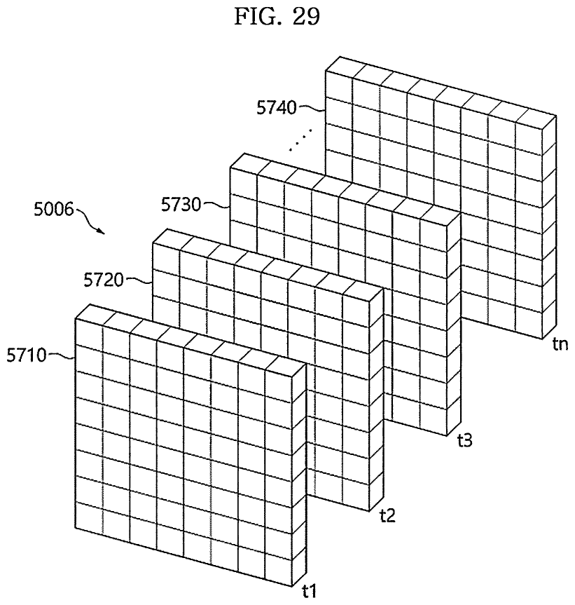

FIG. 28 is a diagram illustrating a spatio-temporal data set defined on the basis of a unit space according to an embodiment.

Referring to FIG. 28, a spatio-temporal data set 5005 according to an embodiment may be a data space defined by a temporal axis and spatial axes. Specifically, the spatio-temporal data set 5005 may include a spatial domain (u,v) defined by the 2D spatial axes, and a time domain (t) defined by the temporal axis.

For example, the spatio-temporal data set 5005 may be an assembly of predetermined unit spaces. Herein, a unit space 5600 may be a space optionally defined for convenience of description of the structure of a spatio-temporal data set in the present specification, and may not a data space that actually has a scale or is standardized. That is, a unit space may be an imaginary space in which a data value is allocated to data having a predetermined structure.

More specifically, the spatio-temporal data set may be an assembly of unit spaces 5600 each defined by a unit region 5610 and a unit time 5630 corresponding thereto. Herein, the unit regions 5610 may constitute the spatial domain of the spatio-temporal data set 5005, and the unit times 5630 may constitute the time domain of the spatio-temporal data set 5005.

In addition, the spatial domain of the spatio-temporal data set 5005 may correspond to the detector array.

Specifically, the spatial domain of the spatio-temporal data set 5005 may be determined on the basis of the location of each of the detectors included in the detector array.

More specifically, according to the location of each of the detectors included in the detector array, corresponding coordinates in the spatial domain of the spatio-temporal data set 5005 may be determined. For example, a first detector 4261 placed at the location (1,1) in the detector array may correspond to the location (1,1) in the spatial domain of the spatio-temporal data set. In addition, for example, a second detector 4262 placed at the location (8,3) in the detector array may correspond to the location (8,3) in the spatial domain of the spatio-temporal data set.

In addition, without limitation thereto, according to the location of each of the detectors included in the detector array, a corresponding unit region in the spatial domain of the spatio-temporal data set may be determined. For example, the first detector 4261 placed at the location (1,1) in the detector array may correspond to a first region 5611 at the location (1,1) in the spatial domain of the spatio-temporal data set 5005. In addition, for example, the second detector placed at the location (8,3) in the detector array may correspond to a second region 5622 at the location (8,3) in the spatial domain of the spatio-temporal data set.

In addition, the time domain of the spatio-temporal data set 5005 may be determined on the basis of a detecting window of the detecting unit. Specifically, the spatio-temporal data set 5005 is a data space for generating data corresponding to lasers detected by the detectors, so the maximum time in the time domain of the spatio-temporal data set may correspond to the size of a detecting window for detecting the lasers. A detecting window has been described above, so a redundant description will be omitted.

In addition, the unit times 5630 constituting the time domain of the spatio-temporal data set 5005 may be determined on the basis of the time bins constituting a detecting window. Specifically, the time domain may be divided into k time bins, and the time bins, as the unit times 5630, may constitute the time domain of the spatio-temporal data set 5005. A time bin has been described above, so a redundant description will be omitted.

In addition, each unit space of the spatio-temporal data set may have a data value. For example, each unit space 5600 of the spatio-temporal data set generated by the LiDAR device including the detector array may have a counting value. A counting value has been described above, so a redundant description will be omitted.

### 7.2.3. Spatio-Temporal Data Set Including Plane Data Sets

FIG. 29 is a diagram illustrating a spatio-temporal data set defined on the basis of plane data sets according to an embodiment.

Referring to FIG. 29, a data processing unit of a LiDAR device or a LiDAR data processing device according to an embodiment may generate a spatio-temporal data set 5006 in which plane data sets corresponding to a detector array are arranged on the basis of the respective time bins constituting a detecting window. In other words, the spatio-temporal data set 5006 may include a plurality of plane data sets.

Herein, each plane data set may be an assembly of counting values corresponding to a particular time bin in the LiDAR device including the detector array. More specifically, the plane data set may be an assembly of counting values that are allocated to a particular time bin and correspond to all the detectors among counting values generated on the basis of photons received from all the detectors included in the detector array.

In addition, each plane data set may be a data set obtained by dividing the spatio-temporal data set 5006 according to a time value. More specifically, the plane data set may be an assembly of counting values having the same time value among a plurality of counting values included in the spatio-temporal data set 5006 generated by the data processing unit. For example, the plane data set may be an assembly of counting values allocated to the same time bin in a detecting window among a plurality of counting values included in the spatio-temporal data set 5006.

In addition, each of the plane data sets constituting the spatio-temporal data set 5006 may be allocated a time value. Specifically, a plane data set may be an assembly of counting values allocated to a particular time value among counting values of the spatio-temporal data set 5006. For example, a plane data set may be an assembly of counting values allocated to a particular time bin in a detecting window among counting values of the spatio-temporal data set 5006, but is not limited thereto.

In addition, a plane data set according to an embodiment may be an assembly of counting values having different location values and the same time value. Specifically, a plurality of counting values included in the plane data set may have different locations of the detectors respectively, but may have the same time bin at which photons are detected in a detecting window.

For example, a first plane data set 5710 may be an assembly of counting values allocated to a first time bin (t1) on the basis of photons detected by the detector array, a second plane data set 5720 may be an assembly of counting values allocated to a second time bin (t2) on the basis of photons detected by the detector array, a third plane data set 5730 may be an assembly of counting values allocated to a third time bin (t3) on the basis of photons detected by the detector array, and an n-th plane data set 5740 may be an assembly of counting values allocated to an n-th time bin (tn) on the basis of photons detected by the detector array. However, no limitation thereto is imposed.

The sizes of the time values allocated to the respective plane data sets constituting the spatio-temporal data set 5006 according to an embodiment may be the same. Specifically, the sizes of the time bins corresponding to the respective plane data sets may be the same. For example, the size of the first time bin (t1) corresponding to the first plane data set 5710, the size of the second time bin (t2) corresponding to the second plane data set 5720, the size of the third time bin (t3) corresponding to third plane data set 5730, and the size of the n-th time bin (tn) corresponding to the n-th plane data set 5740 may be the same. However, without limitation thereto, according to an embodiment, the respective time bins may have different sizes.

The number of counting values included in a plane data set according to an embodiment may correspond to the number of detectors included in the detector array. Specifically, a planc data set is an assembly of counting values that have the same time value and have the location values corresponding to the locations of the respective detectors included in the detector array, so the plane data set may include as many counting values as there are detectors. For example, the plane data set may include as many counting values as there are detectors included in the detector array, but is not limited thereto.

In addition, without limitation thereto, the number of counting values included in a planc data set may be different from the number of detectors included in the detector array. Specifically, the data processing unit may determine, on the basis of a predetermined criterion, the number of counting values that each plane data set includes. For example, the numbers of counting values that the respective plane data sets include may be determined on the basis of the time values allocated to the respective plane data sets. As a specific example, the data processing unit may allocate a plurality of counting values for one detector to a plane data set allocated a time value equal to or greater than a predetermined threshold, but is not limited thereto. This is because the greater the time value to which a counting value is allocated, the longer the distance from the LiDAR device to the target point, so with a predetermined time value or greater, a plurality of counting values may be allocated to one detector to improve the resolution of the LiDAR device.

### 7.3. Visualization of Spatio-Temporal Data Set Through Image Planes

A LiDAR device according to an embodiment may visually represent a generated spatio-temporal data set.

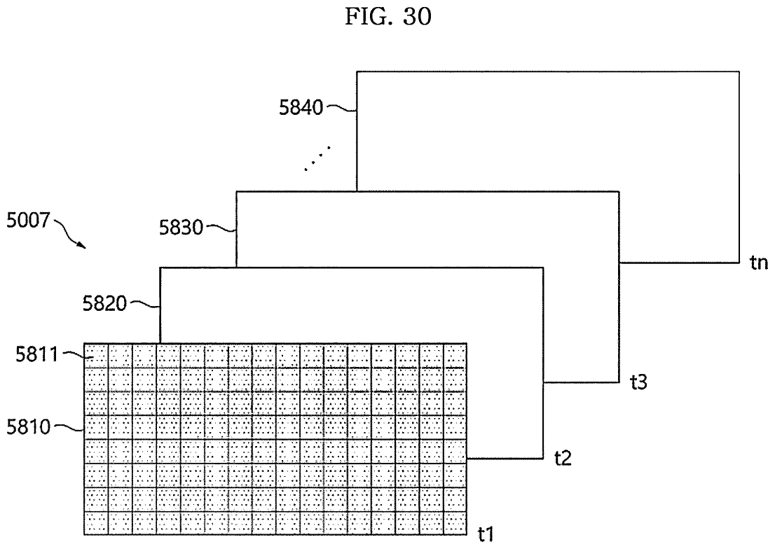

FIG. 30 is a diagram illustrating a spatio-temporal data set visualized on the basis of image planes according to an embodiment.

Referring to FIG. 30, a controller of a LiDAR device according to an embodiment may represent a spatio-temporal data set as time-series image data 5007. Specifically, the controller of the LiDAR device may generate the time-series image data 5007 including a plurality of image planes, on the basis of the counting values included in the spatio-temporal data set. For example, the data processing unit of the LiDAR device or the LiDAR data processing device may generate a spatio-temporal data set including a plurality of counting values, may convert the generated spatio-temporal data set into a plurality of image planes, and may output time-series image data 5007 including the plurality of image planes resulting from conversion, but is not limited thereto. The time-series image data may be data generated on the basis of the spatio-temporal data set. However, without being limited thereto, the time-series image data may be data that is optionally defined in the present specification to visually represent the spatio-temporal data set.

For example, the time-series image data 6000 may include a first image plane 5810, a second image plane 5820, a third image plane 5830, . . . , and an n-th image plane 5840, but is not limited thereto.

In addition, an image plane included in the time-series image data 6000 may be an image corresponding to a particular time value in the spatio-temporal data set. Specifically, a time value may be allocated to each of the plurality of image planes included in the time-series image data 6000. For example, the first image plane 5810 may correspond to a first time bin (t1), the second image plane 5820 may correspond to a second time bin (t2), the third image plane 5830 may correspond to a third time bin (t3), . . . , and the n-th image plane 5840 may correspond to an n-th time bin (tn), However, no limitation thereto is imposed.

In addition, an image plane included in the time-series image data 6000 may be generated on the basis of counting values corresponding to a particular time value in the spatio-temporal data set. For example, the controller of the LiDAR device may generate the first image plane 5810 on the basis of the counting values allocated to the first time bin (t1) among the counting values included in the spatio-temporal data set, but is not limited thereto.

In addition, the data processing unit may generate the time-series image data by generating the image planes on the basis of the above-described plane data sets. More specifically, the plurality of image planes may be generated on the basis of the plurality of plane data sets described above, respectively. For example, the first image plane 5810 may be generated on the basis of the first plane data set 5710 shown in FIG. 29, but is not limited thereto.

In addition, an image plane may be composed of a plurality of pieces of pixel data. Herein, the pixel data may include pixel coordinates and a pixel value. Specifically, the image plane may include pixel data including pixel coordinates determined on the basis of the location value of the counting value, and a pixel value determined on the basis of the magnitude of the counting value. For example, the first image plane 5810 may include first pixel data 5811. Herein, the first pixel data 5811 may include first pixel coordinates determined on the basis of a location value of a first counting value corresponding to the first pixel data, and a first pixel value determined on the basis of the magnitude of the first counting value, but is not limited thereto.

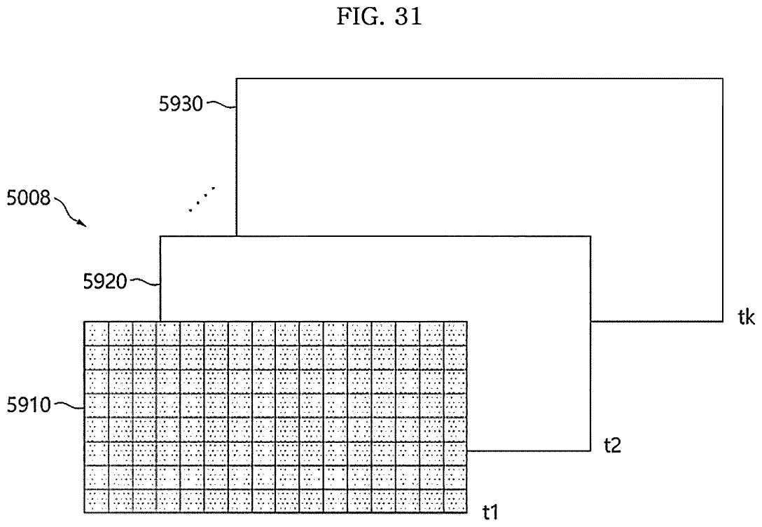

FIG. 31 is a diagram illustrating a spatio-temporal data set visualized through image planes according to another embodiment.

Referring to FIG. 31, a time-series image data 5008 according to an embodiment may include a plurality of image planes that have different scales for respective time bins. For example, the time-series image data 5008 may include a first image plane 5910 corresponding to a first time bin (t1), a second image plane 5920 corresponding to a second time bin (t2), and a k-th image plane 5930 corresponding to a k-th time bin (tk), but is not limited thereto.

Specifically, a LiDAR device having a predetermined field of view has a characteristic that the longer the distance from the LiDAR device, the larger the detection region. Therefore, the controller of the LiDAR device may generate an image plane, wherein the greater the time bin, the larger the region the image plane represents.

For example, the LiDAR device or the LiDAR data processing device may generate the time-series image data 5008 such that the greater the corresponding time bin, the gradually greater the width of the region visualized through the image plane. As a specific example, the width of the region visualized by the first image plane 5910 may be smaller than the width of the region visualized by the second image plane 5920.

As another example, the LiDAR device or the LiDAR data processing device may generate the time-series image data 5008 such that the widths of the regions visualized through the image planes change on the basis of a predetermined time bin. Specifically, the LiDAR device or the LiDAR data processing device may generate the time-series image data 5008 such that the widths of the regions visualized by the image planes before and after the k-th time bin (tk) are different. In this case, the width of the region visualized by the first image plane 5910 may be equal to the width of the region visualized by the second image plane 5920, and the width of the region visualized by the first image plane 5910 may be smaller than the width of the region visualized by the k-th image plane 5930. However, no limitation thereto is imposed.

### 8. Processing of Spatio-Temporal Data Set

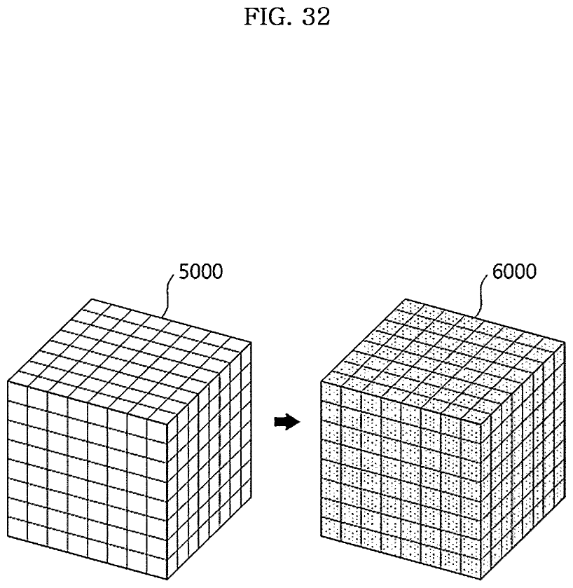

FIG. 32 is a diagram illustrating an enhanced spatio-temporal data set obtained by processing a spatio-temporal data set on the basis of a predetermined data processing method according to an embodiment.

Referring to FIG. 32, a data processing unit of a LiDAR device or a LiDAR data processing device may generate an enhanced spatio-temporal data set 6000 on the basis of a spatio-temporal data set 5000. Herein, the enhanced spatio-temporal data set 6000 may refer to a data set obtained by processing the spatio-temporal data set 5000 on the basis of a predetermined data processing method.

For example, the data processing unit may process the spatio-temporal data set 5000 on the basis of machine learning using a data processing algorithm and training data, thereby generating the enhanced spatio-temporal data set 6000.

### 8.1. Spatio-Temporal Data Set Processing Using Data Processing Algorithm

A data processing unit according to an embodiment may process a spatio-temporal data set on the basis of a plurality of counting values included in the spatio-temporal data set. Specifically, in order to process a particular counting value, the data processing unit may use at least one counting value spatio-temporally related to the particular counting value.

In addition, the data processing unit may process the spatio-temporal data set by correcting the plurality of counting values included in the spatio-temporal data set.

More specifically, the data processing unit may correct the particular counting value on the basis of at least one counting value temporally adjacent to the particular counting value and at least one counting value spatially adjacent to the particular counting value, but is not limited thereto.

For example, the data processing unit may correct a particular counting value on the basis of a counting value that corresponds to the same detector as the particular counting value and is allocated to the time bin before or after the time bin to which the particular counting value is allocated, but is not limited thereto.

In addition, for example, the data processing unit may correct a particular counting value on the basis of a counting value that is allocated to the same time bin as the particular counting value and corresponds to a detector neighboring a detector to which the particular counting value corresponds, but is not limited thereto.

In addition, for example, the data processing unit may correct a particular counting value on the basis of a counting value that corresponds to a detector neighboring a detector to which the particular counting value corresponds, and is allocated to the time bin before or after the time bin to which the particular counting value is allocated, but is not limited thereto.

As described above, a data processing unit may process a spatio-temporal data set by correcting a particular counting value included in the spatio-temporal data set. However, without limitation thereto, a spatio-temporal data set may be processed by individually correcting all counting values or some counting values included in the spatio-temporal data set on the basis of the above-described method.

A data processing unit of a LiDAR device or a LiDAR data processing device according to an embodiment may generate an enhanced spatio-temporal data set by processing a spatio-temporal data set on the basis of various types of data processing algorithms. For example, the data processing unit may process the spatio-temporal data set 5000 may performing screening operation on the basis of a screening algorithm.

In addition, for example, the data processing unit may process the spatio-temporal data set 5000 on the basis of a classification algorithm for determining types of plane data sets included in the spatio-temporal data set 5000.

In addition, for example, the data processing unit may process the spatio-temporal data set 5000 on the basis of a denoising algorithm for removing a counting value corresponding to noise among a plurality of counting values included in the spatio-temporal data set 5000.

The details of the above-described data processing algorithm will be described in detail below.

### 8.1.1. Spatio-Temporal Data Set Processing Using Screening Algorithm

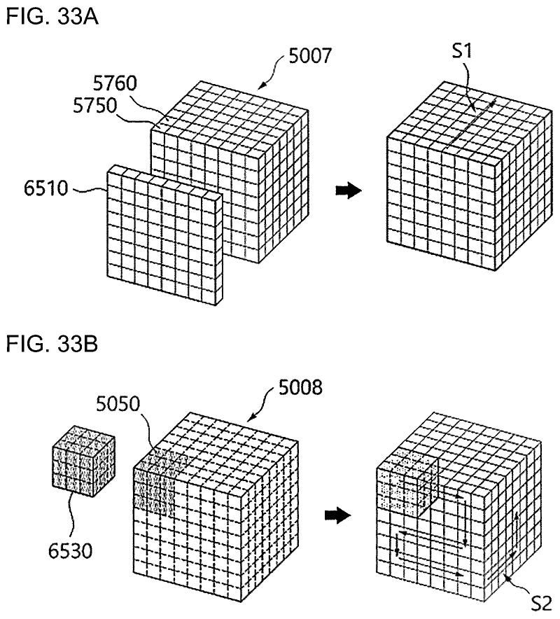

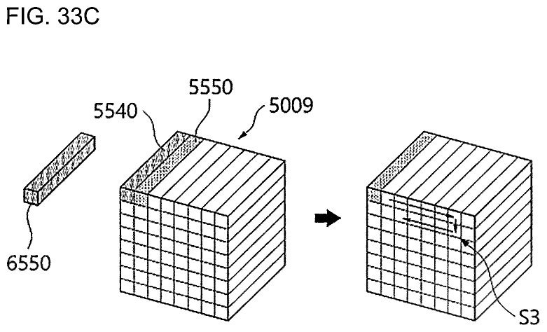

FIG. 33 is a diagram illustrating a method of processing a spatio-temporal data set using a screening algorithm according to an embodiment.

A data processing unit according to an embodiment may use a predetermined screening algorithm to perform screening operation on a spatio-temporal data set. Herein, the screening operation may refer to an operation of scanning all counting values included in the spatio-temporal data set in order for the data processing unit to process the spatio-temporal data set according to a predetermined purpose. In addition, the screening algorithm may refer to an algorithm pre-stored in the data processing unit for performing the screening operation.

In addition, the data processing unit may use various types of filters for performing the screening algorithm. For example, the data processing unit may use a planar filter 6510, a kernel filter 6530, or a matched filter 6550, but is not limited thereto.

Referring to FIG. 33A, the data processing unit may use the planar filter 6510 to perform screening operation on a spatio-temporal data set 5007 including a plurality of plane data sets. Herein, the planar filter 6510 may correspond to the plane data sets of the spatio-temporal data set 5007. Specifically, the planar filter 6510 may be designed to process the plane data sets one by one.

Specifically, for the spatio-temporal data set 5007 including a plurality of pieces of plane data corresponding to a plurality of time bins, the data processing unit may apply the planar filter 6510 to a first plane data set 5750.

In addition, the screening algorithm using the planar filter may be accompanied by an additional data processing algorithm. For example, the data processing unit may use the planar filter to process the first plane data set by performing a classification algorithm or a denoising algorithm described below, but is not limited thereto.

In addition, the data processing unit may apply the planar filter 6510 to the plane data sets sequentially in order of corresponding time bins. For example, the data processing unit may apply the planar filter 6510 to the first plane data set 5750 according to a first order (S1) and then apply the planar filter 6510 to a second plane data set 5760 corresponding to the time bin next to the time bin of the first plane data set 5750, but is not limited thereto.

In addition, referring to FIG. 33B, the data processing unit may use the kernel filter 6530 to perform screening operation on a spatio-temporal data set 5008 including a plurality of counting values. Herein, the kernel filter 6530 may correspond to a predetermined number of counting values included in the spatio-temporal data set. More specifically, the kernel filter 6530 may be designed to simultaneously process a counting value set including a predetermined number of counting values. For example, the kernel filter 6530 may be designed to simultaneously use a counting value set including 3*3*3 counting values to process at least some of the counting value set, but is not limited thereto.

Specifically, for the spatio-temporal data set 5008 including a plurality of counting values, the data processing unit may perform application to a first counting value set 5050.

In addition, the screening algorithm using the kernel filter may be accompanied by an additional data processing algorithm. For example, the data processing unit may use the planar filter to process the first counting value set by performing a classification algorithm or a denoising algorithm described below, but is not limited thereto.

In addition, the data processing unit may apply the kernel filter 6530 to the spatio-temporal data set 5008 according to a predetermined order. Specifically, the data processing unit may apply the kernel filter 6530 to the entire spatio-temporal data set according to a second order (S2). For example, the data processing unit may apply the kernel filter 6530 to the first counting value set 5050, and then may apply the kernel filter 6530 to the counting values allocated to all time bins corresponding to the first counting value set 5050, and may apply the kernel filter 6530 to the counting values allocated to the next time bins, but is not limited thereto.

In addition, referring to FIG. 33C, the data processing unit may use the matched filter 6550 to perform screening operation on a spatio-temporal data set 5009 including a plurality of accumulated data sets. Herein, the matched filter 6550 may correspond to the accumulated data sets of the spatio-temporal data set 5009. Specifically, the matched filter 6510 may be designed to process the accumulated data sets one by one.

Specifically, in the LiDAR device including the detector array, for the spatio-temporal data set 5009 including a plurality of accumulated data sets corresponding to the respective detectors of the detector array, the data processing unit may apply the matched filter 6550 to a first accumulated data set 5540.

In addition, the screening algorithm using the matched filter may be accompanied by an additional data processing algorithm. For example, the data processing unit may use the matched filter to process the first accumulated data set by performing a classification algorithm or a denoising algorithm described below, but is not limited thereto.

In addition, the data processing unit may apply the matched filter 6550 to the accumulated data sets corresponding to the respective detectors included in the detector array according to a predetermined order. For example, the data processing unit may apply the matched filter 6550 to the first accumulated data set 5540 corresponding to the first detector according to a third order (S3), and may then apply the matched filter 6550 to a second accumulated data set 5550 corresponding to a second detector adjacent to the first detector, but is not limited thereto.

### 8.1.2. Spatio-Temporal Data Set Processing Using Classification Algorithm

A data processing unit according to an embodiment may classify a spatio-temporal data set on the basis of a classification algorithm according to a purpose. Herein, the data processing unit may classify a plurality of plane data sets included in the spatio-temporal data set or a plurality of accumulated data sets included in the spatio-temporal data set according to a predetermined criterion. Herein, the above-described technical features of the plane data sets and the accumulated data sets may be applied as they are. More specifically, the data processing unit may classify the plane data sets or the accumulated data sets included in the spatio-temporal data set on the basis of the counting values included in the spatio-temporal data set.

For example, the data processing unit may classify the plane data sets or the accumulated data sets into at least one type on the basis of the distribution of the counting values included in the spatio-temporal data set. More specifically, the data processing unit may classify the plane data sets on the basis of the spatial distribution of the counting values, and may classify the accumulated data sets on the basis of the temporal distribution of the counting values.

### 8.1.2.1. Classification of Plane Data Sets

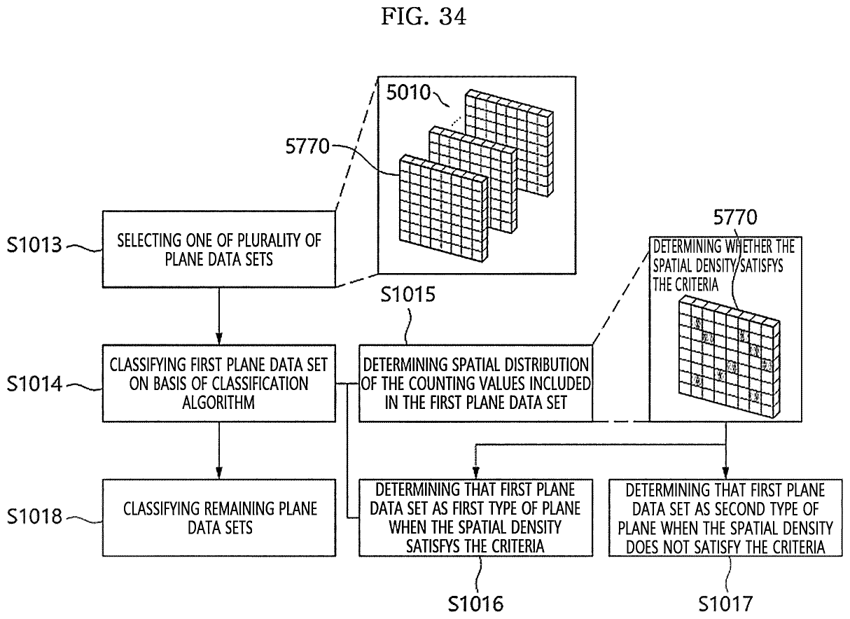

FIG. 34 is a diagram illustrating a method of classifying plane data sets on the basis of the spatial distribution of counting values by a data processing unit according to an embodiment.

A data processing unit according to an embodiment may determine the spatial distribution of counting values on the basis of whether the counting values are generated from spatially adjacent detectors. For example, the data processing unit may determine spatial distribution on the basis of proximity of the location values of the counting values included in the spatio-temporal data set.

Referring to 34, the data processing unit may select one of the plurality of plane data sets included in the spatio-temporal data set in step S1013. For example, the data processing unit may select a first plane data set 5770 among the plurality of plane data sets included in the spatio-temporal data set 5010.

In addition, the data processing unit may classify the first plane data set 5770 based on a classification algorithm in step S1014. Herein, the data processing unit may perform the classification algorithm using a planar filter. Specifically, the data processing unit may perform the classification algorithm by applying the planar filter to the first plane data set 5770.

In addition, the classification step may further include the detailed steps below.

The data processing unit may determine the spatial distribution of the counting values included in the first plane data set 5770 in step S1015. Herein, the spatial distribution may include the distribution of the location values corresponding to the counting values in the first plane data set 5770.

Herein, the determining of the spatial distribution in step S1015 may include determining whether the spatial density of the counting values included in the first plane data set 5770 satisfy a criteria by the data processing unit.

Specifically, the data processing unit may determine the spatial density on the basis of whether among the counting values included in the first plane data set 5750, the location values corresponding to the counting values having similar magnitudes are adjacent.

Alternatively, the data processing unit may determine the spatial density on the basis of whether in a plurality of similar counting values in the first plane data set 5750, the locations of the detectors corresponding to the counting values having similar magnitudes are adjacent.

In addition, when the spatial density of the counting values satisfies the criteria, the data processing unit may determine that the first plane data set 5770 is a first type of plane in step S1016.

For example, the first type of plane may include an object plane. Specifically, when counting values having similar magnitudes spatially crowd the first plane data set 5770, the data processing unit may determine that the first plane data set 5770 is a plane (object plane) including the counting values corresponding to an object.

In addition, when the spatial density of the counting values does not satisfy the criteria, the data processing unit may determine that the first plane data set 5770 is a second type of plane in step S1017.

For example, the first type of plane may include a noise plane. Specifically, when counting values having similar magnitudes does not spatially crowd the first plane data set 5770 (in other words, the counting values are spatially scattered), the data processing unit may determine that the first plane data set 5770 is a plane (noise plane) that does not include counting values corresponding to an object, but includes only counting values corresponding to noise.

In addition, the data processing unit may classify the remaining plane data sets in step S1018 on the basis of the above-described steps. Specifically, after classifying the first plane data set 5770, the data processing unit may perform the above-described classification algorithm on the remaining plane data sets on the basis of a screening algorithm using the above-described planar filter according to a predetermined order.

In addition, without limitation thereto, the classification algorithm of the plane data set may be performed by the data processing unit normalizing, on the basis of the magnitudes of the counting values included in the plane data set, the counting values.

Specifically, the data processing unit may perform normalization on all the counting values included in the plane data set, on the basis of the maximum counting value. For example, the data processing unit may calculate the deviation between the maximum counting value and each of the counting values and may generate the normalized plane data set composed of the deviation values. However, no limitation thereto is imposed.

In addition, a method of normalizing counting values is not limited to the above-described method, and general methods of normalizing data by those skilled in the art may be applied.

In addition, the data processing unit may classify the plane data set on the basis of the distribution of the deviation values of the normalized plane data set.

Specifically, when the deviation values included in the normalized plane data set are uniform, the data processing unit may determine that the plane data set is a noise plane. However, no limitation thereto is imposed. Herein, when the difference between the maximum value and the minimum value of the deviation values is equal to or less than a threshold, the data processing unit may determine that the deviation values are uniform. This is because uniform deviation values mean that most of the counting values included in the plane data set have similar magnitudes, so there is a high probability that the plane data set does not include counting values corresponding to an object.

In addition, when the deviation values included in the normalized plane data set are ununiform, the data processing unit may determine that the plane data set is an object plane. However, no limitation thereto is imposed. Herein, when the difference between the maximum value and the minimum value of the deviation values is equal to or greater than a threshold, the data processing unit may determine that the deviation values are ununiform. This is because ununiform deviation values mean that among the counting values included in the plane data set, there is a counting value set having higher values than other counting values, so there is a high probability that the plane data set includes counting values corresponding to an object.

### 8.1.2.2. Classification of Accumulated Data Sets

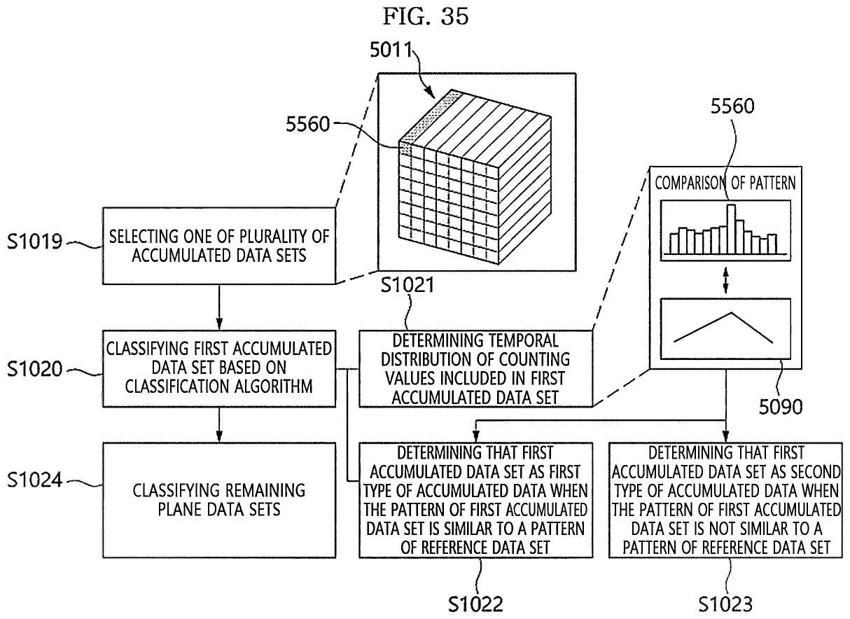

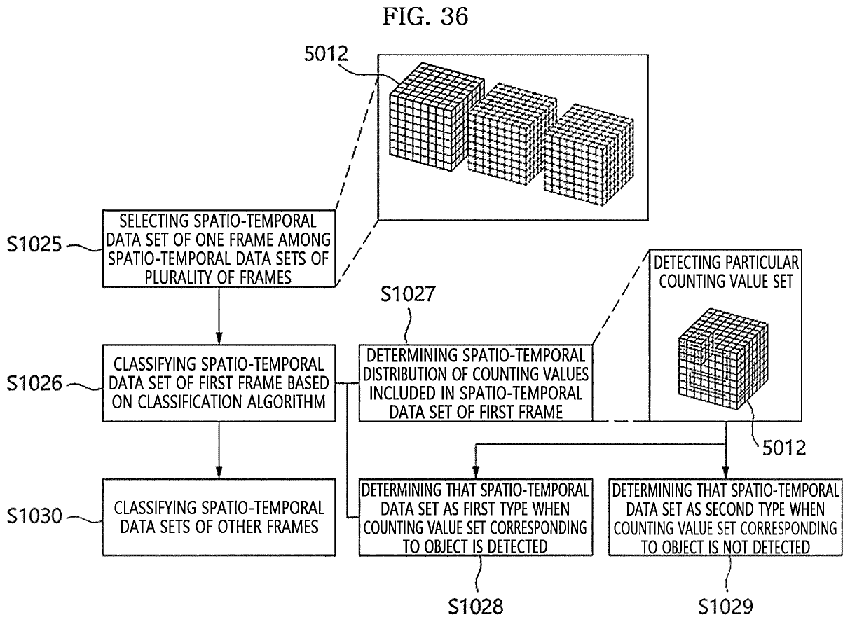

FIG. 35 is a diagram illustrating a method of classifying accumulated data sets on the basis of the temporal distribution of counting values by a data processing unit according to an embodiment.

A data processing unit according to an embodiment may determine the temporal distribution of counting values on the basis of whether the counting values have similar distribution to reference data pre-stored in the LiDAR device.

Referring to FIG. 35, the data processing unit may select one accumulated data set among a plurality of accumulated data sets included in a spatio-temporal data set in step S1019. For example, the data processing unit may select a first accumulated data set 5560 among the plurality of accumulated data sets included in the spatio-temporal data set 5011.

In addition, the data processing unit may classify the first accumulated data set 5560 on the basis of a classification algorithm in step S1020. Herein, the data processing unit may perform the classification algorithm using a matched filter. Specifically, the data processing unit may perform the classification algorithm by applying the matched filter to the first accumulated data set 5560. In addition, the classification step may further include the detailed steps below.

The data processing unit may determine the temporal distribution of the counting values included in the first accumulated data set 5560 in step S1021. Herein, the temporal distribution may include the distribution of the counting values according to time values in the first accumulated data set 5560.

Herein, the determining of the temporal distribution in step S1021 may include comparing, by the data processing unit, the counting values included in the first accumulated data set 5560 with a reference data set 5090.

Herein, the reference data set 5090 may be a data set having a predetermined pattern, as a data set pre-stored in the LiDAR device. Specifically, the data processing unit may generate the reference data set 5090 such that the reference data set has a pattern of counting values represented by detection signals with respect to an object, and may pre-store the reference data set. For example, data generated on the basis of photons reflecting off an object has a triangular pattern with a high median value, so the data processing unit may generate the reference data set 5090 having the triangular pattern and pre-store the reference data set. However, no limitation thereto is imposed.

In addition, the reference data set 5090 may be realized in the form of a matched filter having a predetermined pattern. In this case, the data processing unit may apply the matched filter to the first accumulated data set 5560 to compare the counting values included in the first accumulated data set 5560 with the predetermined pattern that the matched filter has.

In addition, the data processing unit may determine the similarity between the pattern of the counting values included in the first accumulated data set 5560 and the pattern of the reference data set 5090. For example, the similarity may be determined on the basis of the difference between the counting values included in the first accumulated data set 5560 and the data values included in the reference data set 5090, but is not limited thereto. In this case, when the difference is equal to or greater than a threshold, the data processing unit may determine that the pattern of the first accumulated data set 5560 is not similar to the pattern of the reference data set 5090. When the difference is equal to or less than a threshold, the data processing unit may determine that the pattern of the first accumulated data set 5560 is similar to the pattern of the reference data set 5090.

In addition, when the pattern of the first accumulated data set 5560 is similar to a pattern of the reference data set 5090 as a result of determination, the data processing unit may determine that the first accumulated data set 5560 is a first type of accumulated data in step S1022.

For example, the first type of accumulated data may be a data set including counting values corresponding to an object. Specifically, when the first accumulated data set 5560 has a similar pattern to the reference data set 5090 reflecting a reflection pattern of an object, the data processing unit may determine that the first accumulated data set 5560 is accumulated data including counting values corresponding to an object.

In addition, when the pattern of the first accumulated data set 5560 is not similar to a pattern of the reference data set 5090 as a result of determination, the data processing unit may determine that the first accumulated data set 5560 is a second type of accumulated data in step S1023.

For example, the second type of accumulated data may be a data set that does not include counting values corresponding to an object, but only includes counting values corresponding to noise. Specifically, when the first accumulated data set 5560 has a non-similar pattern to the reference data set 5090 reflecting a reflection pattern of an object, the data processing unit may determine that the first accumulated data set 5560 is accumulated data not including counting values corresponding to an object, but including counting values corresponding to noise.

In addition, the data processing unit may classify the remaining accumulated data sets in step S1024 on the basis of the above-described steps. Specifically, after classifying the first accumulated data set 5560, the data processing unit may perform the above-described classification algorithm on the remaining accumulated data sets on the basis of a screening algorithm using the above-described matched filter according to a predetermined order.

In addition, without limitation thereto, the classification algorithm of the accumulated data set may be performed by the data processing unit comparing the counting values included in the accumulated data set with a threshold. Specifically, the data processing unit may determine whether among a plurality of counting values included in the accumulated data set, there is a counting value having a value greater than a threshold.

For example, when a counting value having a value greater than a threshold is included in the accumulated data set, the data processing unit may determine that the accumulated data set is the first type of accumulated data having counting values corresponding to an object. However, no limitation thereto is imposed. This is because the LiDAR device sets the threshold such that counting values corresponding to an object have values at least equal to or greater than the threshold.

In addition, when all the counting values included in the accumulated data set have values less than a threshold, the data processing unit may determine that the accumulated data set is the second type of accumulated data not having counting values corresponding to an object. However, no limitation thereto is imposed.

In addition, the data processing unit may classify plane data sets or accumulated data sets constituting the spatio-temporal data set on the basis of the classification algorithm as described above. However, without being limited thereto, the data processing unit may classify the spatio-temporal data set by frame.

### 8.1.2.3. Classification of Spatio-Temporal Data Set by Frame

FIG. 36 is a diagram illustrating a method of classifying a spatio-temporal data set on the basis of the spatio-temporal distribution of counting values by a data processing unit according to an embodiment.

For a spatio-temporal data set of one frame, a data processing unit according to an embodiment may determine, on the basis of whether the spatio-temporal data set includes a counting value set corresponding to an object, the spatio-temporal distribution of counting values.

Referring to FIG. 36, a data processing unit according to an embodiment may select a spatio-temporal data set of one frame among spatio-temporal data sets of several frames in step S1025.

For example, the data processing unit may select a spatio-temporal data set 5012 of a first frame among spatio-temporal data sets of a plurality of frames. In addition, without going through the selection step S1025, the data processing unit may perform a classification algorithm, which will be described below, each time a spatio-temporal data set of one frame is generated.

In addition, the data processing unit may classify the spatio-temporal data set 5012 of the first frame on the basis of the classification algorithm in step S1026. Herein, the data processing unit may perform the classification algorithm using a kernel filter. Specifically, the data processing unit may perform the classification algorithm by applying the kernel filter to some of the counting values included in the spatio-temporal data set 5012 of the first frame.

In addition, the classification step may further include the detailed steps below.

The data processing unit may determine the spatio-temporal distribution of the counting values included in the spatio-temporal data set 5012 of the first frame in step S1027. Herein, the spatio-temporal distribution may include the distribution of a plurality of counting values corresponding to a plurality of location values and a plurality of time bins.

Herein, the determining of the spatio-temporal distribution in step S1027 may include determining, by the data processing unit, whether a particular counting value set corresponding to an object is present in the spatio-temporal data set 5012 of the first frame.

For example, the data processing unit may determine that in the first frame data set 5012, a counting value set representing a pattern similar to a reflection pattern of an object is a particular counting value set corresponding to an object, but is not limited thereto.

In addition, for example, the data processing unit may use a kernel filter to determine whether among the counting values included in the first frame data set 5012, there is a particular counting value set corresponding to an object, but is not limited thereto. In this case, the data processing unit may use the kernel filter that reflects a reflection pattern of an object.

More specifically, the data processing unit may apply the kernel filter to a first counting value set in the first frame data set 5012, and may determine whether the first counting value set is a particular counting value set corresponding to an object. In addition, the data processing unit may determine whether the particular counting value set is present by screening the spatio-temporal data set 5012 of the first frame with the kernel filter according to a predetermined order.

In addition, without being limited thereto, the data processing unit may perform the above-described step using a planar filter or a matched filter.

In addition, when a particular counting value set corresponding to an object is detected, the data processing unit may determine that the spatio-temporal data set 5012 of the first frame is a first type of data set in step S1028. Herein, the first type of data set may be a data set in which a counting value corresponding to an object is present.

In addition, when a particular counting value set corresponding to an object is not detected, the data processing unit may determine that the spatio-temporal data set 5012 of the first frame is a second type of data set. Herein, the second type of data set may be a noise spatio-temporal data set in which a counting value corresponding to an object is not present in step S1029.

In addition, the data processing unit may classify the spatio-temporal data sets of the remaining frames in step S1030 on the basis of the above-described steps.

### 8.1.2.4. Postprocessing Method of Classification Algorithm

A data processing unit according to an embodiment may process data through postprocessing after classifying the data on the basis of the classification algorithm. More specifically, the data processing unit may process data in different ways according to a result of the classification algorithm. However, without being limited thereto, the data processing unit may process data in the same way.

For example, the data processing unit may determine whether to adjust counting values of a data set according to a result of the classification algorithm.

In addition, for example, the data processing unit may perform a denoising algorithm, which will be described later, on a data set regardless of a result of the classification algorithm.

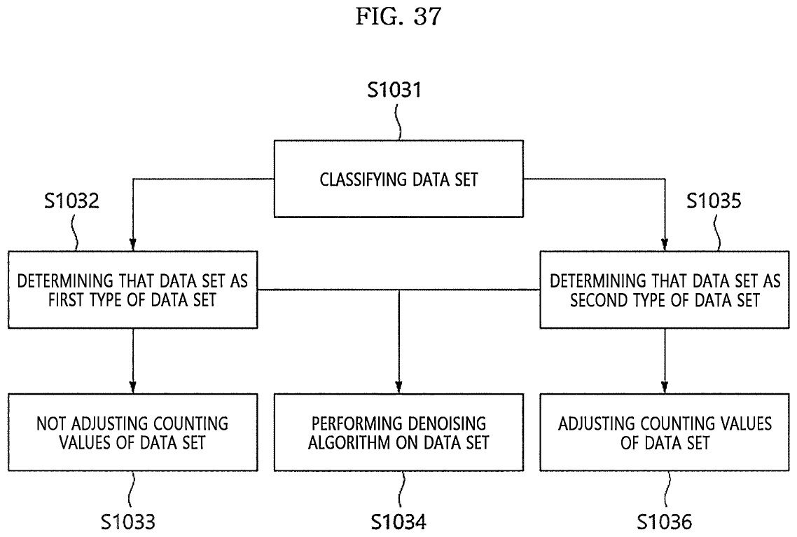

FIG. 37 is a diagram illustrating a method of classifying and postprocessing data by a data processing unit according to an embodiment.

Referring to FIG. 37, the data processing unit may classify a data set in step S1031. Herein, the data set may include a spatio-temporal data set of one frame, a plane data set included in a spatio-temporal data set, or an accumulated data set included in a spatio-temporal data set, but is not limited thereto.

In addition, according to a result of classification, the data processing unit may determine that the data set is a first type of data set in step S1032. Herein, the first type of data set may be a data set including at least one counting value corresponding to an object. For example, the first type of data set may include the first type of spatio-temporal data set (for example, a frame spatio-temporal data set including a counting value set corresponding to an object), the first type of plane (for example, an object plane), or the first type of accumulated data (for example, an accumulated data set representing a reflection pattern of an object) described above, but is not limited thereto.

In addition, the data processing unit may not adjust the counting values included in the data set identified as the first type of data set in step S1033. This may be to preserve the counting values of the data set because the first type of data set reflects information on the object. Without being limited thereto, according to an embodiment, the data processing unit may adjust the counting values of the data set according to a purpose, such as smoothing, which will be described later.

Alternatively, the data processing unit may perform a denoising algorithm, which will be described later, on the data set in step S1034. The details of the denoising algorithm will be described below.

In addition, according to a result of classification, the data processing unit may determine that the data set is a second type of data set in step S1035. Herein, the second type of data set may be a data set including at least one counting value corresponding to noise. For example, the second type of data set may include the second type of spatio-temporal data set (for example, a frame spatio-temporal data set in which a counting value corresponding to an object is not present), the second type of plane (for example, a noise plane), or the second type of accumulated data (for example, an accumulated data set in which a counting value corresponding to an object is not present) described above, but is not limited thereto.

In addition, the data processing unit may adjust the counting values included in the data set identified as the second type of data set in step S1036. This is because the second type of data set does not reflect information on an object, so the data processing unit may determine that the second type of data set is noise data. For example, the data processing unit may adjust all counting values included in the data set identified as the second type of data set, to 0. In addition, without limitation thereto, the data processing unit may adjust some of the counting values included in the data set identified as the second type of data set, to 0. In addition, without limitation thereto, the data processing unit may delete the data set identified as the second type of data set.

Alternatively, the data processing unit may perform a denoising algorithm, which will be described later, on the data set in step S1034. The details of the denoising algorithm will be described below.

### 8.1.3. Spatio-Temporal Data Set Processing Using Denoising Algorithm

A data processing unit according to an embodiment may remove noise data included in a spatio-temporal data set on the basis of a denoising algorithm.

More specifically, the data processing unit may extract or remove, on the basis of the denoising algorithm, counting values corresponding to noise among a plurality of counting values included in the spatio-temporal data set. For example, the data processing unit may adjust the counting values corresponding to noise to 0 on the basis of the denoising algorithm, but is not limited thereto.

### 8.1.3.1. Denoising Algorithm Using Kernel Filter

For example, the data processing unit may perform denoising on a spatio-temporal data set using a kernel filter.

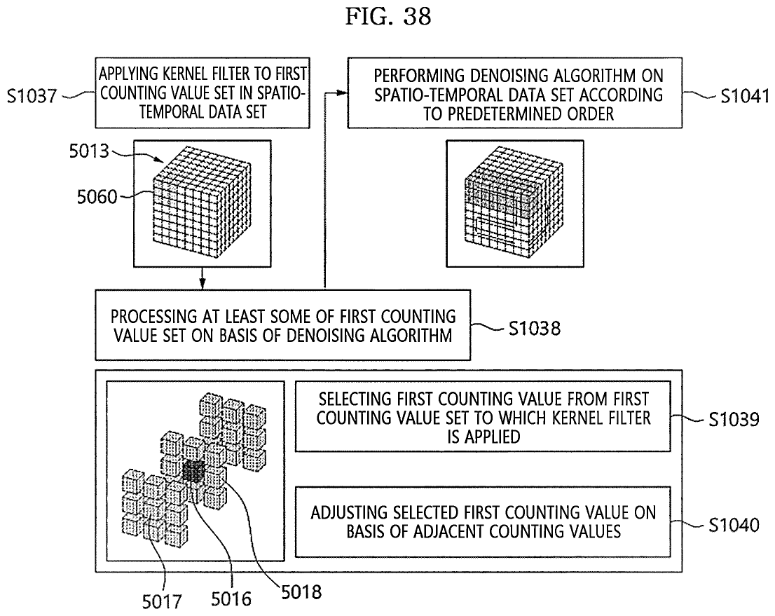

FIG. 38 is a diagram illustrating a method of denoising a spatio-temporal data set using a kernel filter by a data processing unit according to an embodiment.

Referring to FIG. 38, a data processing unit included in a LiDAR device or a LiDAR data processing device may apply a spatial filter to a first counting value set 5060 that is a part of a plurality of counting values included in a spatio-temporal data set 5013 in step S1037.

Herein, the first counting value set 5060 may be a plurality of counting values including a first counting value 5016. For example, the first counting value set 5060 may include the first counting value 5016 and adjacent counting values of the first counting value 5016

In addition, the data processing unit may process at least a part of the first counting value set 5060 on the basis of a denoising algorithm in step S1038.

Herein, the data processing unit may perform the denoising algorithm on the basis of Gaussian filtering. In addition, the kernel filter may be a filter for performing Gaussian filtering. Accordingly, a counting value set to which the kernel filter is applied may be denoised through Gaussian filtering.

Specifically, the data processing unit may select the first counting value 5016 from the first counting value set 5060 to which the kernel filter is applied in step S1039. Herein, the first counting value 5016 may be a counting value located in the center of the first counting value set 5060, but is not limited thereto.

In addition, the data processing unit may adjust the selected first counting value 5016 on the basis of the adjacent counting values excluding the first counting value in the first counting value set 5060 in step S1040.

Specifically, the data processing unit may adjust the first counting value 5016 on the basis of the counting values adjacent to the first counting value 5016. For example, the data processing unit may include a group of the first counting value 5016, a second counting value 5017 corresponding to the same location value as the first counting value 5016 and a neighboring time value, and a third counting value 5018 corresponding to the same time value as the first counting value 5016 and having a neighboring location value, but is not limited thereto.

As a specific example, the first counting value 5016 corresponding to a first location value and a first time bin may be adjusted on the basis of the second counting value 5017 corresponding to the first location value and a second time bin before the first time bin, and the third counting value 5018 corresponding to a second location value adjacent to the first location value and the first time bin, but is not limited thereto.

In addition, for example, the first counting value 5016 corresponding to a first detector and included in a first plane data set may be adjusted on the basis of the second counting value 5017 corresponding to the first detector and included in a second plane data set neighboring the first plane data set, and the third counting value 5018 corresponding to a second detector neighboring the first detector and included in the first plane data set.

In addition, for example, the first counting value 5016 corresponding to a first time bin and included in a first accumulated data set may be adjusted on the basis of the second counting value 5017 included in the first accumulated data set and corresponding to a second time bin before the first time bin, and the third counting value 5018 corresponding to the first time bin and included in a second accumulated data set spatially neighboring the first accumulated data set.

In addition, for example, the first counting value 5016 included in a first image plane and corresponding to first pixel coordinates may be adjusted on the basis of the second counting value 5017 included in a second image plane before the first image plane and corresponding to second pixel coordinates the same as the first pixel coordinates, and the third counting value 5018 included in the first image plane and corresponding to third pixel coordinates neighboring the first pixel coordinates.

In addition, the data processing unit may perform the denoising algorithm on a spatio-temporal data set 5012 according to a predetermined order in step S1041. Specifically, the data processing unit performs the above-described screening operation, thereby performing the above-described denoising algorithm on all the counting values included in the spatio-temporal data set. For example, the data processing unit may locate each of the all counting values included in the spatio-temporal data set 5012 at the center of the kernel filter, thereby adjusting all the counting values. However, no limitation thereto is imposed.

### 8.1.3.2. Additional Example of Denoising Algorithm

In addition, a data processing unit may adjust, on the basis of differences between a target counting value to be subjected to denoising and adjacent counting values of the target counting value, the target counting value.

Specifically, the data processing unit may calculate a difference between a target counting value included in a counting value set to which a kernel filter is applied and at least one adjacent counting value of the target counting value included in the counting value set.

In addition, the data processing unit may compare the sum of the differences to a threshold.

Specifically, when the sum of the differences between the target counting value and the adjacent counting values is equal to or greater than a threshold, the data processing unit may change the target counting value to 0 or may delete the target counting value. However, no limitation thereto is imposed. This is because when the sum of the differences is equal to or greater than the threshold, the target counting value is different from the adjacent counting values and the target counting value may thus be noise data.

In addition, when the differences are equal to or less than a threshold, the data processing unit may correct the target counting value on the basis of the adjacent counting values. For example, the data processing unit may adjust the target counting value to an average value of the target counting value and the adjacent counting values, but is not limited thereto. Through this, the data processing unit may achieve the effect of smoothing counting values, which will be described below.

In addition, when adjusting the target counting value, the data processing unit may correct the target counting value on the basis of the proximity to adjacent counting values. More specifically, the data processing unit may correct the target counting value by further reflecting a counting value of a detector adjacent to a target detector to which the target counting value corresponds.

For example, the data processing unit may correct the target counting value by applying a weighting in such a manner that the closer a detector is to the target detector, the higher the weighting applied. For example, the data processing unit may apply a first weighting of a counting value corresponding to a first detector neighboring a target detector and may apply a second weighting smaller than the first weighting to a second detector not neighboring the target detector, but is not limited thereto. In this case, the data processing unit may adjust the target counting value on the basis of the adjacent counting values to which the weightings are applied.

In addition, the data processing unit may process a spatio-temporal data set including a plurality of image planes on the basis of a denoising algorithm. In this case, the data processing unit may perform the denoising algorithm on each of the plurality of image planes, or may perform the denoising algorithm on the entire spatio-temporal data set. For example, the data processing unit may use a planar filter to perform denoising on each of the plurality of image planes, or may use the kernel filter to perform screening and denoising on the entire spatio-temporal data set.

In addition, the data processing unit may process the spatio-temporal data set to generate an enhanced spatio-temporal data set including an image plane from which an outlier is deleted. Herein, the outlier may refer to noise data in the image plane. In addition, in this case, the data processing unit may visualize the enhanced spatio-temporal data set including the image plane from which the outlier is deleted.

### 8.2. Spatio-Temporal Data Set Processing Using Machine Learning Model

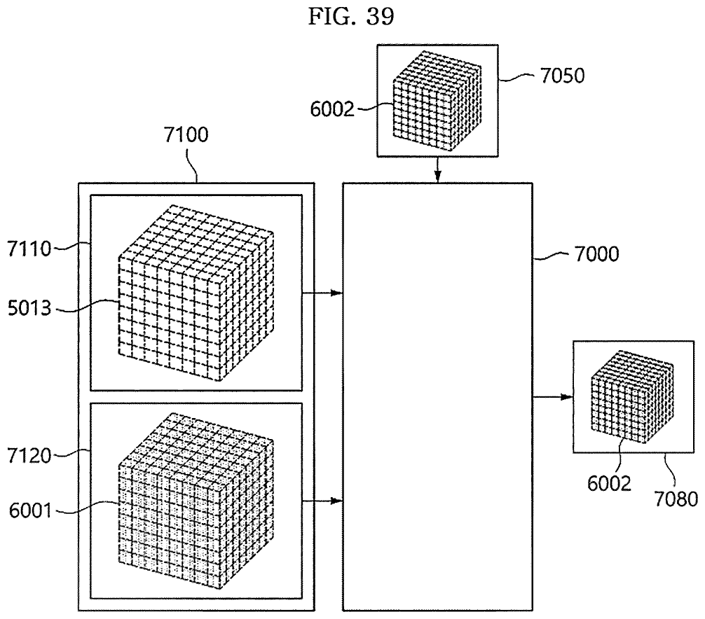

FIG. 39 is a diagram illustrating a method of processing a spatio-temporal data set using a machine learning model according to an embodiment.

Referring to FIG. 39, a data processing unit may process a spatio-temporal data set by using a machine learning model 7000. Herein, when the machine learning model 7000 receives input data 7050, the machine learning model may output output data 7080. In particular, the machine learning model 7000 may be a deep learning model, but is not limited thereto.

In addition, the machine learning model 7000 may be stored in the data processing unit. However, without being limited thereto, the machine learning model may be stored in an external processor separate from the data processing unit. In this case, the data processing unit may transmit the input data 7050 to the machine learning model 7000 and may receive the output data 7080 from the machine learning model 7000.

In addition, the data processing unit or the external processor may train the machine learning model 7000. Herein, as a method of training the machine learning model 7000, a general method of training machine learning, such as supervised learning, semi-supervised learning, unsupervised learning, or reinforcement learning, may be used.

In addition, the data processing unit or the external processor may train the machine learning model 7000 using at least one piece of training data 7100. Herein, the training data 7100 may be data provided to the machine learning model 7000 so that machine learning model 7000 outputs the targeted output data 7080 on the basis of the input data 7050.

For example, the data processing unit or the external processor may include first training data 7110 and second training data 7120, but is not limited thereto. Herein, the first training data 7110 may be data in the same layer as data to be processed through the machine learning model 7000. In addition, the second training data 712 may be correct answer data intended to be obtained through the machine learning model 7000.

Specifically, the first training data 7110 may correspond to the input data 7050, and the second training data 7120 may correspond to the output data 7080.

Specifically, the data processing unit or the external processor may train the machine learning model 7000 such that when data in the same layer as the first training data 7110 is input, data in the same layer as the second training data 7120 is output.

For example, the data processing unit or the external processor may use, as the first training data 7110, a spatio-temporal data set 5013 generated by the data processing unit. In addition, the data processing unit or the external processor may use the above-described enhanced spatio-temporal data set 6001 as the second training data 7120. Specifically, the data processing unit or the external processor may perform classification, denoising, or screening on the spatio-temporal data set through machine learning.

In this case, when a spatio-temporal data set 5014 generated by the data processing unit is input to the machine learning model 7000, the machine learning model 7000 may process the spatio-temporal data set and output an enhanced spatio-temporal data set 6002.

In addition, for example, the data processing unit or the external processor may use, as the first training data 7110, a spatio-temporal data set generated by a LiDAR device with a low laser emission power. In addition, the data processing unit or the external processor may use, as the second training data 7120, a spatio-temporal data set generated by a LiDAR device with a high laser emission power. Specifically, the data processing unit or the external processor may obtain a spatio-temporal data set with improved distance resolution or brightness through machine learning.

In this case, when a spatio-temporal data set generated by a LiDAR device with low output power is input to the machine learning model 7000, the machine learning model 7000 may output a high-resolution spatio-temporal data set similar to a spatio-temporal data set generated by a LiDAR device with high laser emission power.

### 8.3. Examples of Processing Spatio-Temporal Data Sets According to Purposes

In addition, the data processing unit may process the spatio-temporal data set on the basis of various purposes.

For example, the data processing unit may process the spatio-temporal data set to extract a target data set from the spatio-temporal data set, but is not limited thereto.

In addition, for example, the data processing unit may process the spatio-temporal data set to perform smoothing on the spatio-temporal data set, but is not limited thereto.

Hereinafter, methods of processing spatio-temporal data sets according to the above-described data processing purposes will be described in detail.

### 8.3.1. Spatio-Temporal Data Set Processing for Extracting Target Data Set

A data processing unit of a LiDAR device or a LiDAR data processing device according to an embodiment may process a spatio-temporal data set and may extract a target data set having a predetermined pattern. Herein, the target data set may refer to a counting value set having a predetermined distribution pattern among counting values included in the spatio-temporal data set. For example, the target data set may refer to a counting value set representing a reflection pattern of a first object within the spatio-temporal data set, but is not limited thereto.

Herein, the data processing unit may extract the target data set on the basis of the above-described classification algorithm. However, without being limited thereto, the data processing unit may extract the target data set on the basis of the above-described denoising algorithm, screening algorithm, or machine learning.

Hereinafter, as a representative example, a method of extracting a target data set by performing a screening algorithm using a kernel filter will be described.

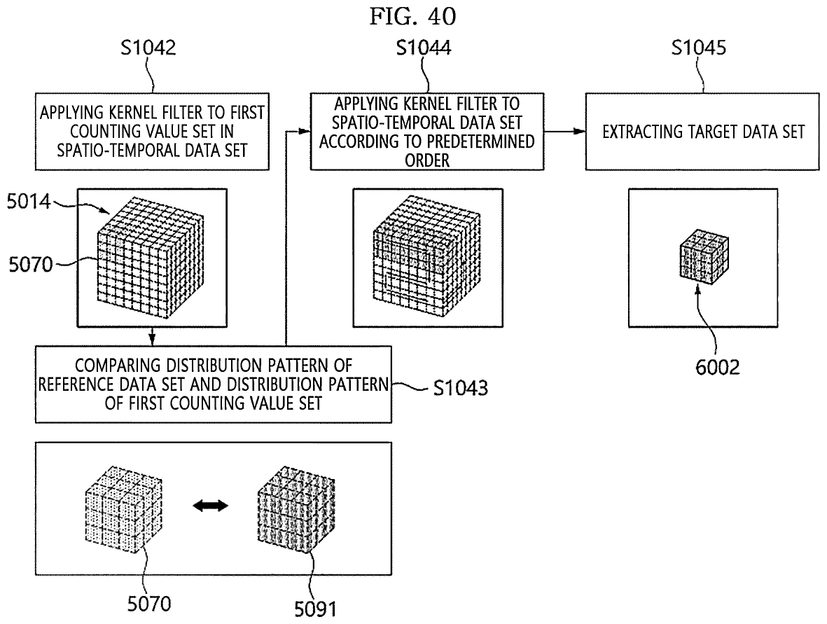

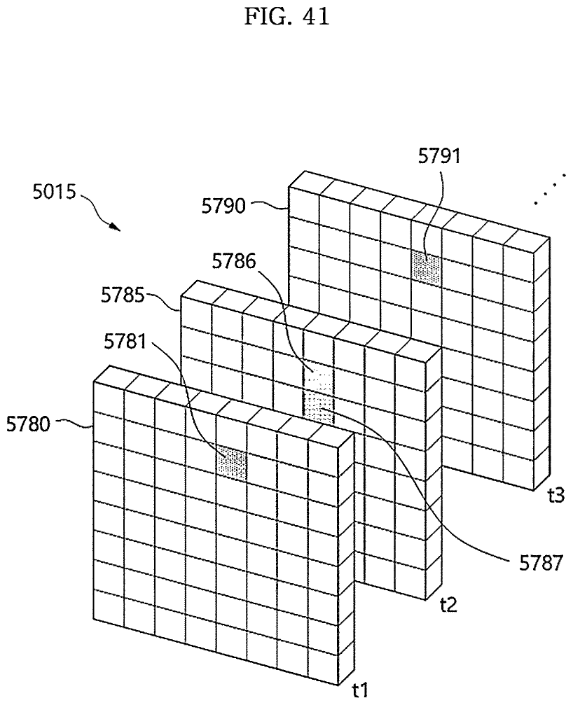

FIG. 40 is a flowchart illustrating a method of extracting a target data set within a spatio-temporal data set by a data processing unit according to an embodiment.

Referring to FIG. 40, the data processing unit may apply a kernel filter to a first counting value set 5070 among counting values included in a spatio-temporal data set 5014 in step S1042.

In addition, the data processing unit may compare a counting value distribution pattern of the first counting value set 5070 to that of the reference data set 5091 in step S1043. Specifically, the data processing unit may pre-store a reference data set for a reflection pattern of a first object in order to extract a counting value set including counting values corresponding to the first object from the spatio-temporal data set.

In addition, the kernel filter may include the reference data set 5091. Specifically, the kernel filter may include the reference data set 5091 including counting values having a predetermined distribution pattern, and the data processing unit may compare the counting value distribution pattern of the first counting value set 5070 in which the kernel filter is located, with the counting value distribution pattern of the kernel filter.

In addition, the data processing unit may apply the kernel filter to the spatio-temporal data set according to a predetermined order in step S1044. For example, by performing screening operation, the data processing unit may perform the above-described steps S1042 and S1043 using the kernel filter on the entire spatio-temporal data set.

In addition, the data processing unit may extract a target data set 6002 from the spatio-temporal data set 5014 in step S1045. Specifically, the data processing unit may extract, from the spatio-temporal data set, a counting value set having a similar distribution pattern of the counting values to the reference data set and may determine the extracted counting value set as the target data set. For example, the target data set 6002 may be, among the counting values included in the spatio-temporal data set 5014, a counting value set having a similar counting value distribution pattern to the reference data set 5091, but is not limited thereto.

In addition, without being limited thereto, the data processing unit may apply a planar filter to each plane data set of the spatio-temporal data set, and may extract, as the target data set, a counting value set having a similar distribution pattern to the reference data set from the plane data sets.

In addition, without being limited thereto, the data processing unit may apply a matched filter to each accumulated data set of the spatio-temporal data set, and may extract, as the target data set, a counting value set having a similar distribution pattern to the reference data set from the accumulated data sets.

In addition, without being limited thereto, the data processing unit may train a machine learning model with the spatio-temporal data set and the reference data set such that the target data set is output when the spatio-temporal data set is input to the machine learning model.

### 8.3.2. Spatio-Temporal Data Set Processing for Data Smoothing

A data processing unit of a LiDAR device or a LiDAR data processing device according to an embodiment may process a spatio-temporal data set to generate an enhanced spatio-temporal data set in which data is smoothed. Herein, data smoothing may be one of the data preprocessing methods for smoothing counting values included in a spatio-temporal data set into a form suitable for processing by the data processing unit. For example, the counting values of the spatio-temporal data set may be distorted or deformed by jitter that occurs in the process of generating the spatio-temporal data set by the data processing unit, and the distorted or deformed counting values may be smoothed through data smoothing.

For example, the data processing unit may perform smoothing on the spatio-temporal data set by adjusting the counting values on the basis of a denoising algorithm. However, without being limited thereto, the data processing unit may perform smoothing on the spatio-temporal data set by adjusting the counting values using the above-described machine learning.

### 9. Use of Spatio-Temporal Data Set

### 9.1. Generation of Depth Information and Intensity Information Using Spatio-Temporal Data Set

A data processing unit according to an embodiment may obtain depth information of a detection point on the basis of a spatio-temporal data set. Specifically, the data processing unit may extract a detection time point of a laser on the basis of a plurality of counting values included in the spatio-temporal data set, and may obtain depth information on the basis of the detection time point of the laser and an emission time point of the laser.

In addition, a data processing unit according to an embodiment may obtain intensity information of a detection point on the basis of a spatio-temporal data set. Specifically, the data processing unit may obtain intensity information of a detection point by determining the intensity of a laser reflecting off the detection point, on the basis of a plurality of counting values included in the spatio-temporal data set.

In addition, in order to obtain depth information of an object detected by a particular detector, the data processing unit may use detection signals received from one or more adjacent detectors of the particular detector.

For example, the data processing unit may obtain depth information corresponding to a particular detector on the basis of a particular counting value corresponding to the particular detector and one or more counting values corresponding to adjacent detectors of the particular detector in the spatio-temporal data set, but is not limited thereto.

In addition, in order to obtain intensity information of an object detected by a particular detector, the data processing unit may use the intensities of detection signals received from one or more adjacent detectors of the particular detector.

For example, the data processing unit may obtain an intensity value corresponding to a particular detector on the basis of the magnitudes of a particular counting value corresponding to the particular detector and one or more counting values corresponding to adjacent detectors of the particular detector in the spatio-temporal data set, but is not limited thereto.

In addition, the data processing unit may obtain depth information of a detection point on the basis of an enhanced spatio-temporal data set resulting from processing the spatio-temporal data set.

For example, the data processing unit may generate an enhanced spatio-temporal data set with data corresponding to noise removed by denoising the generated spatio-temporal data set, and may obtain depth information on the basis of the enhanced spatio-temporal data set, but is not limited thereto.

### 9.1.1. Depth Information Obtainment Method Using Adjacent Counting Values

A data processing unit according to an embodiment may generate a spatio-temporal data set including a plurality of counting values. Herein, the data processing unit may determine depth information of a detection point on the basis of at least some of the plurality of counting values. Specifically, the data processing unit may determine the depth information of the detection point on the basis of a plurality of spatio-temporally adjacent counting values among the plurality of counting values. Herein, the data processing unit may extract a laser detection time point on the basis of one or more time bins to which the plurality of adjacent counting values are allocated, and may determine the depth information of the detection point on the basis of the laser detection time point.

For example, depth information corresponding to a first detector may be obtained on the basis of a first counting value corresponding to the first detector and allocated to a first time bin, and adjacent counting values of the first counting value, but is not limited thereto. Herein, the adjacent counting values may include at least one counting value spatio-temporally adjacent to the first counting value. For example, the adjacent counting values may include at least one of the following: a counting value corresponding to the first detector and allocated to the time bin before or after the first time bin; a counting value corresponding to a second detector neighboring the first detector and allocated to the first time bin; and a counting value corresponding to the second detector neighboring the first detector and allocated to the time bin before or after the first time bin. However, the adjacent counting values are not limited thereto.

In addition, without being limited thereto, the data processing unit may calculate an intensity value of the detection point on the basis of the magnitudes of the plurality of adjacent counting values.

In addition, a data processing unit according to an embodiment may generate a spatio-temporal data set including a plurality of accumulated data sets. Herein, the data processing unit may determine depth information of a detection point on the basis of at least some of the plurality of accumulated data sets. Specifically, the data processing unit may determine the depth information of the detection point on the basis of counting values included in a plurality of spatially adjacent accumulated data sets among the plurality of accumulated data sets.

For example, the data processing unit may obtain depth information corresponding to a first detector on the basis of a first accumulated data set corresponding to the first detector and adjacent accumulated data sets of the first accumulated data set, but is not limited thereto. Herein, the adjacent accumulated data sets may include at least one accumulated data set spatially adjacent to the first accumulated data set. Specifically, the adjacent accumulated data sets may include at least one accumulated data set corresponding to at least one detector neighboring the first detector, but is not limited thereto.

In addition, without being limited thereto, the data processing unit may calculate an intensity value of the detection point on the basis of the magnitudes of the counting values included in the plurality of adjacent accumulated data sets.

In addition, a data processing unit according to an embodiment may generate a spatio-temporal data set including a plurality of plane data sets. Herein, the data processing unit may determine depth information of a detection point on the basis of at least some of the plurality of plane data sets. Specifically, the data processing unit may determine the depth information of the detection point on the basis of counting values included in a plurality of temporally adjacent plane data sets among the plurality of plane data sets.

For example, the data processing unit may obtain depth information corresponding to a first detector on the basis of a first plane data set corresponding to a first time bin and adjacent plane data sets of the first plane data set, but is not limited thereto. Herein, the adjacent plane data sets may include at least one plane data set temporally adjacent to the first plane data set. Specifically, the adjacent plane data sets may include at least one plane data set corresponding to a time bin before or after the first time bin, but is not limited thereto.

In addition, without being limited thereto, the data processing unit may calculate an intensity value of the detection point on the basis of the magnitudes of the counting values included in the plurality of adjacent plane data sets.

In addition, a data processing unit according to an embodiment may generate a spatio-temporal data set including a plurality of unit spaces. Herein, the data processing unit may determine depth information of a detection point on the basis of at least some of the plurality of unit spaces. Specifically, the data processing unit may determine the depth information of the detection point on the basis of the counting values allocated to a plurality of spatio-temporally adjacent unit spaces among the plurality of unit spaces.

For example, the data processing unit may obtain depth information corresponding to a first detector on the basis of a first unit space, which is defined by a first unit region corresponding to the first detector and a first unit time corresponding to a first time bin, and adjacent unit spaces of the first unit space, but is not limited thereto. Herein, the adjacent unit spaces may include at least one unit space spatio-temporally adjacent to the first unit space. Specifically, the adjacent unit spaces may include at least one unit space that is defined by a unit region corresponding to at least one detector neighboring the first detector and a unit time corresponding to a time bin before or after the first time bin, but is not limited thereto.

In addition, without being limited thereto, the data processing unit may calculate an intensity value of the detection point on the basis of the magnitudes of the counting values allocated to the plurality of adjacent unit spaces.

In addition, a data processing unit according to an embodiment may generate a spatio-temporal data set including a plurality of image planes. Herein, the data processing unit may determine depth information of a detection point on the basis of at least some of the plurality of image planes. Specifically, the data processing unit may determine the depth information of the detection point on the basis of pieces of pixel data included in a plurality of temporally adjacent image planes among the plurality of image planes.

For example, the data processing unit may obtain depth information corresponding to a first detector on the basis of a first image plane corresponding to a first time bin and adjacent image planes of the first image plane, but is not limited thereto. Herein, the adjacent image planes may include at least one image plane temporally adjacent to the first image plane. Specifically, the adjacent image planes may include at least one image plane corresponding to a time bin before or after the first time bin, but is not limited thereto.

In addition, without being limited thereto, the data processing unit may calculate an intensity value of the detection point on the basis of the magnitudes of the pixel values of pixel data included in the plurality of adjacent image planes.

For example, a method of obtaining depth information on the basis of a spatio-temporal data set including a plurality of plane data sets will be described with reference to FIG. 41.

FIG. 41 is a diagram illustrating a method of obtaining depth information on the basis of a spatio-temporal data set according to an embodiment.

In order to obtain depth information corresponding to a particular detector, a data processing unit according to an embodiment may use a data set corresponding to the particular detector as well as data sets corresponding to detectors spatially adjacent to the particular detector. Specifically, the data processing unit may obtain the depth information corresponding to the particular detector on the basis of a particular counting value corresponding to the particular detector and allocated to a particular time bin, and one or more counting values corresponding to one or more detectors located around the particular detector and allocated to the particular time bin and time bins near the particular time bin.

Referring to FIG. 41, the data processing unit may generate a spatio-temporal data set 5015 including a plurality of plane data sets. Herein, the plurality of plane data sets may correspond to a plurality of time bins constituting a detecting window, respectively. For example, the spatio-temporal data set 5015 may include a first plane data set 5780 corresponding to a first time bin (t1), a second plane data set 5785 corresponding to a second time bin (t2), and a third plane data set 5790 corresponding to a third time bin (t3), but is not limited thereto.

In addition, a plane data set may include a plurality of counting values. Herein, the plurality of counting values included in the plane data set may correspond to detectors included in a detector array, respectively. For example, the first plane data set 5780 may include a first counting value 5781 corresponding to a first detector, the second plane data set 5785 may include a second counting value 5786 included in the first detector and a third counting value 5787 corresponding to a second detector adjacent to the first detector, and the third plane data set 5790 may include a fourth counting value 5791 corresponding to the first detector. However, no limitation thereto is imposed.

In addition, the data processing unit may obtain depth information corresponding to the first detector on the basis of counting values included in the plurality of plane data sets. Herein, the data processing unit may obtain the depth information corresponding to the first detector on the basis of a particular counting value corresponding to the first detector and adjacent counting values of the particular counting value.

For example, the data processing unit may obtain the depth information corresponding to the first detector on the basis of the second counting value 5786 corresponding to the first detector and included in the second plane data set 5785, and adjacent counting values of the second counting value.

Herein, the adjacent counting values may include at least one counting value spatially adjacent to the second counting value 5786. As a specific example, the adjacent counting values may include the third counting value 5787 corresponding to the second detector adjacent to the first detector and included in the second plane data set 5785, but are not limited thereto.

In addition, the adjacent counting values may include at least one counting value temporally adjacent to the second counting value 5786. As a specific example, the data processing unit may include the first counting value 5781 corresponding to the first detector and allocated to the first time bin (t1) before the second time bin (t2) to which the second counting value 5786 is allocated, and the fourth counting value 5791 corresponding to the first detector and allocated to the third time bin (t3) after the second time bin (t2) to which the second counting value 5786 is allocated, but is not limited thereto.

### 9.1.2. Method of Obtaining Depth Information and Intensity Information Using Enhanced Spatio-Temporal Data Set

A data processing unit of a LiDAR device or a LiDAR data processing device according to an embodiment may process a spatio-temporal data set to generate an enhanced spatio-temporal data set, and may obtain depth information and intensity information of a detection point on the basis of the enhanced spatio-temporal data set. Specifically, in the LiDAR device including a detector array, the data processing unit may process the generated spatio-temporal data set into a form suitable for obtaining depth information or intensity information. Herein, the technical features described above in section 8 may be applied to a method of processing the spatio-temporal data set as they are.

Specifically, the data processing unit may process a spatio-temporal data set including a plurality of counting values on the basis of counting values adjacent to each other among the plurality of counting values and may generate an enhanced spatio-temporal data set. In addition, the data processing unit may obtain depth information on the basis of a plurality of corrected counting values included in the generated enhanced spatio-temporal data set.

In addition, without being limited thereto, the data processing unit may calculate an intensity value on the basis of the magnitudes of the plurality of corrected counting values included in the enhanced spatio-temporal data set.

For example, the data processing unit may perform denoising on the spatio-temporal data set to remove data related to noise and may enhance data related to an object to generate the enhanced spatio-temporal data set, but is not limited thereto.

In this case, the data processing unit may obtain the depth information or intensity information of the object on the basis of the data related to the object in the enhanced spatio-temporal data set. Specifically, the data processing unit may obtain the depth information or the intensity information on the basis of a plurality of counting values having a high probability of presence of the object in the enhanced spatio-temporal data set. For example, the data processing unit may obtain the depth information or the intensity information on the basis of a particular counting value having a value equal to or greater than a threshold and adjacent counting values of the particular counting value in the enhanced spatio-temporal data set.

For example, the data processing unit may obtain the depth information on the basis of one or more time bins allocated a particular counting value having a value equal to or greater than a threshold and adjacent counting values of the particular counting value in the enhanced spatio-temporal data set.

As another example, the data processing unit may obtain the depth information on the basis of magnitudes of a particular counting value having a value equal to or greater than a threshold and adjacent counting values of the particular counting value in the enhanced spatio-temporal data set.

In addition, for example, the data processing unit may classify data related to an object in the spatio-temporal data set to generate an enhanced spatio-temporal data set, but is not limited thereto.

In this case, the data processing unit may obtain the depth information or the intensity information of the object on the basis of data classified into data related to the object in the enhanced spatio-temporal data set. For example, the data processing unit may obtain the depth information or the intensity information on the basis of counting values included in at least one plane data set classified as an object plane in the spatio-temporal data set including a plurality of plane data sets, but is not limited thereto.

For example, the data processing unit may obtain the depth information on the basis of one or more time bins allocated counting values included in at least one plane data set classified as an object plane in the enhanced spatio-temporal data set.

As another example, the data processing unit may obtain the intensity information on the basis of the magnitudes of the counting values included in at least one plane data set classified as an object plane in the enhanced spatio-temporal data set.

### 9.1.3. Method of Obtaining Depth Information and Intensity Information Through Extraction of Peak Value in Spatio-Temporal Data Set

A data processing unit according to an embodiment may extract a peak value among a plurality of counting values included in a spatio-temporal data set. In the present specification, the peak value may refer to at least one counting value corresponding to a detection point or at least one time bin corresponding to the at least one counting value. For example, the peak value may be represented as at least one counting value (C) corresponding to a detection point or at least one time bin (t) corresponding to the at least one counting value or a set (C,t) of the at least one counting value and the at least one time bin, but is not limited thereto.

Herein, in the LiDAR device including a detector array, the data processing unit may extract a peak value for each of the detectors constituting the detector array. Specifically, for each detector included in the detector array, the data processing unit may extract, on the basis of counting values corresponding to the respective detectors, peak values corresponding to the respective detectors.

In addition, in this case, among the detectors included in the detector array, there may be a detector having no peak value. For example, when counting values included in an accumulated data set corresponding to a first detector do not include a counting value corresponding to an object, but only include counting values corresponding to noise, there may be no peak value in the counting values corresponding to the first detector.

Herein, the data processing unit may extract the peak value in various ways.

For example, the data processing unit may determine, as a peak value, a counting value having the highest value among the plurality of counting values corresponding to the first detector in the spatio-temporal data set, but is not limited thereto.

As another example, the data processing unit may use to threshold to extract a peak value of the spatio-temporal data set, but is not limited thereto. Herein, the spatio-temporal data set may include a plurality of peak values. However, without being limited thereto, the spatio-temporal data set may include only one peak value or may include no peak value. However, the following description assumes the case in which the spatio-temporal data set includes at least one peak value.

More specifically, the data processing unit may extract one or more counting values having values equal to or greater than the threshold among the plurality of counting values included in the spatio-temporal data set. In this case, the data processing unit may determine each of the one or more counting values as a peak value.

In addition, a counting value determined as a peak value may not be a counting value actually corresponding to the object. Details thereof will be described below (section).

In addition, a data processing unit according to an embodiment may obtain depth information or intensity information of a detection point on the basis of a spatio-temporal data set. More specifically, the data processing unit may determine at least one peak value among a plurality of counting values included in the spatio-temporal data set, and may determine depth values or intensity values of at least one detection point on the basis of the at least one peak value.

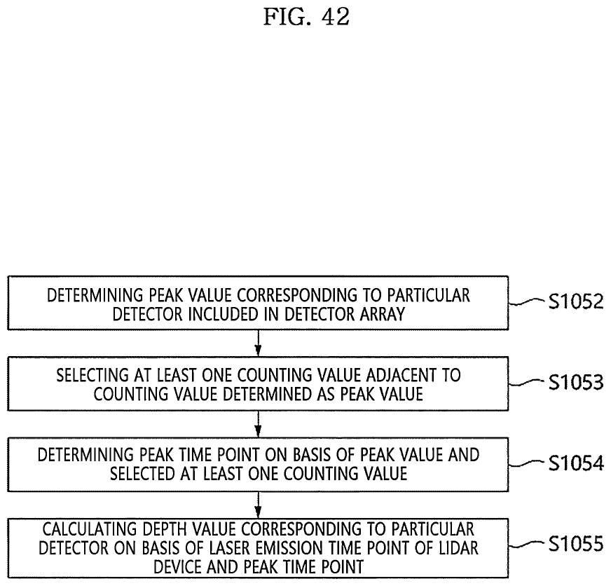

FIG. 42 is a diagram illustrating a method of obtaining depth information on the basis of adjacent counting values according to an embodiment.

Referring to FIG. 42, the data processing unit may determine a peak value corresponding to a particular detector included in a detector array in step S1052. Specifically, the data processing unit may determine, as the peak value, a particular counting value corresponding to the particular detector and allocated to a particular time bin. Herein, the above-described technical means may be applied to the method of determining the peak value as it is.

In addition, the data processing unit may select at least one counting value adjacent to the counting value determined as the peak value in step S1053.

Specifically, the data processing unit may select at least one counting value spatially adjacent to the peak value. More specifically, the data processing unit may select at least one counting value that corresponds to a detector adjacent to the detector corresponding to the peak value and is allocated to the same time bin as the peak value.

In addition, the data processing unit may select at least one counting value temporally adjacent to the peak value. More specifically, the data processing unit may select at least one counting value that is allocated to at least one time bin adjacent to the time bin to which the peak value is allocated and corresponds to the detector to which the peak value corresponds.

In addition, the data processing unit may determine a peak time point on the basis of the peak value and the selected at least one counting value in step S1054. Herein, the peak time point may correspond to a detection time point at which the LiDAR device detects a laser. In addition, the peak time point may be a time value (for example, a median value of the time bin) corresponding to the peak value, or may be a time point determined on the basis of the peak value and counting values adjacent to the peak value as described above.

In addition, the data processing unit may calculate a depth value corresponding to the particular detector on the basis of a laser emission time point of the LiDAR device and the peak time point in step S1055. Herein, the data processing unit may calculate the depth value using the speed of light based on the time of flight (TOF) of a laser.

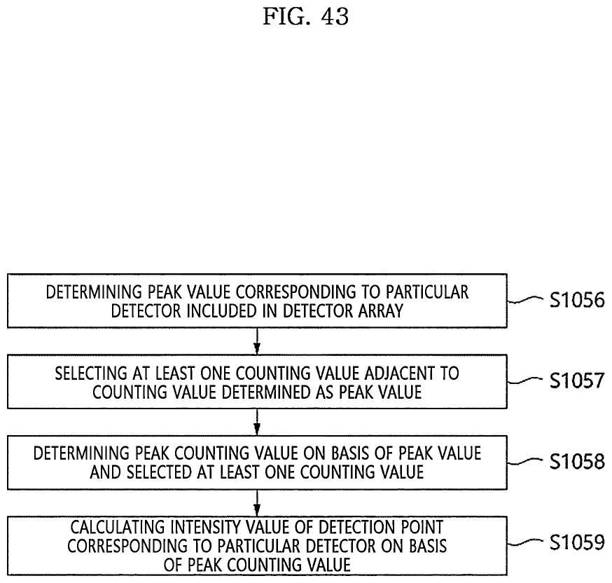

FIG. 43 is a diagram illustrating a method of obtaining intensity information of a detection point using a spatio-temporal data set according to an embodiment.

Referring to FIG. 43, a data processing unit may determine a peak value corresponding to a particular detector included in a detector array in step S1056. The technical details of the above-described step S1052 may be applied to the determination step as they are.

In addition, the data processing unit may select at least one counting value adjacent to the counting value determined as the peak value in step S1057. The technical details of the above-described step S1053 may be applied to the selection step as they are.

In addition, the data processing unit may determine a peak counting value on the basis of the peak value and the selected at least one counting value in step S1058. Herein, the peak counting value may correspond to a reflection intensity of a detection point. In addition, the peak counting value may be a counting value corresponding to the peak value, or may be a value determined on the basis of the peak value and counting values adjacent to the peak value as described above. The technical features described above in section 8 may be applied to a method of correcting a counting value on the basis of a plurality of counting values.

In addition, the data processing unit may calculate an intensity value of the detection point corresponding to the particular detector on the basis of the peak counting value in step S1059. A detailed method of calculating an intensity value on the basis of a counting value has been described above, so a description thereof will be omitted.

9.2. Method of Removing Noise from Ambient Light Using Spatio-Temporal Data Set

In a LiDAR device including a detector array, light detected by the detector array includes a laser emitted from the LiDAR device and reflecting off an object, sunlight reflecting off an object, sunlight directly received by the detector array, or interference light emitted from another LiDAR device.

In the present specification, among the types of light received by the LiDAR device, the types of light excluding a laser emitted from the LiDAR device and reflecting off an object are collectively referred to as ambient light.

LiDAR data generated by a LiDAR device may include noise data generated as a detector receives ambient light. Because of the noise data, it is difficult for the LiDAR device to extract data actually corresponding to an object. In particular, during the day when sunlight is strong, a detector of the LiDAR device may receive a lot of ambient light caused by sunlight, so it may be difficult to distinguish between noise data caused by the ambient light and data actually corresponding to an object.

For example, a spatio-temporal data set generated by a LiDAR device or a data processing unit of a LiDAR device may include counting values actually corresponding to an object and counting values corresponding to ambient light.

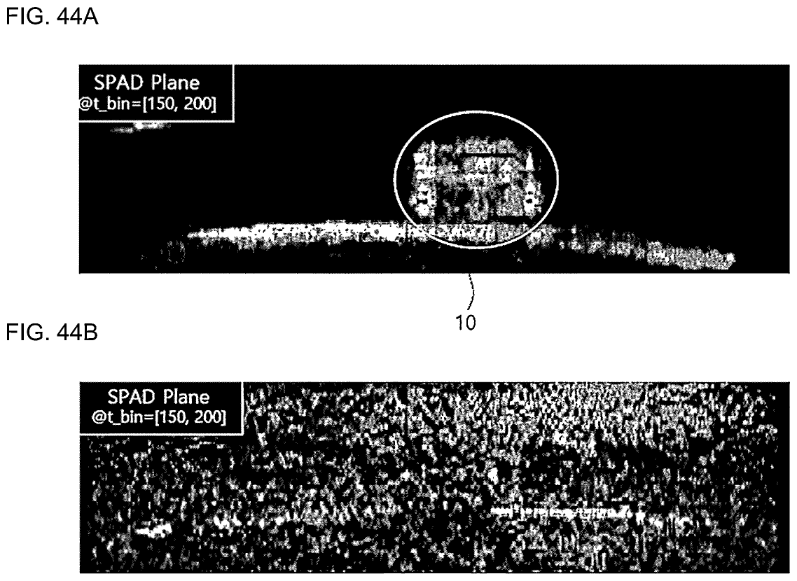

FIG. 44 is a diagram illustrating a spatio-temporal data set generated in a daytime environment with strong ambient light and a spatio-temporal data set generated in a nighttime environment with weak ambient light.

FIG. 44A is a diagram illustrating part of a spatio-temporal data set generated in a nighttime environment with weak ambient light.

Referring to FIG. 44A, it can be seen that there is weak ambient light in the nighttime environment and data corresponding to an object 10 is clearly distinguishable.

FIG. 44B is a diagram illustrating part of a spatio-temporal data set generated in a daytime environment with strong ambient light.

Referring to FIG. 44B, it can be seen that a data processing unit cannot distinguish data corresponding to the object because of noise caused by ambient light.

In order to solve the above-described problem, a data processing unit of a LiDAR device or a LiDAR data processing device may use a spatio-temporal data set.

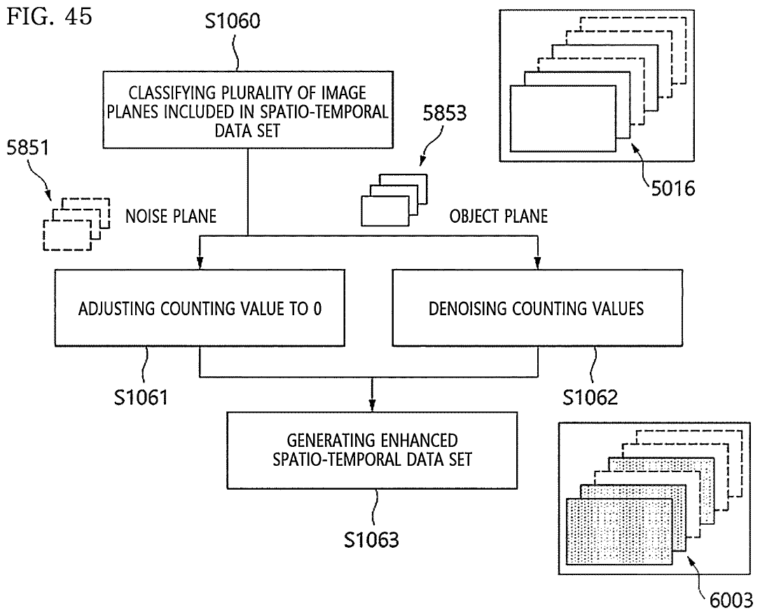

FIG. 45 is a diagram illustrating a method of denoising noise from ambient light using a spatio-temporal data set by a data processing unit according to an embodiment.

Referring to FIG. 45, for a spatio-temporal data set 5016 including a plurality of image planes, a data processing unit may classify each of the plurality of image planes included in the spatio-temporal data set 5016 in step S1060. Herein, the classification step may be performed by performing the above-described classification algorithm by the data processing unit. In addition, in this case, the data processing unit may perform screening operation on the basis of the above-described screening algorithm, thereby classifying all the image planes included in the spatio-temporal data set 5016.

In addition, for a first image plane set 5851 determined as a noise plane as a result of classification, the data processing unit may adjust all counting values included in the first image plane set 5851 to 0 in step S1061. In other words, the data processing unit may practically delete the noise plane.

In addition, for a second image plane set 5853 determined as an object plane as a result of classification, the data processing unit may denoise a plurality of counting values included in the second image plane set 5853 in step S1062. Herein, the denoising step may be performed by performing the above-described denoising algorithm by the data processing unit. In addition, in this case, the data processing unit may perform screening operation on the basis of the above-described screening algorithm, thereby denoising all the image planes included in the second image plane set 5853.

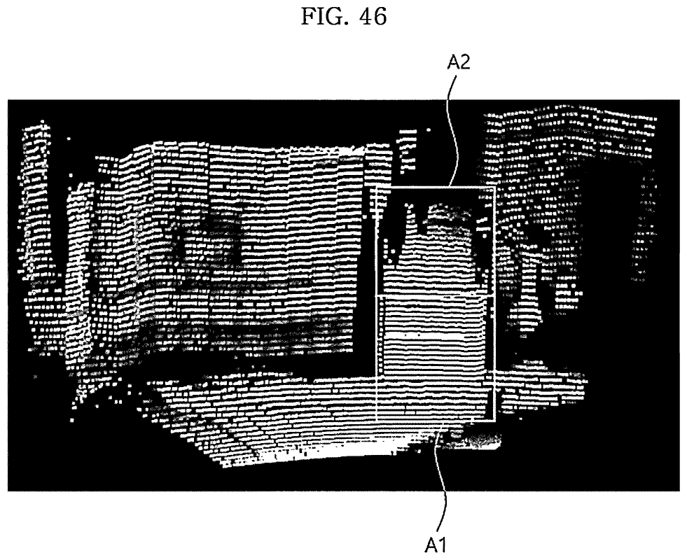

In addition, the adjustment step S1061 and the denoising step S1062 may be performed in parallel as shown in FIG. 46. However, without being limited thereto, the adjustment step S1061 may be performed and next the denoising step S1062 may be performed.

In addition, the data processing unit may generate, on the basis of a result of classification and postprocessing, an enhanced spatio-temporal data set 6003 in step S1063. Herein, the enhanced spatio-temporal data set 6003 may be a data set obtained by denoising noise counting values corresponding to ambient light and by smoothing counting values corresponding to an object.

In addition, without being limited thereto, the data processing unit may obtain depth information on the basis of the enhanced spatio-temporal data set 6003. Specifically, the data processing unit may obtain depth information of a detection point by using the above-described depth information obtainment method on the basis of counting values included in a denoised object plane.

### 9.3. Flaring Artifact Removal Using Spatio-Temporal Data Set

When a laser emitted from a LiDAR device is emitted to an object made of a retro material with a very high reflectivity, a flaring artifact may occur.

Hereinafter, a flaring artifact will be defined on the basis of what causes a flaring artifact.

Herein, the retro material object may refer to an object with a high retro-reflection. For example, examples of the retro material object may include road signs, vehicle tail lights, road guardrails, emergency signs, and road dividers, but are not limited thereto.

In addition, the retro-reflection may refer to the degree to which an emitted laser returns back along an emission path. In other words, objects with high retro-reflection are more likely to reflect emitted lasers back. For example, when lasers output from a LiDAR device reflect off the surface of a retro material object with a high retro-reflection, there are many lasers returning to the LiDAR device.

As described above, with a wide range and a high intensity, lasers reflecting off a retro object may be received by a LiDAR device. In this case, in addition to a detector having the field of view for receiving a laser reflecting off the retro object, adjacent detectors of the detector may receive the laser.

Accordingly, lasers reflecting off one object may be received by a plurality of detectors, and the plurality of detectors may generate detection signals on the basis of the received lasers.

As described above, even though there is no object corresponding to the field of view of a particular detector, lasers reflecting off an object included in the field of view of an adjacent detector are received by a particular number or greater and a ghost signal may thus occur in LiDAR data. This phenomenon is called a flaring artifact.

FIG. 46 is a diagram illustrating a spatio-temporal data set with a flaring artifact according to an embodiment.

Referring to FIG. 46, a first region (A1) of a spatio-temporal data set according to an embodiment may include counting values corresponding to an object. However, it can be seen that even though an object is not actually present in a second region (A2) of the spatio-temporal data set, there are counting values because of a ghost signal caused by a flaring artifact.

To solve the above-described problem, a data processing unit of a LiDAR device or a LiDAR data processing device may use a spatio-temporal data set to correct a flaring artifact.

Specifically, the data processing unit may extract and remove counting values corresponding to a flaring artifact. For example, the data processing unit may determine, on the basis of a spatio-temporal data set, whether a flaring artifact has occurred, and may extract at least one counting value corresponding to the determined flaring artifact, and may adjust the extracted at least one counting value to 0. However, no limitation thereto is imposed.

In addition, the data processing unit may detect a flaring artifact on the basis of one or more spatio-temporally adjacent counting values. Specifically, the data processing unit may determine a flaring artifact on the basis of one or more counting values corresponding to one or more spatially adjacent detectors and allocated to temporally adjacent time bins

In addition, without being limited thereto, there are various methods of determining whether a flaring artifact has occurred, on the basis of the spatio-temporal data set by the data processing unit.

For example, the data processing unit may determine a flaring artifact in a spatio-temporal data set on the basis of a reference data set representing a pre-stored flaring pattern.

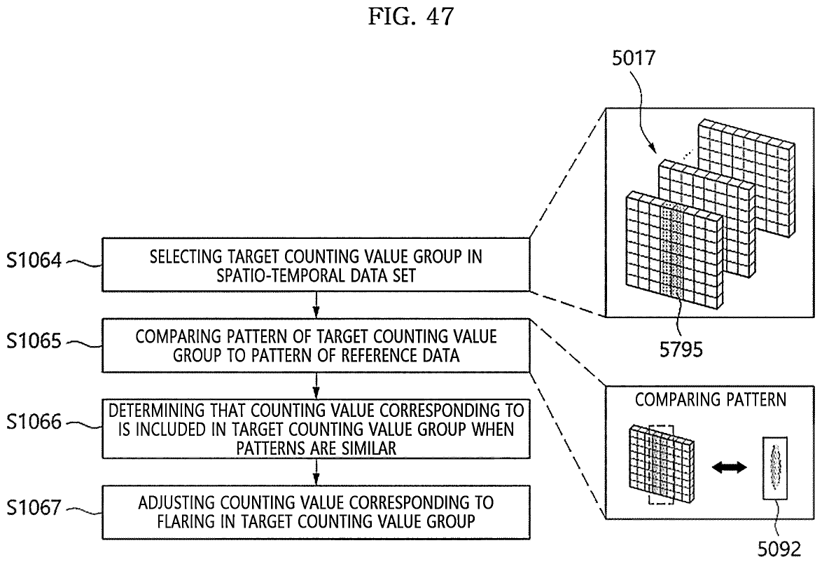

FIG. 47 is a diagram illustrating a method of determining a flaring artifact according to an embodiment.

Referring to FIG. 47, a data processing unit may select a target counting value group 5795 to be checked for flaring, in a spatio-temporal data set 5017 in step S1064. Herein, the target counting value group 5795 may be selected on the basis of an operating sequence of a detector array. For example, when the detector array operates n columns by n columns, counting values corresponding to detectors in n columns may be selected as the target counting value group. However, no limitation thereto is imposed.

In addition, the data processing unit may compare a counting value distribution pattern of the target counting value group 5795 to reference data 5092 in step S1065. Herein, the reference data 5092 may have a flaring pattern pre-stored in the LiDAR device.

Specifically, the reference data 5092 reflects the distribution pattern of counting values when a flaring artifact occurs due to a retro object, so the reference data may include a pattern corresponding to the retro object and a pattern corresponding to flaring. In addition, the reference data 5092 may be stored differently depending on types of retro objects. For example, the reference data 5092 may be stored in the form of a lookup table depending on the type of retro object, but is not limited thereto.

In addition, the data processing unit may store, as a lookup table (LUT), a reference data set that has different profiles depending on a distance to or a reflection intensity of an object. Specifically, as a distance to an object increases or a reflection intensity decreases, a range over which a flaring artifact occurs decreases. Therefore, pieces of reference data reflecting the range and having various profiles may be pre-stored. When an object is actually detected, reference data reflecting the distance to and the reflection intensity of the object may be fetched.

In addition, when the counting value distribution pattern of the target counting value group 5795 is similar to that of the reference data 5092, the data processing unit may determine that counting values corresponding to flaring are included in the target counting value group in step S1066.

In addition, the data processing unit may adjust counting values corresponding to flaring in the target counting value group 5795 in step S1067. Herein, to remove a flaring artifact, the data processing unit may adjust the extracted counting values to 0 or may delete the extracted counting values, but is not limited thereto.

As another example, the data processing unit may determine a flaring artifact on the basis of a plurality of pre-stored thresholds. Specifically, the data processing unit may pre-store a plurality of thresholds in order to distinguish between characteristics of an object and noise on the basis of levels of counting values. For example, the data processing unit may pre-store a threshold for distinguishing between noise and an object, a threshold for distinguishing between an object and a retro object, or a threshold for distinguishing between an object and flaring, but is not limited thereto. Accordingly, the data processing unit may determine counting values corresponding to flaring, on the basis of a threshold for distinguishing an object and flaring, but is not limited thereto.

As another example, the data processing unit may determine flaring by detecting a counting value corresponding to a retro object. More specifically, when a spatio-temporal data set includes a counting value corresponding to a retro object, a counting value corresponding to flaring may be present at a location adjacent to the counting value corresponding to the retro object. Accordingly, by detecting counting values corresponding to a retro object in a spatio-temporal data set, the data processing unit may determine counting values included in a predetermined region around the counting values corresponding to the retro object, as counting values corresponding to flaring. However, no limitation thereto is imposed.

For example, the data processing unit may detect a counting value group representing the occurrence of retro-reflection in a spatio-temporal data set. In addition, in association with the detection of the occurrence of retro-reflection, the data processing unit may determine counting values corresponding to flaring in the spatio-temporal data. In addition, the data processing unit may adjust the counting values corresponding to flaring in the spatio-temporal data set to 0 or delete the counting values, but is not limited thereto.

In addition, the data processing unit may define a range for determining a flaring artifact in a spatio-temporal data set on the basis of a predetermined criterion.

For example, the data processing unit may set a range for determining a flaring artifact on the basis of a detector group operating simultaneously. Specifically, the data processing unit may determine whether flaring has occurred for the counting values corresponding to the detector group operating simultaneously in the spatio-temporal data set, but is not limited thereto.

In addition, there are various ways of removing the flaring artifact by the data processing unit.

For example, as described above, the data processing unit may remove a flaring artifact by adjusting a counting value optionally. Specifically, the data processing unit may remove a flaring artifact by adjusting counting values corresponding to the flaring artifact in the spatio-temporal data set to 0 or by deleting the counting values, but is not limited thereto.

As another example, the data processing unit may remove a flaring artifact using a filter with an adaptive threshold set for flaring. Specifically, when a counting value corresponding to flaring is determined, the data processing unit applies a threshold at a level higher than the counting value corresponding to the flaring, thereby removing the counting value corresponding to the flaring.

### 9.4. Point Cloud Data Generation Using Spatio-Temporal Data Set

A data processing unit of a LIDAR device or a LIDAR data processing device according to an embodiment may generate point cloud data using a spatio-temporal data set. Specifically, the data processing unit may generate, on the basis of information on an object obtained from the spatio-temporal data set, point data for each detection point, and may use the pieces of point data to generate the point cloud data.

Herein, the point cloud data may refer to a point cloud map. However, without being limited thereto, the point cloud data may refer to a point data set in the form of (x,y,z,I) including location information and intensity information of a detection point.

For example, the data processing unit may generate point cloud data on the basis of depth information or intensity information of a detection point obtained using the above-described method, but is not limited thereto.

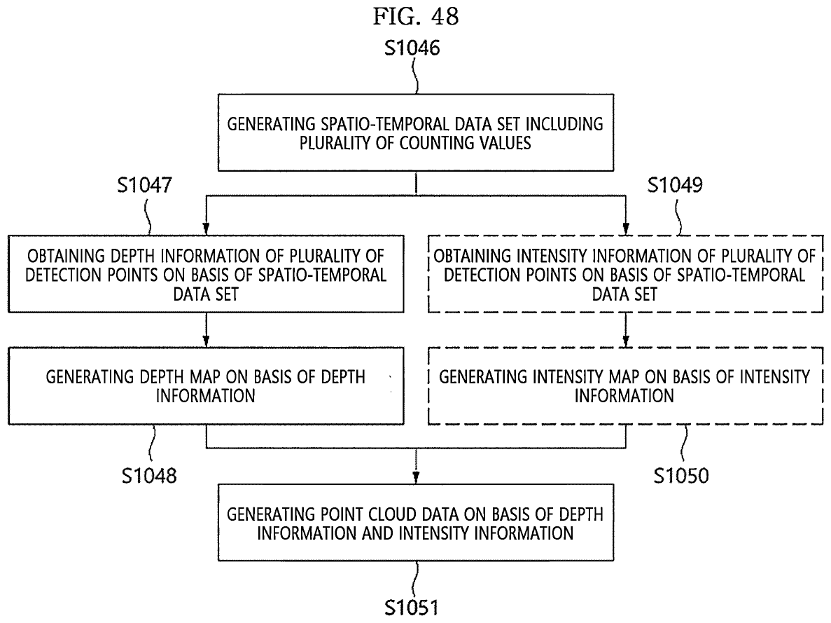

FIG. 48 is a diagram illustrating a method of generating point cloud data on the basis of a spatio-temporal data set according to an embodiment.

Referring to FIG. 48, a data processing unit of a LiDAR device or a LiDAR data processing device may generate a spatio-temporal data set including a plurality of counting values in step S1046. Herein, the above-described technical details may be applied to a method of generating the spatio-temporal data set as they are.

In addition, the data processing unit may obtain depth information of a plurality of detection points on the basis of the spatio-temporal data set in step S1047. Herein, the detection points may refer to an region to which a laser emitted from the LiDAR device is emitted and off which the laser reflects. In addition, the depth information may be represented as a depth value. However, without being limited thereto, the depth information may refer to an assembly of depth values for all the detection points.

In addition, the data processing unit may optionally generate a depth map on the basis of the depth information in step S1048. Herein, the depth map may refer to a map obtained by visualizing depth values of all the detection points using a 2D image. Specifically, the depth map may include a plurality of pixels, and each of the pixels may include location coordinates of a corresponding detector as pixel coordinates and include a depth value corresponding to the detector as a pixel value. For example, each pixel in the depth map may be pixel data in the form of ((u,v),D), and (u,v) may be location coordinates of a corresponding detector, and D may be a corresponding depth value.

In addition, the data processing unit may obtain intensity information of a plurality of detection points on the basis of the spatio-temporal data set in step S1049. Herein, the intensity information may be represented as an intensity value. However, without being limited thereto, the intensity information may refer to an assembly of intensity values for all the detection points.

In addition, the data processing unit may optionally generate an intensity map on the basis of the intensity information in step S1050. Herein, the intensity map may refer to a map obtained by visualizing intensity values of all the detection points using a 2D image. Specifically, the intensity map may include a plurality of pixels, and each of the pixels may include location coordinates of a corresponding detector as pixel coordinates and include an intensity value corresponding to the detector as a pixel value. For example, each pixel in the depth map may be pixel data in the form of ((u,v),I), and (u,v) may be location coordinates of a corresponding detector, and I may be a corresponding intensity value.

In addition, the data processing unit may generate point cloud data on the basis of the depth information and the intensity information in step S1051. However, without limitation thereto, according to an embodiment, the data processing unit may generate the point cloud on the basis of only the depth information. In this case, the point cloud data does not reflect intensity information of a detection point, so the data processing unit may generate the intensity map for reinforcement. However, no limitation thereto is imposed.

As another example, the data processing unit may process a spatio-temporal data set to generate an enhanced spatio-temporal data set, and may obtain depth information or intensity information on the basis of the enhanced spatio-temporal data set, thereby generating point cloud data. Specifically, the data processing unit may remove noise data by denoising the spatio-temporal data set, and may obtain depth information and intensity, thereby generating point cloud data.

As still another example, the data processing unit may remove a flaring artifact on the basis of a spatio-temporal data set, and may obtain depth information and intensity information, thereby generating point cloud data.

As still another example, the data processing unit may remove noise caused by ambient light on the basis of a spatio-temporal data set, and may obtain depth information and intensity information, thereby generating point cloud data.

As still another example, the data processing unit may process a spatio-temporal data set to generate point cloud data.

### 9.5. Other Uses of Spatio-Temporal Data Set

Hereinafter, described will be an example of solving various problematic situations that may occur when a LiDAR device detects an object and obtains depth information of the object, by using a spatio-temporal data set.

A problem, such as misalignment between a laser emitting unit and a detecting unit of the LiDAR device, may cause a dead zone in which data is not obtained as a laser reflecting off a particular region in the field of view of the LiDAR device is not detected by the detecting unit. In particular, the dead zone may occur because a laser reflecting off an object located at a short distance from the LiDAR device is not received by the detecting unit.

To solve this, the data processing unit of the LiDAR device or the LiDAR data processing device may use a spatio-temporal data set to detect the dead zone.

Specifically, the data processing unit may determine a dead zone on the basis of a counting value of the spatio-temporal data set. For example, the data processing unit may determine, as a dead zone, a predetermined region in which a counting value is close to 0 in the spatio-temporal data set.

In addition, in this case, the controller of the LiDAR device may operate to obtain data of the dead zone. For example, the controller may adjust the power or output repetition of the laser emitting unit to obtain data for a region determined as the dead zone, but is not limited thereto.

When the number of lasers reflecting off an object present at a long distance and received is less than a threshold, so depth information of the object may not be obtained and data may be lost.

To solve this, the data processing unit may use a spatio-temporal data set to detect a counting value set corresponding to the object at the long distance.

Specifically, when counting values having similar values crowd a predetermined region in the spatio-temporal data set, the data processing unit may determine that the counting values are a counting value set corresponding to the object, even if the counting values do not exceed a threshold.

In addition, in this case, without applying the threshold to the counting value set, the data processing unit may obtain depth information on the basis of the counting value set.

### 10. Variations of Spatio-Temporal Data Set

A data processing unit of a LiDAR device or a LIDAR data processing device may extract a spatio-temporal data set in the above-described form or some of the spatio-temporal data set, or may generate a data set that is a variation of the spatio-temporal data set.

For example, according to an embodiment, the data processing unit may generate a sub spatio-temporal data set including some of the counting values included in the spatio-temporal data set, or may generate a summation data set on the basis of the sum of the counting values included in the spatio-temporal data set, but is not limited thereto.

The sub spatio-temporal data set and the summation data set will be described in detail below.

### 10.1. Sub Spatio-Temporal Data Set

10.1.1. Definition of Sub Spatio-Temporal Data Set A data processing unit according to an embodiment may generate a sub spatio-temporal data set including some of the plurality of counting values included in the above-described spatio-temporal data set.

Specifically, the sub spatio-temporal data set may be an assembly of counting values identified by a location value and a time value. Herein, the location value may be a value reflecting a location of a detector by which the counting value is generated, and the time value may be a time bin to which the counting value is allocated in a detecting window of the detector. However, no limitation thereto is imposed.

In addition, a sub spatio-temporal data set may include a peak value and at least one counting value adjacent to the peak value. Herein, the peak value may refer to a counting value that satisfies the above-described criterion among a plurality of counting values, and may mainly refer to a counting value corresponding to an object for calculating a depth value.

Specifically, the sub spatio-temporal data set may include at least one counting value spatially adjacent to a peak value. For example, the sub spatio-temporal data set may include at least one counting value that is allocated to the time bin the same as the time bin to which the peak value is allocated, and corresponds to at least one detector neighboring a detector corresponding to the peak value, but is not limited thereto.

In addition, the sub spatio-temporal data set may include at least one counting value temporally adjacent to a peak value. For example, the sub spatio-temporal data set may include at least one counting value that corresponds to the same detector as the detector to which the peak value corresponds, and is allocated to at least one time bin adjacent to the time bin to which the peak value is allocated, but is not limited thereto.

In addition, the sub spatio-temporal data set may include at least one counting value spatio-temporally adjacent to a peak value. For example, the sub spatio-temporal data set may include at least one counting value that corresponds to at least one detector neighboring the detector corresponding to the peak value, and is allocated to at least one time bin adjacent to the time bin to which the peak value is allocated, but is not limited thereto.

As a specific example, the sub spatio-temporal data set may include counting values having a volume of 3*3*3 with a peak value in the center, but is not limited thereto.

### 10.1.2. Generation and Use of Sub Spatio-Temporal Data Set

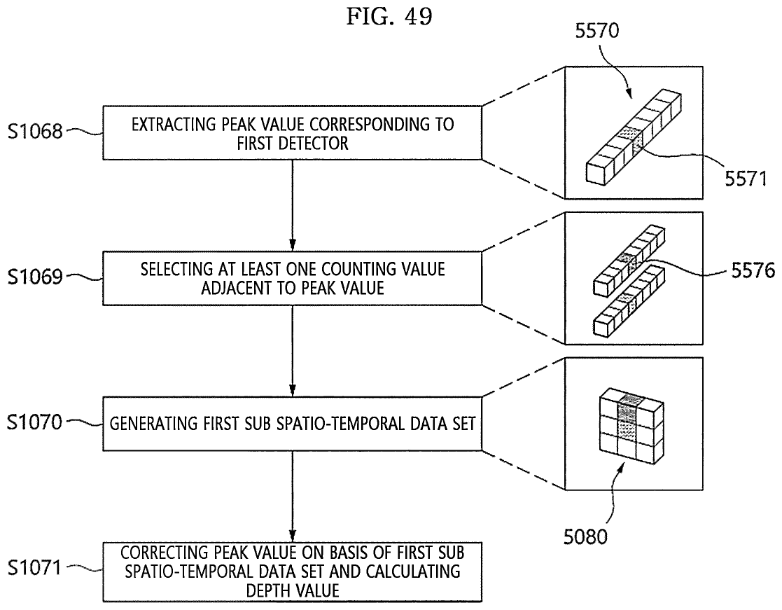

FIG. 49 is a diagram illustrating a method of generating and using a sub spatio-temporal data set according to an embodiment.

Referring to FIG. 49, a data processing unit may generate a sub spatio-temporal data set and may generate a depth value corresponding to a first detector.

Specifically, the data processing unit may extract a peak value corresponding to the first detector in step S1068. Herein, the technical details of the above-described method of extracting a peak value may be applied to the extraction step S1068 as they are. For example, for a first accumulated data set 5570 corresponding to the first detector, the data processing unit may extract a first counting value 5571 as a peak value, but is not limited thereto.

In addition, the data processing unit may select at least one counting value around the peak value in step S1069. Herein, the at least one counting value may include at least one counting value temporally or spatially adjacent to the peak value. For example, the data processing unit may select a second counting value 5576 that corresponds to a second detector adjacent to the first detector and is allocated to the same time bin as the first counting value 5571, but is not limited thereto.

In addition, the data processing unit may generate a first sub spatio-temporal data set 5080 including the peak value and the adjacent counting values in step S1070. Herein, the sub spatio-temporal data set 5080 may include the first counting value 5571, which is the peak value, and the second counting value 5576, and may further include counting values located around the first counting value.

In addition, the data processing unit may correct the peak value on the basis of the first sub spatio-temporal data set 5080, and may calculate a depth value corresponding to the first detector in step S1071. Specifically, the data processing unit may correct the peak value on the basis of the first counting value 5571 extracted as the peak value and the counting values that are included in the first sub spatio-temporal data set 5080 and around the first counting value 5571. In addition, the data processing unit may calculate the depth value corresponding to the first detector on the basis of the corrected peak value and the time of flight of a laser.

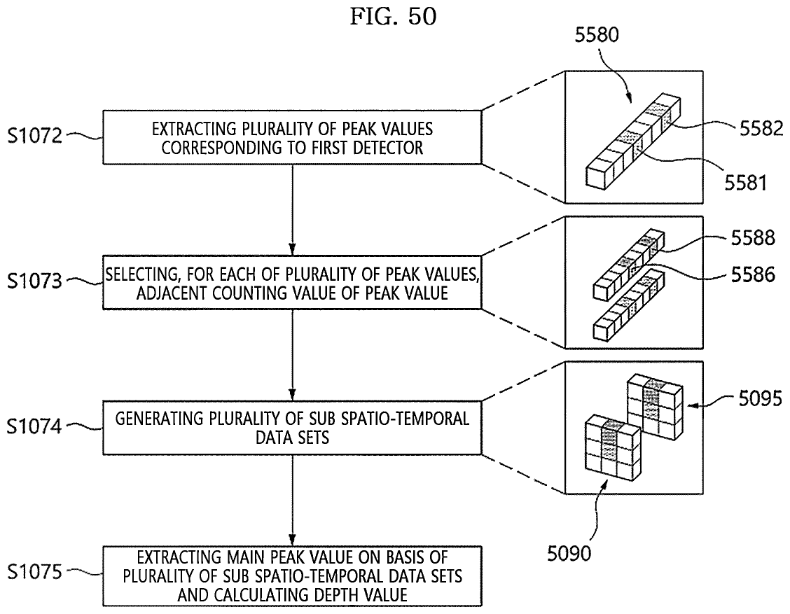

FIG. 50 is a diagram illustrating a method of generating and using a sub spatio-temporal data set according to another embodiment.

Referring to FIG. 50, a data processing unit according to an embodiment may generate a plurality of sub spatio-temporal data sets and may calculate a depth value corresponding to a detector.

Specifically, the data processing unit may extract a plurality of sub peak values corresponding to a first detector in step S1072. Herein, the technical details of the above-described method of extracting a peak value may be applied to the extraction step S1072 as they are. For example, for a first accumulated data set 5580 corresponding to the first detector, the data processing unit may extract a first counting value 5581 and a second counting value 5582 as peak values, but is not limited thereto.

In addition, for each of the plurality of peak values, the data processing unit may select adjacent counting values of the plurality of peak values in step S1073. For example, the data processing unit may select a third counting value 5586 spatially adjacent to the first counting value 5581, and may select a fourth counting value 5588 spatially adjacent to the second counting value 5582. Herein, the third counting value 5586 may correspond to a second detector neighboring the first detector, and may be allocated to the time bin the same as the time bin to which the first counting value 5581 is allocated. However, no limitation thereto is imposed. In addition, the fourth counting value 5588 may correspond to the second detector neighboring the first detector, and may be allocated to the time bin the same as the time bin to which the second counting value 5582 is allocated. However, no limitation thereto is imposed.

In addition, the data processing unit may generate a plurality of sub spatio-temporal data sets on the basis of the plurality of peak values and the adjacent counting values in step S1074. For example, the data processing unit may generate a first sub spatio-temporal data set 5090 including the first counting value 5581 and the third counting value 5586. In addition, the data processing unit may generate a second sub spatio-temporal data set 5095 including the second counting value 5582 and the fourth counting value 5588.

In addition, the data processing unit may extract a main peak value on the basis of the plurality of sub spatio-temporal data sets, and may calculate a depth value corresponding to the first detector on the basis of the main peak value in step S1075.

Specifically, the data processing unit may calculate and compare the differences between the counting values included in the plurality of sub spatio-temporal data sets. For example, the data processing unit may compare the difference between the first counting value 5581 and the third counting value 5586 included in the first sub spatio-temporal data set 5090 and the difference between the second counting value 5582 and the fourth counting value 5588 included in the second sub spatio-temporal data set 5095, but is not limited thereto.

Herein, the data processing unit may extract a sub spatio-temporal data set having a small difference between the counting values, and may extract the main peak value on the basis of the extracted sub spatio-temporal data set. For example,

The data processing unit may extract a main peak value by extracting one of the plurality of sub spatio-temporal data sets on the basis of the differences between the counting values. When the difference between the first counting value 5581 and the third counting value 5586 is smaller than the difference between the second counting value 5582 and the fourth counting value 5588, the data processing unit may extract the first counting value 5581 included in the first sub spatio-temporal data set 5090 as the main peak value.

In addition, the data processing unit may calculate the depth value corresponding to the first detector on the basis of the main peak value. For example, the data processing unit may calculate the depth value corresponding to the first detector by using the time of flight of a laser on the basis of the time value of the first counting value 5581 extracted as the main peak value, but is not limited thereto.

### 10.2. Summation Image

### 10.2.1. Definition and Generation of Summation Image

A summation image according to an embodiment may be data obtained by arranging, in one plane, the sum of counting values corresponding to each detector in a LiDAR device including a detector array.

In addition, a summation image may be data obtained by fusing image planes corresponding to all time bins in a spatio-temporal data set and compressing the image planes into one image.

In addition, a summation image may be data obtained by arranging, in one image, the sum of all counting values included in an accumulated data set corresponding to each detector.

In addition, a summation image may be data obtained by fusing a counting value corresponding to noise and a counting value corresponding to an object.

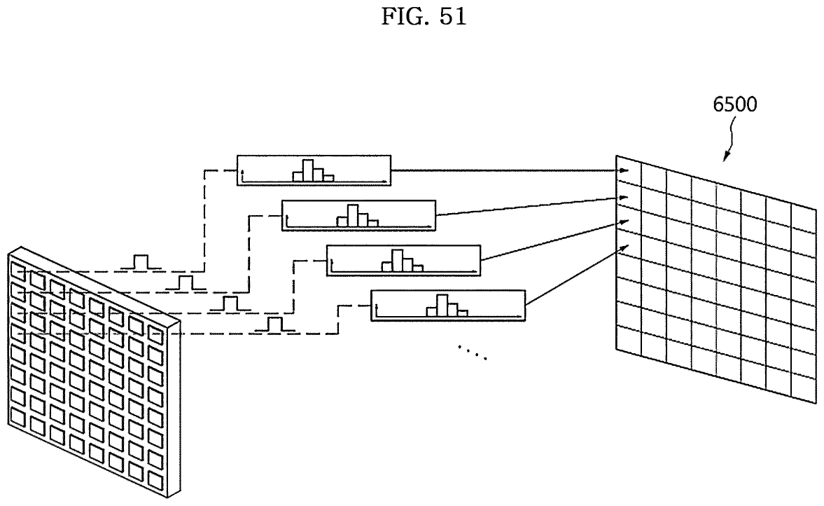

FIG. 51 is a diagram illustrating a summation image according to an embodiment.

Referring to FIG. 51, a data processing unit may generate a summation image 6500 corresponding to a detector array. Herein, the summation image 6500 may include a plurality of pieces of pixel data.

In addition, the plurality of pieces of pixel data may correspond to the respective detectors included in the detector array. In addition, pixel coordinates of pixel data may be determined on the basis of the location of a corresponding detector.

In addition, a pixel value of pixel data may be determined on the basis of the sum of counting values corresponding to a detector. Specifically, respective pixel values included in the summation image 6500 may be the sums of counting values generated on the basis of detection signals received from the detectors corresponding to the respective pixels.

In addition, the data processing unit may receive detection signals from the detectors of the detector array, and may generate the summation image 6500 on the basis of the detection signals. In addition, the data processing unit may receive detection signals from the detectors of the detector array, may generate counting values on the basis of the detection signals, and may generate the summation image 6500 on the basis of the counting values. Specifically, the data processing unit may generate the summation image 6500 by adding all the counting values corresponding to each detector. For example, the data processing unit may generate first pixel data having a first pixel value by adding all counting values corresponding to a first detector, and may generate second pixel data having a second pixel value by adding all counting values corresponding to a second detector. Accordingly, the summation image 6500 including the first pixel data and the second pixel data may be generated, but is not limited thereto.

In addition, the data processing unit may receive detection signals from the detectors of the detector array, may generate histogram data on the basis of the detection signals, and generate the summation image 6500 on the basis of the histogram data. Specifically, the data processing unit may generate the summation image 6500 by adding all the counting values included in histogram data corresponding to each detector. For example, the data processing unit may generate first pixel data having a first pixel value by adding all counting values included in histogram data corresponding to a first detector, and may generate second pixel data having a second pixel value by adding all counting values included in histogram data corresponding to a second detector. Accordingly, the summation image 6500 including the first pixel data and the second pixel data may be generated, but is not limited thereto.

In addition, the data processing unit may receive detection signals from the detectors of the detector array, may generate a plurality of plane data sets on the basis of the detection signals, and may generate the summation image 6500 on the basis of the plurality of plane data sets. Specifically, the data processing unit may generate a plurality of plane data sets corresponding to a plurality of time bins, respectively, and may generate the summation image 6500 by adding all counting values corresponding to the same detector in the plurality of plane data sets. For example, the data processing unit may generate first pixel data by adding counting values of all plane data sets corresponding to a first detector, and may generate second pixel data by adding counting values of all plane data sets corresponding to a second detector. Accordingly, the summation image 6500 including the first pixel data and the second pixel data may be generated, but is not limited thereto.

In addition, the data processing unit may receive detection signals from the detectors of the detector array, may generate a plurality of image planes on the basis of the detection signals, and may generate the summation image 6500 on the basis of the plurality of image planes.

Specifically, the data processing unit may generate a plurality of image planes corresponding to a plurality of time bins, respectively, and may generate the summation image 6500 by adding all pixel values corresponding to the same detector in the plurality of image planes. For example, the data processing unit may generate first pixel data by adding pixel values of all image planes corresponding to a first detector, and may generate second pixel data by adding pixel values of all image planes corresponding to a second detector. Accordingly, the summation image 6500 including the first pixel data and the second pixel data may be generated, but is not limited thereto.

In addition, the data processing unit may receive detection signals from the detectors of the detector array, may generate a spatio-temporal data set on the basis of the detection signals, and may generate the summation image 6500 on the basis of the spatio-temporal data set. Specifically, the data processing unit may generate the summation image 6500 by adding all counting values corresponding to the same detector in the spatio-temporal data set. For example, the data processing unit may generate first pixel data by adding all counting values corresponding to a first detector in in the spatio-temporal data set, and may generate second pixel data by adding all counting values corresponding to a second detector. Accordingly, the summation image 6500 including the first pixel data and the second pixel data may be generated, but is not limited thereto.

### 10.2.2. Depth Information Obtainment Using Summation Image

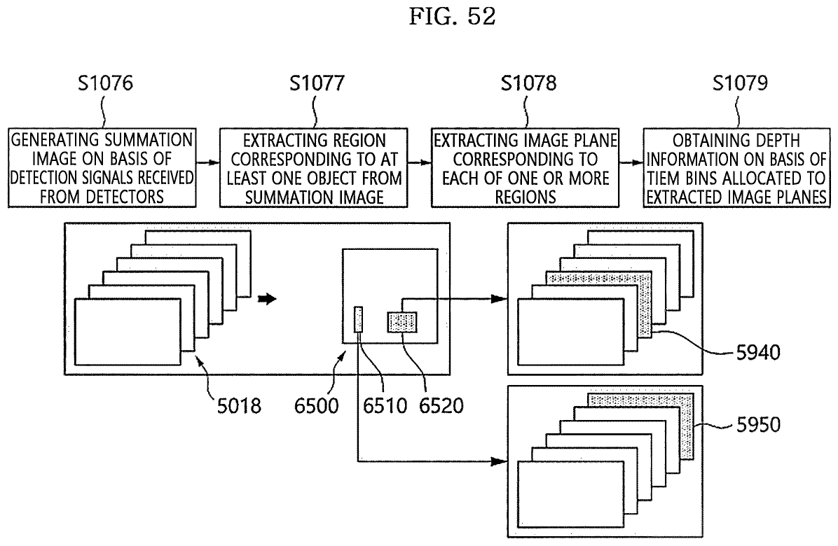

FIG. 52 is a diagram illustrating a method of using a summation image according to an embodiment.

Referring to FIG. 52, a data processing unit according to an embodiment may generate a summation image 6500 on the basis of a detection signal received from each detector in a LiDAR device including a detector array in step S1076.

Specifically, the data processing unit may generate a plurality of image planes 5018 on the basis of the detection signals, and may generate the summation image 6500 by adding pixel values corresponding to the same detector in the plurality of image planes 5018, but is not limited thereto.

In addition, the data processing unit may extract one or more regions corresponding to one or more objects from the summation image 6500 in step S1077.

Specifically, the data processing unit may extract the one or more regions corresponding to the one or more objects on the basis of the distribution of pixel values of a plurality of pieces of pixel data included in the summation image 6500.

For example, when a plurality of pieces of pixel data having similar pixel values crowd a particular region of the summation image 6500, the data processing unit may determine the particular region as a region corresponding to an object. However, no limitation thereto is imposed.

Referring to FIG. 52, the data processing unit may extract a first dense region 6510 corresponding to a first object and a second dense region 6520 corresponding to a second object from the summation image 6500.

In addition, the data processing unit may determine a noise level on the basis of the summation image 6500, and may extract at least one region corresponding to an object on the basis of the noise level.

Specifically, the data processing unit may determine the noise level on the basis of the pixel values of the plurality of pieces of pixel data included in the summation image. For example, the data processing unit may determine an average value or a median value of the plurality of pixel values as the noise level, but is not limited thereto. As another example, the data processing unit may determine, as the noise level, an average value or a median value of pixel values in a predetermined range among the plurality of pixel values, but is not limited thereto. Specifically, the data processing unit may determine the predetermined range on the basis of the maximum value and the minimum value among the pixel values of the summation image, and may determine the average value or the median value of the pixel values included in the predetermined range as the noise level.

In addition, the data processing unit may extract at least one region corresponding to an object by applying the determined noise level to the summation image 6500. Specifically, the data processing unit may determine, as a region corresponding to an object, at least one piece of pixel data having a pixel value higher than the determined noise level among the plurality of pieces of pixel data included in the summation image.

In addition, the data processing unit may extract an image plane corresponding to each of the one or more regions in step S1078.

Specifically, the data processing unit may determine which image plane among the plurality of image planes 5018 an object corresponding to at least one dense region included in the summation image 6500 is included.

More specifically, the data processing unit may traceback the plurality of image planes 5018 to extract, from the summation image 6500, an image plane in which pieces of pixel data corresponding to the at least one dense region are present. For example, the data processing unit may perform screening operation on the plurality of image planes 5018 and extract at least one image plane corresponding to the at least one dense region.

To this end, the plurality of image planes 5018 may be stored in a memory region different from a memory region in which the summation image 6500 is stored. Specifically, the data processing unit may extract at least one dense region from the summation image 6500 stored in a first section of a memory, and may perform screening on the plurality of image planes 5018 stored in a second section of the memory, thereby extracting an image plane corresponding to the at least one dense region.

For example, the data processing unit may extract a first image plane 5940 corresponding to the first dense region 6510 included in the summation image 6500, and may extract a second image plane 5950 corresponding to the second dense region 6520.

For convenience of description, FIG. 52 assumes that there is one image plane corresponding to a dense region. However, according to an embodiment, a plurality of adjacent image planes may correspond to the dense region.

In addition, the data processing unit may determine depth information of the one or more objects on the basis of the time bins allocated to the extracted image planes in step S1079.

For example, the data processing unit may obtain the depth information of the first object on the basis of a first time bin allocated to the first image plane 5940, and may obtain the depth information of the second object on the basis of a second time bin allocated to the second image plane 5950.

In addition, according to an embodiment, when a plurality of image planes adjacent to each other correspond to the dense region, the data processing unit may calculate a representative value on the basis of a plurality of time bins corresponding to the plurality of image planes and may obtain depth information on the basis of the representative value.

Methods according to the embodiments may be embodied as program instructions executable by various computer means and may be recorded on a computer-readable recording medium. The computer-readable recording medium may include program instructions, data files, data structures, and the like separately or in combinations. The program instructions to be recorded on the computer-readable recording medium may be specially designed and configured for the embodiments may be well-known to and be usable by those skilled in the art of computer software. Examples of the computer-readable recording medium include magnetic recording media such as hard disks, floppy disks and magnetic tapes; optical data storage media such as CD-ROMs or DVD-ROMs; magneto-optical media such as floptical disks; and hardware devices, such as read-only memory (ROM), random-access memory (RAM), and flash memory, which are particularly structured to store and implement the program instructions. Examples of the program instructions include not only a mechanical language code formatted by a compiler but also a high level language code that may be implemented by a computer using an interpreter, and the like. The hardware devices may be configured to be operated by one or more software modules or vice versa to conduct the operation according to the embodiments.

Although the embodiments have been described with reference to the limited embodiments and drawings, it will be understood by those skilled in the art that various modifications and variations may be made from the description. For example, suitable results may be achieved if the described techniques are performed in an order different from the described method, and/or the elements of the above-described system, structure, device, and circuit are coupled or combined in a form different from the described method, or replaced or substituted by other elements or equivalents.

Therefore, other implementations, other embodiments, and equivalents to the claims are also within the scope of the following claims.

### MODE FOR INVENTION

As described above, in the best mode for carrying out the invention, related matters have been described.

What is claimed is:

1. A method for obtaining a point cloud data per frame based on a spatio-temporal data set, the method comprising:
generating the spatio-temporal data set per frame,
wherein the spatio-temporal data set per frame comprises:
a plurality of sets of counting values for all time-bins, wherein each set of counting values of the plurality of sets of counting values is corresponding to each time-bin, wherein each set of counting values comprises a plurality of counting values respectively corresponding to each of detecting units which consist of a detector array; and
obtaining the point cloud data per frame based on the spatio-temporal data set generated per frame,
wherein the obtaining the point cloud data comprises determining one point data for one of the detecting units with considering all or a part of counting values corresponding to the one of the detecting units and further considering a part of counting values corresponding to adjacent detecting unit to the one of the detecting units.

2. The method of claim 1, wherein the one point data is determined based on a first distance value for the one of the detecting units and a location coordinate of the one of the detecting units,
wherein the first distance value is generated based on at least a first counting value corresponding to the one of the detecting units and a second counting value corresponding to the adjacent detecting unit to the one of the detecting units,
wherein the first counting value is included in a first set of counting values corresponding to a first time-bin, and
wherein the second counting value is included in the same set of counting values as the first counting value.

3. The method of claim 2, wherein the first counting value is generated based on detection signals generated by the one of detecting units, and
wherein the second counting value is generated based on detection signals generated by the adjacent detecting unit to the one of the detecting units.

4. The method of claim 2, wherein the second counting value is generated after the first counting value.

5. The method of claim 4, wherein the adjacent detecting unit is located at a different row and the same column as the one of the detecting units in the detector array.

6. The method of claim 2, wherein the second counting value is generated at the same time as the first counting value.

7. The method of claim 6, wherein the adjacent detecting unit is located at the same row and a different column as the one of the detecting units in the detector array.

8. The method of claim 1, wherein the determining one point data comprises:
generating a processed spatio-temporal data set, wherein the processed spatio-temporal data set comprises a plurality of sets of values for all time-bins, wherein each set of values of the plurality of sets of values is corresponding to each time-bin, wherein each set of values comprises a plurality of values respectively corresponding to each of detecting units which consist of the detector array;
determining one distance value for the one of the detecting units with considering all or a part of values corresponding to the one of the detecting units; and
determining the one point data based on the one distance value,
wherein values corresponding to the one of the detecting units comprise a first value included in a first set of values corresponding to a first time-bin,
wherein the first value is generated based on a first counting value corresponding to the one of the detecting units, a second counting value corresponding to the adjacent detecting unit to the one of the detecting units and a third counting value corresponding to the one of the detecting units,
wherein the first counting value is included in a first set of counting values corresponding to the first time-bin,
wherein the second counting value is included in the same set of counting values as the first counting value, and
wherein the third counting value is included in a second set of counting values corresponding to a second time-bin adjacent to the first time-bin.

9. The method of claim 8, wherein a number of values of the processed spatio-temporal data set corresponds to a number of counting values of the spatio-temporal data set.

10. The method of claim 9, wherein the processed spatio-temporal data set is stored in a different memory from the spatio-temporal data set.

11. The method of claim 8, wherein the first value is generated by weighting to the first counting value, the second counting value and the third counting value, wherein a first weight applied to the first counting value is greater than a second weight applied to the second counting value, wherein a third weight applied to the third counting value is the same as the second weight.

12. The method of claim 1, wherein the one point data for the one of the detecting units is determined with considering at least a first counting value and a second counting value included in a first set of counting values corresponding to a first time-bin,
wherein the first counting value is corresponding to the one of detecting units, and
wherein the second counting value is corresponding to the adjacent detecting unit to the one of the detecting units.

13. The method of claim 1, wherein the point cloud data comprises a plurality of point data, wherein each of the plurality of point data comprises three-dimensional location coordinate.

14. The method of claim 1, wherein the each of the detecting units is configured to detect light for a predetermined period corresponding to an emission of a corresponding laser pulse, and
wherein each time-bin is representing a time section in which a specific time has elapsed from an emission time of the corresponding laser pulse.
